(19) United States
(12) Patent Application Publication
(10) Pub. No.: US 2007/0121115 A1
(43) Pub. Date: May 31, 2007

(54) Apparatus and method for reducing effects of coherent artifacts and compensation of effects of vibrations and environmental changes in interferometry

(75) Inventor: Henry A. Hill, Tucson, AZ (US)

Correspondence Address: WILMER CUTLER PICKERING HALE AND DORR LLP, 60 STATE STREET, BOSTON, MA, 02109, US

(73) Assignee: Zetetic Institute, Tucson, AZ (US)

(21) Appl. No.: 11/600,310

(22) Filed: Nov. 15, 2006

Related U.S. Application Data
(60) Provisional application No. 60/737,102, filed on Nov. 15, 2005.

(51) Int. Cl. G01B 9/02

(52) U.S. Cl. 356/450

(57) ABSTRACT

An interferometric method including: generating a variable frequency source beam; from the source beam, generating a collimated beam propagating at an angle Ω relative to an optical axis; introducing the collimated beam into an interferometer that includes a reference object and a measurement object, wherein at least a portion of the collimated beam interacts with the reference object to generate a reference beam, at least a portion of the collimated beam interacts with the measurement object to generate a return measurement beam, and the reference beam and the return measurement beam are combined to generate a combined beam; causing the angle Ω to have a first value and at a later time a second value that is different from the first value; and causing the variable frequency F to have a first value that corresponds to the first value of the angle Ω and at the later time to have a second value that corresponds to the first value of the angle Ω.

This application claims the benefit of U.S. Provisional Application No. 60/737,102, filed Nov. 15, 2005, which is incorporated herein by reference.

### TECHNICAL FIELD

The invention in general relates to interferometric apparatus and methods for preserving test surface fringe visibility in interferograms while suppressing effects of coherent artifacts that would otherwise be present in the interferograms and for compensation of effects of vibrations and environmental changes in high speed measurements to improve overall signal-to-noise ratios.

### RELATED PATENT APPLICATIONS

U.S. Ser. No. 11/463,036, filed Aug. 8, 2006, entitled “Apparatus and Methods for Reduction and Compensation of Effects of Vibrations and of Environmental Effects in Wavefront Interferometry” (ZI-71); and U.S. Ser. No. 11/457,025, filed Jul. 12, 2006, entitled “Continuously Tunable External Cavity Diode Laser Sources with High Tuning Rates and Extended Tuning Ranges” (ZI-72), both of which are incorporated herein by reference.

### BACKGROUND AND SUMMARY OF THE INVENTION

Phase-shift interferometry is an established method for measuring a variety of physical parameters ranging from intrinsic properties of gases to the displacement of objects such as described in a review article by J. Schwider entitled “Advanced Evaluation Techniques In Interferometry,” Progress In Optics XXVII, Ed. E. Wolf (Elsevier Science Publishers 1990). The contents of the Schwider article are herein incorporated in their entirety by reference. Interferometric wavefront sensors can employ phase-shift interlerometers (PSI) to measure the spatial distribution of a relative phase across an area, i.e., to measure a physical parameter across a two-dimensional section.

An interferometric wavefront sensor employing a PSI typically consists of a spatially coherent light source that is split into two beams, a reference beam and a measurement beam, which are later recombined after traveling respective optical paths of different lengths. The relative phase difference between the wavefronts of the two beams is manifested as a two-dimensional intensity pattern or interference signal known as an interferogram. PSIs typically have an element in the path of the reference beam which introduces three or more known phase-shifts. By detecting the intensity pattern with a detector for each of the phase-shifts, the relative phase difference distribution of the reference and measurement beam wavefronts can be quantitatively determined independent of any attenuation in either of the reference or measurement beams.

Optical systems that use coherent radiation, e.g., laser light, encounter scattered light that can interfere coherently in the interferometric image to produce large amplitude light level changes with spatial and/or temporal structure that can mask the desired interference pattern of a respective interferogram. Generally, the sensitivity of these interferometers is such that it makes them adversely affected by background that can be produced by small imperfections in any practical system. Dust or small scratches on the optical surfaces of the system or variations in antireflection coatings are examples of imperfections that can be the source of the background. Collectively, these flaws are often called “optical artifacts” and when observed in coherent optical systems, are known as “coherent artifacts”.

A commonly used interferometer configuration is known as the Fizeau interferometer. The Fizeau interferometer has many advantages: the optical system is common path with respect to portions of the paths of the measurement and reference beams; it has a minimum number of optical components; and is highly manufacturable. However, the effects of unequal path design or of the portions of the paths that are not common path present a problem which can be eliminated for example by the use of coherent light sources. With the use of a coherent source, light from all locations in the system optics and interferometer, including scattering from small surface defects such as scratches, pits or dust, or volume defects such as bubbles can influence an interferogram. These defects act as light scattering centers and produce characteristic ring patterns called Newton rings or “Bulls-eye” patterns that can imprint onto the interferogram as a result of the coherency of the source and of departures from a strictly common path interferometer design. The imprinted patterns subsequently affect an extracted surface topography.

As a consequence, alternative light sources, mainly with lower temporal coherence, have received more attention in recent years such as in the article by T. Dresel, G. Haeusler, and H. Venske entitled “Three-Dimensional Sensing Of Rough Surfaces By Coherence Radar,” Applied Optics 31, p 919 (1992) and scanning white light interferometers have been introduced for microscopic applications such as described in U.S. Pat. No. 5,398,113 entitled “Method And Apparatus For Surface Topography Measurement By Spatial-Frequency Analysis Of Interferograms” by Peter de Groot. A problem with combining low temporal coherence with Fizeau interferometry is that with a reduced temporal coherence, only backward “scatter” is reduced whereas forward “scatter” is still a problem.

A quantity which causes the primary trouble with respect to coherent artifacts is the high spatial coherence of laser sources, not their high temporal coherence. The effect of the high spatial coherence problem has been reduced in a number of interferometers by the well known technique of lowering the effective spatial coherence where a “point-like” light source is replaced by an incoherent “disk-like” source. The replacement can be implemented by using the laser source to illuminate a slightly defocused spot on a rotating ground glass surface. For Fizeau interferometer configurations with unequal path lengths and using the disk-like source, there is a trade-off between the amount of spatial coherence reduction that can be used and an undesired concomitant reduction of the contrast of interference fringes in an interferogram.

Another method for the reduction of the effects of coherent artifacts is based on the displacement of the test object between the recording of interferograms and the averaging of the phase maps of the individual interferograms such as described in U.S. Pat. No. 5,357,341 entitled “Method For Evaluating Interferograms And Interferometer Thereof” to M. Küchel, K.-H. Schuster, and K Freischlad. For the averaging, the individual surface or wavefront maps are superimposed in such a way that the test piece motion is eliminated. Thus, the coherent noise is displaced in each map while the test piece is stationary. In the average of the individual maps, the coherent noise is reduced while the test piece topography is obtained without loss of resolution. A disadvantage of this technique, however, is that it requires the averaging of a very large number of individual maps. This often is not feasible because of the long data acquisition times required to achieve this.

U.S. Pat. No. 5,357,341 also describes how the angle of the illuminating light from the interferometer may be changed between recording the interferograms to introduce displacements of the coherent noise relative to the effects of the test piece. The illuminating light traces a circular path by means of a rotation of a wedge prism in the path of the illuminating light. The individual surface or wavefront maps obtained from the measured interferograms are superimposed. There is no motion of the test piece and since the angle of the illuminating light in the cavity of the interferometer is constant in magnitude, the respective order of interference of the illuminating light in the cavity is a constant so that no compensation for effects of changes in the order of interference is required in the superposition of the interferograms. However, the coherent noise pattern in each individual map is superimposed at different positions on the surface or wavefront map and the subsequent averaging process leads to a reduction of the coherent noise at high spatial frequencies. A disadvantage of this technique, however, is the same as the disadvantage stated in the preceding paragraph with respect to U.S. Pat. No. 5,357,341.

Another technique has been introduced to reduce the effect of the high spatial coherence problem which replaces the circular path of the illuminating beam and subsequent averaging of phase maps described in U.S. Pat. No. 5,357,341 with an infinitesimal subsection of the incoherent disk-like source that is a concentric ring of point sources such as described in U.S. Pat. No. 6,643,024 B2 entitled “Apparatus And Method(s) For Reducing The Effects Of Coherent Artifacts In An Interferometer” to L. L. Deck, D. Stephenson, E. J. Gratix, and C. A. Zanoni; in International Publication No. WO 02/090880 A1 entitled “Reducing Coherent Artifacts In An Interferometer” by M. Küchel; in International Publication No. WO 02/090882 A1 entitled “Reducing Coherent Artifacts In An Interferometer” by M. Küchel, L. L. Deck, D. Stephenson, E. J. Gratix, and C. A. Zanoni; and in an article by M. Küchel entitled “Spatial Coherence In Interferometry,” subtitled “Zygo's New Method To Reduce Intrinsic Noise In Interferometers,” copyright © 2004 (Zygo Corporation). The contents of U.S. Pat. No. 5,357,341, U.S. Pat. No. 6,643,024 B2, WO 02/090880 A, WO 02/090882 A1, and the article by Küchel are herewithin incorporated in their entirety by reference.

The concentric ring technique comprising a concentric ring of point sources preserves the optimal visibility of the test surface interference fringes and but also imposes its own restrictions on to the maximum cavity length that can be effectively used when effects of diffraction are taken into account. With the concentric ring technique, there are large gains in signal-to-noise ratios for the complete band of spatial frequencies that an interferometer is intended to measure.

Improvements in the reduction of effects of coherent artifacts beyond that achieved by the use of the concentric ring technique are desired in order to obtain a greater reduction of effects of coherent artifacts, extend the limits on the maximum cavity length beyond that achievable with the concentric ring technique, and to achieve compensation for effects of vibrations and environmental changes and reduction of effects of systematic errors in conjunction with the improvement in reduction of the effects of coherent artifacts. The material presented herein shows how such improvements can be achieved using a variable frequency source with a variable output beam direction. With use of the variable frequency source, the benefits of Fizeau-type interferometers using a coherent source are preserved while relaxing restrictions on the maximum length of a cavity of the Fizeau-type interferometer beyond that set when using a concentric ring technique; that preserves the optimal visibility of respective interference fringes; and that achieves at the same time enhanced reduction of the effects of artifacts and other noise for the complete band of spatial frequencies the Fizeau-type interferometer is intended to measure; and that reduces effects of systematic errors.

Phase shifting in homodyne detection methods using phase shifting methods such as piezo-electric driven mirrors have been widely used to obtain high-quality measurements under otherwise static conditions. The measurement of transient or high-speed events have required in prior art either ultra high speed phase shifting, i.e., much faster than the event time scales and corresponding detector read out speeds, or phase shifting apparatus and methods that can be used to acquire the required information by essentially instantaneous measurements.

Several methods of spatial phase shifting have been disclosed in the prior art. In 1983 Smythe and Moore described a spatial phase-shifting method in which a series of conventional beam-splitters and polarization optics are used to produce three or four phase-shifted images onto as many cameras for simultaneous detection. A number of U.S. patents such as U.S. Pat. No. 4,575,248, No. 5,589,938, No. 5,663,793, No. 5,777,741, and No. 5,883,717 disclose variations of the Smythe and Moore method where multiple cameras are used to detect multiple interferograms. One of the disadvantages of these methods is that multiple cameras are required or a single camera recording multiple images and complicated optical arrangements are required to produce the phase-shifted images. The disadvantages of using multiple cameras or a camera recording multiple images are described for example in the commonly owned U.S. patent application Ser. No. 10/765,368 (ZI-47) entitled “Apparatus and Method for Joint Measurements of Conjugated Quadratures of Fields of Reflected/Scattered and Transmitted Beams by an Object in Interferometry” by Henry A. Hill. The contents of patent application Ser. No. 10/765,368 are herein incorporated in their entirety by reference.

An alternative technique for the generation of four simultaneous phase-shifted images for a homodyne detection method has also been disclosed by J. E. Millerd and N. J. Brock in U.S. Pat. No. 6,304,330 B1 entitled “Methods And Apparatus For Splitting, Imaging, And Measuring Wavefronts In Interferometry.” The technique disclosed in U.S. Pat. No. 6,304,330 B1 uses holographic techniques for the splitting of a beam into four beams. The four beams are detected by a single pixelated detector. One consequence of the use of a single pixelated detector to record four phase-shifted images simultaneously is a reduction in frame rate for the detector by a factor of approximately four compared to a PSI recording a single phase-shifted image on a single pixelated detector with the same image resolution. It is further observed that since the generation of the multiple beams in the technique described in U.S. Pat. No. 6,304,303 B1 is performed on a non-mixed beam of an interferometer, the alternative technique of U.S. Pat. No. 6,304,303 B1 is most readily applicable to for example a Twyman-Green type interferometer.

Another alternative technique for generating the equivalent of multiple simultaneous phase shifted images has also been accomplished by using a tilted reference wave to induce a spatial carrier frequency to a pattern in an interferogram, an example of which is disclosed by H. Steinbichler and J. Gutjahr in U.S. Pat. No. 5,155,363 entitled “Method For Direct Phase Measurement Of Radiation, Particularly Light Radiation, And Apparatus For Performing The Method.” This another alternative technique for generating the equivalent of multiple simultaneous phase shifted images requires the relative phase of the reference and measurement field to vary slowly with respect to the detector pixel spacing.

The another alternative technique for generating the equivalent of multiple simultaneous phase shifted images using a tilted reference wave is also used in an acquisition technology product FlashPhase™ of Zygo Corporation. The steps performed in FlashPhase™ are: first acquire a single frame of intensity or interferogram; next generate a two-dimensional complex spatial frequency map by a two-dimensional finite Fourier transform (FFT); next generate a filter and use the filter to isolate a first order signal; and then invert the filtered spatial frequency map by an inverse two-dimensional FFT to a phase map or wavefront map. Although the acquisition technology product FlashPhase™ is computationally complex, it is very fast on today's powerful computers. However, the use of a tilted reference wave introduces departures from the common path condition that impacts of the problem presented by the effects of coherent artifacts.

Other methods of generating simultaneous multiple phase-shifted images include the use of gratings to introduce a relative phase shift between the incident and diffracted beams, an example of which is disclosed in U.S. Pat. No. 4,624,569. However, one of the disadvantages of these grating methods is that careful adjustment of the position of the grating is required to control the phase shift between the beams.

Yet another method for measuring the relative phase between two beams is disclosed in U.S. Pat. No. 5,392,116 in which a linear grating and five detector elements are used. However, this yet another method only measures the difference in height of two adjacent spots on a measurement object and not the simultaneous measurement of a two-dimensional array of spots on the measurement object. The yet another method also generates a set of multiple beams as a mixed beam of an interferometer and therefore has a similar limitation to the technique described in U.S. Pat. No. 6,304,303 B1 wherein the alternative technique of U.S. Pat. No. 6,304,303 B1 is most readily applicable to for example a Twyman-Green type interferometer.

A disadvantage of the techniques for generating simultaneous multiple phase shifted images described in U.S. Pat. No. 6,304,303 B1 is a first order sensitivity to variations in the relative sensitivities of conjugate sets of detector pixels and to variations in corresponding properties of the optical system used to generate the four phase shifted images wherein a conjugate set of pixels is four.

It is noted that wavefront sensing can be accomplished by non-interferometric means, such as with Hartmann-Shack sensors which measure the spatially dependent angle of propagation across a wavefront. These types of sensors are disadvantageous in that they typically have much less sensitivity and spatial resolution than interferometric wavefront sensors.

Variable frequency and multiple frequency sources have been used to measure and monitor the relative path length difference such as described in U.S. Pat. No. 5,412,474 entitled “System For Measuring Distance Between Two Points Using A Variable Frequency Coherent Source” by R. D. Reasenberg, D. Phillips, and M. C. Noecker and in references contained therein. The contents of U.S. Pat. No. 5,412,474 are herein incorporated in their entirety by reference. The variable frequency source techniques have further been used to remove phase redundancy in making absolute distance measurements.

Prior art also teaches the practice of interferometric metrology using heterodyne techniques and a detector having a single detector element or having a relatively small number of detector elements. Prior art further teaches the practice of interferometric metrology using a step and stare method with a single-homodyne detection method for the acquisition of conjugated quadratures of fields of reflected and/or scattered beams when a detector is used that comprises a large number of detector elements. The term single-homodyne method is used hereinafter for homodyne detection methods wherein the reference and measurement beams each comprise one component corresponding to a component of a conjugated quadratures. The respective conjugated quadrature of a field is |a|sin φ when the quadrature x(φ) of the field is expressed as |a|cos φ.

The step and stare method and single-homodyne detection method are used in prior art in order to obtain for each detector element a set of at least three electrical interference signal values with a substrate that is stationary with respect to the respective interferometric metrology system during the stare portion of the step and stare method. The set of at least three electrical interference signal values are required to obtain for each detector element conjugated quadratures of fields of a measurement beam comprising a reflected and/or scattered field from a spot in or on a substrate that is conjugate to the each detector element.

Commonly owned prior art teaches the practice of acquisition of the respective at least three electrical interference signal values in interferometric metrology when operating in a relatively fast scanning mode wherein each of the at least three electrical interference signal values corresponds to the same respective spot on or in a substrate and contain information that can be used for determination of joint measurements of conjugated quadratures of fields in both spatial and temporal coordinates.

Various embodiments presented herein teach the practice of scanning and non-scanning interferometric metrology using a single- and multiple-homodyne detection methods to obtain non-joint and joint measurements, respectively, of conjugated quadratures of fields either reflected and/or scattered or transmitted by a substrate with a detector having a large number of detector elements; that exhibits an intrinsic reduced sensitivity to effects of vibrations and environmental changes; that enables in part compensation of effects of vibrations and of environmental changes; and that can be used where the effects of coherent artifacts are reduced. The classification of multiple-homodyne detection methods is used hereinafter for homodyne detection methods wherein the reference and measurement beams each contain information about two components of each of one or more conjugated quadratures. For each spot in and/or on the substrate that is imaged a corresponding set of at least three electrical interference signal values is obtained. Each of the set of at least three electrical interference signal values contains information for determination of either a non-joint or a joint measurement of respective conjugated quadratures of fields and in addition contains information for the enablement of a procedure for the compensation of effects of vibrations and of environmental changes in the phases corresponding to conjugated quadratures as cyclic errors.

Prior art teaches a homodyne detection method, referenced herein as a double homodyne detection method, that is based on use of four detectors wherein each detector generates an electrical interference signal value used to furnish information about a corresponding component of a conjugated quadratures of a field such as described in cited U.S. Pat. No. 6,304,303 B1 and in Section IV of the article by G. M D'ariano and M G. A. Paris entitled “Lower Bounds On Phase Sensitivity In Ideal And Feasible Measurements,” Phys. Rev.. A49, p 3022 (1994). The four detectors generate the four electrical interference signal values simultaneously and each electrical interference signal value contains information relevant to one conjugated quadratures component. Accordingly, the double homodyne detection method does not make joint determinations of conjugated quadratures of fields wherein each electrical interference value contains information simultaneously about each of two orthogonal components of the conjugated quadratures although the four electrical interference signal values are obtained jointly with respect to time.

The multiple-homodyne detection methods, e.g., the bi-homodyne and quad-homodyne detection methods, obtain measurements of the at least three electrical interference signal values wherein each measured value of an electrical interference signal contains simultaneously information about two orthogonal components of a conjugated quadratures. The faster rate for the determination of conjugated quadratures is achieved when using the quad-homodyne detection method relative to the bi-homodyne detection method to obtain the measured values of the electrical interference signal values in two measurements. The next fastest rate for the determination of conjugated quadratures is obtained when operating the bi-homodyne detection method configured for operation with a set of three phase shift values.

Compensation for effects of vibrations and environmental changes in various embodiments described herein is implemented by two different procedures. In each of the two different procedures, advantage is taken of properties of the described with respect of the enablement of compensation for effects of vibrations and environmental changes as cyclic errors. In one procedure, the reduction of effects of coherent artifacts and the compensation for the effects of vibrations and environmental changes is based on information obtained when operating in a reference frame to reduce the effects of coherent artifacts, vibrations, and environmental changes. The operation in the reference frame enables the generation of a dynamic extended non-coherent source in certain embodiments of the present invention.

In the reference frame, the order of interference associated with a spot on the reference object and a corresponding spot on the measurement object is maintained a constant value mod 1 at a reference frequency when using for example a single homodyne detection method and maintained a constant value mod ¼ at the reference frequency when using for example a bi-homodyne detection method. The reference frequency is controlled by using information from a portion of the reference and measurement beams or a portion of the information contained in the respective two-dimensional arrays of electrical interference signal values corresponding to the corresponding spots on the reference and measurement objects.

A description of the first procedure is given in the corresponding portion of the description of the first embodiment of the present invention. In the second procedure, a spatial frequency is introduced into the relative path length between the reference and measurement beam objects and the effect of the spatial frequency is used in the measurement of the cyclic errors in the phases of measured conjugated quadratures that represent the effects of vibration and environmental changes. The measured values of cyclic errors are used in a subsequent compensation for the effects of vibrations and environmental changes. The measured values of cyclic errors may also be used to monitor changes in position, angular orientation, and/or deformation of a measurement object corresponding to phase measurements mod 2π. The monitored changes in position, angular orientation, and/or deformation corresponding to phase measurements mod 2π can be used as an error signal to a servo systems that control either the reference frequency and/or the relative positions, angular orientations, and/or deformations of the reference and measurement objects corresponding to phase measurements mod 2π.

The error signal used to monitor changes in the relative position of the corresponding portions of the reference and measurement objects comprises two-dimensional spatial Fourier components of the phases of the conjugated quadratures of relative path length differences between the reference and measurement objects corresponding to the cyclic errors. The information about changes in the relative angular orientation of the reference and measurement objects is obtained by using linear displacement information about two different portions of the array of relative path length differences between the reference and measurement objects. The information about changes in relative deformations of the reference and measurement objects is obtained by using linear displacement information about three or more different portions of the array of relative path length differences between the reference and measurement objects.

The spatial frequency is introduced into the relative path length between the reference and measurement beam objects by introducing a tilt between the reference and measurement objects. The role of the tilt which may be used in the present invention is different from the roles of the tilt used in the product FlashPhase™ and in published U.S. Patent Application 20050046864 entitled “Simultaneous phase-shifting Fizeau interferometer” by J. E. Millerd and J. C. Wyant. In Patent Application 20050046864, the tilt is used to make it possible to separate the reference and measurement beams after the reference and measurement objects, respectively, so that the reference and measurement beams can be optically processed separately before subsequently recombining the optically processed reference and measurement beams to form mixed output beams. In FlashPhase™, the tilt is used to introduce a spatial carrier frequency that enables the extraction of conjugated quadratures across a wavefront from a single array of measured electrical interference signal values. The tilt in both cases is not used to generate information about the effect of the vibrations and environmental changes and in addition impacts on the problem presented by coherent artifacts.

In the second procedure used by certain embodiments of the present invention, the tilt is used to generate information about the effects of the vibrations and environmental changes that appear as cyclic errors for subsequent use in compensation for the effects of the vibrations and environmental changes including the effects of rotation and deformations. Accordingly, the second procedure does not impact on the problem presented by coherent artifacts.

With respect to information content and signal-to-noise ratios, the conjugated quadratures of fields obtained jointly in an interferometric metrology system that is operating in a scanning mode and using either the bi-homodyne or quad-homodyne detection methods are substantially equivalent to conjugated quadratures of fields obtained when operating the interferometric metrology system in a step and stare mode, i.e., a non-scanning mode. The conjugated quadratures of fields obtained jointly when operating in the scanning mode and using either the bi-homodyne or the quad-homodyne detection methods also have reduced sensitivity, i.e., only in second and higher order effects, to pinhole-to-pinhole variations in properties of a conjugate set of pinholes used in a confocal microscopy system and reduced sensitivity, i.e., only in second and higher order effects, to pixel-to-pixel variation of properties within a set of conjugate pixels of a multipixel detector in confocal and non-confocal microscopy systems.

The conjugated quadratures of fields obtained jointly when operating in the scanning mode and using either the bi-homodyne or the quad-homodyne detection method further have reduced sensitivity, i.e., only in second and higher order effects, to pulse to pulse variations of the input beam used in generating the conjugated quadratures of fields and can exhibit reduced sensitivity, i.e., only in second and higher order effects, to a relative motion of a substrate being imaged during the acquisition of joint measurements of the conjugated quadratures of fields. The reduced sensitivity is relative to conjugated quadratures of fields obtained when operating with a single-homodyne detection method in either a scanning or non-scanning mode. In microscopy applications, conjugated quadratures of fields are obtained for each spot in and/or on a substrate that is imaged.

The conjugated quadratures of fields that are obtained jointly in a non-dispersion and dispersion linear or angular displacement interferometer operating in a scanning mode and using either the bi-homodyne or the quad-homodyne detection methods have a reduced phase redundancy problem as compared to non-dispersion and dispersion linear or angular displacement interferometer operating in a scanning mode and using a single-homodyne detection method.

The signal-to-noise ratios obtained operating in the reference frame are generally greater than the signal-to-noise ratios obtained when not operating in the reference frame such with the techniques for generating simultaneous multiple phase shifted images in the presence of vibrations and environmental changes. In summary, the various embodiments of the present invention described herein teach how to reduce the effects of coherent artifacts, to compensate for effects of vibrations and environmental effects simultaneously with the reduction of effects of coherent artifacts, and how incorporate the use of the multiple-homodyne detection methods such as the bi- and quad-homodyne detection methods for reduced systematic and statistical errors.

An apparatus and methods are disclosed for the reduction of effects of coherent artifacts in interferometry using a variable frequency, multiple output beam source with variable output beam directions. The variable frequency can be modulated at a rate up to or of the order of a MHz and the variable output beam directions can be modulated at a rate up to or of the order of a 300 kHz. When the source is incorporated in an interferometer, the variable frequency feature is used to maintain the order of interference of the interferometer cavity constant mod 1 as the variable output beam directions are used to generate an extended incoherent source. The interferometer cavity is defined by the test and reference surfaces of the interferometer. The variable frequency feature may further be used in the interferometer to compensate for effects of vibrations and environmental changes simultaneously with the reduction of effects of coherent artifacts. The variable frequency feature may also be employed to modulate the frequency of the variable frequency source to enable use of the bi-homodyne detection method based on temporal encoding. The apparatus and methods are applicable to metrology tools for on-line use during the normal processing cycle of test objects, e.g. surfaces of optical elements and wafers.

The fringe visibility of artifact fringes generated by effects of artifacts or the degree of reduction of effects of coherent artifacts achieved with various embodiments of the present invention depends on the size of the extended source generated by the-variable output beam directions or alternatively the size of the extended source generated by the variable output beam directions is designed according to the desired degree of reduction. The fringe visibility of artifact fringes is the same as achieved with an extended incoherent source that has the same extended source size. The restrictions placed on the maximum cavity length of a respective interferometer are the same as the restrictions place on maximum cavity length for the interferometer using a coherent point source. The fringe visibility of test surface fringes, i.e., fringes containing information about the differences of the test and reference surfaces, achieved with various embodiments of the present invention is the same as achieved with a respective interferometer using a coherent point source. In addition, multiple-homodyne detection methods such as the bi- and quad-homodyne detection methods may be used and compensation for effects of vibrations and environmental changes may be incorporated without altering the performance of an interferometer with respect to fringe visibility of test surface fringes, to reduction of fringe visibility of artifact fringes, and to restrictions placed on maximum cavity length in order to obtain high speed, joint measurements of conjugated quadratures of reflected/scattered measurement beams with reduced systematic errors and a high throughput.

In general, in one aspect, the invention features an interferometric method including: generating a source beam characterized by a variable frequency F; from the source beam, generating a collimated beam propagating at an angle Ω relative to an optical axis; introducing the collimated beam into an interferometer that includes a reference object and a measurement object, wherein at least a portion of the collimated beam interacts with the reference object to generate a reference beam, at least a portion of the collimated beam interacts with the measurement object to generate a return measurement beam, and the reference beam and the return measurement beam are combined to generate a combined beam; causing the angle Ω to have a first value and a second value that is different from the first value; and causing the variable frequency F to have a first value that corresponds to the first value of the angle Ω and then to have a second value that corresponds to the first value of the angle Ω.

Other embodiments include one or more of the following features. The interferometric method further includes scanning the collimated beam over a plurality of different values of the angle Ω and for each of the different values of the angle Ω using a different value for the variable frequency F, wherein the first and second values of the angle Ω are among the plurality of different values of the angle Ω. The different values of the variable frequency F are selected to compensate for changes in an optical path length within the interferometer resulting from changes in the value of the angle Ω. Stated differently, the different values of the variable frequency F are selected to maintain the order of interference of the cavity constant mod 1 for the plurality of values of the angle Ω. The interferometric method further includes, for each value of the angle Ω, causing the collimated beam to assume a plurality of different azimuthal angles relative to the optical axis. The combined beam is an interference beam. The interferometric method further includes detecting the combined beam to generate an interference signal and integrating the interference signal that is generated for the plurality of different values of the angle Ω to generate an interferogram of the measurement object. Scanning the collimated beam is performed to produce an extended source for the interferometer. The interferometer is a wavefront interferometer, e.g. a Fizeau-type interferometer.

In general, in another aspect, the invention features an interferometric method including: generating a source beam characterized by a variable frequency F; from the source beam, generating a collimated beam propagating at an angle Ω relative to an optical axis; interacting at least a portion of the collimated beam with a measurement object to generate a return measurement beam; combining the return measurement beam with a reference beam to generate a combined beam; and scanning the collimated beam over a plurality of different values of the angle Ω and for each of the different values of the angle Ω using a different value for the variable frequency F.

In general, in still another aspect, the invention features an apparatus including: a variable frequency source for generating a beam characterized by a variable frequency F; an interferometer characterized by an optical axis and having a reference object and a stage for holding a measurement object; an optical module for generating from the source beam a collimated beam that propagates at an angle Ω relative to the optical axis of the interferometer and that is delivered to the interferometer, wherein during operation at least a portion of the collimated beam interacts with the reference object to generate a reference beam, at least a portion of the collimated beam interacts with the measurement object to generate a return measurement beam, and the interferometer combines the reference beam and the return measurement beam to generate a combined beam; and a control module that during operation causes the optical module to scan the collimated beam over a plurality of different values of the angle Ω and for each of the different values of the angle Ω causes the variable source to use a different value for the variable frequency F.

Other embodiments include one or more of the following features. The optical module includes: a combination of a first acousto-optic modulator and a second acousto-optic modulator for scanning the source beam over an area, wherein the scanned area represents an extended source for the interferometer. It also includes a diffuser system onto which the source beam is scanned to produce a scattered beam from which the collimated beam is derived and a collimating system which generates the collimated beam from the scattered beam. The measurement object and the reference object define a cavity, and the control module selects the different values of the variable frequency F so as to compensate for changes in the optical path length of the cavity resulting from changes in the value of the angle Ω.

Or, the control module selects the different values of the variable frequency F so as to maintain the order of interference of the cavity constant mod 1 for the plurality of values of the angle Ω. For each value of the angle Ω, the control module during operation also causes the collimated beam to assume a plurality of different azimuthal angles relative to the optical axis. The combined beam is an interference beam. The apparatus further includes a detector assembly that during operation receives the combined beam and generates an interference signal therefrom. The apparatus also includes a processor for integrating the interference signal that is generated for the plurality of different values of the angle Ω to generate an interferogram of the measurement object.

An advantage of certain embodiments of the present invention is the use of a variable frequency extended incoherent source in the reduction of effects of coherent artifacts.

Another advantage of certain embodiments of the present invention is the use of a variable frequency extended incoherent source in the reduction of effects of coherent artifacts where the surface defined by the frequencies of light from the source is related to sections of the surfaces of a family of concentric paraboloids.

Another advantage of certain embodiments of the present invention is the simultaneous reduction of effects of coherent artifacts and the compensation for effects of vibration and environmental changes.

Another advantage of certain embodiments of the present invention is the reduction of effects of coherent artifacts by the operation in a reference frame wherein the order of interference corresponding to the optical path length between a reference object and a corresponding measurement object is maintained a constant value mod 1 at a reference frequency.

Another advantage of certain embodiments of the present invention is high speed measurement of conjugated quadratures of reflected/scattered measurement beams and high throughput:

Another advantage of certain embodiments of the present invention is the reduction of effects of coherent artifacts by the control of the physical path length difference between the reference and measurement objects.

Another advantage of certain embodiments of the present invention is that the signal-to-noise ratios obtained operating in the reference frame are generally greater than the signal-to-noise ratios obtained when not operating in the reference frame such as with prior art techniques based on a concentric ring source or a disk source.

Another advantage of certain embodiments of the present invention is that a one-, two- or three-dimensional image of a substrate may be obtained by an interferometric metrology system when operating in a scanning mode with a relatively fast scan rate. The image comprises a one-, a two-, or a three-dimensional array of conjugated quadratures of reflected and/or scattered or transmitted fields.

Another advantage of certain embodiments of the present invention is that information used in the determination of a conjugated quadratures of reflected and/or scattered or transmitted fields by a substrate is obtained jointly, i.e., simultaneously.

Another advantage of certain embodiments of the present invention is that the conjugated quadratures of fields that are obtained jointly when operating in the scanning mode and using either the bi-homodyne or quad-homodyne detection methods have reduced sensitivity, i.e., only in second and higher order effects, to effects of pinhole-to-pinhole variations in the properties of a conjugate set of pinholes used in a confocal microscopy system that are conjugate to a spot in or on the substrate being imaged at different times during the scan.

Another advantage of certain embodiments of the present invention is that the conjugated quadratures of fields that are obtained jointly when operating in the scanning mode and using either the bi-homodyne or the quad-homodyne detection methods have reduced sensitivity, i.e., only in second and higher order effects, to effects of pixel-to-pixel variation of properties within a set of conjugate pixels that are conjugate to a spot in or on the substrate being imaged at different times during the scan.

Another advantage of certain embodiments of the present invention is that the conjugated quadratures of fields that are obtained jointly when operating in the scanning mode and using either the bi-homodyne or the quad-homodyne detection methods can have reduced sensitivity, i.e., only in second and higher order effects, to effects of pulse to pulse variations of a respective set of pulses or pulse sequences of an input beam to the interferometer system.

Another advantage of certain embodiments of the present invention is an increased throughput for an interferometric metrology system with respect to the number of spots in and/or on a substrate imaged per unit time.

Another advantage of certain embodiments of the present invention is reduced systematic errors in a one-, a two-, or a three-dimensional image of a substrate obtained in interferometric metrology systems.

Another advantage of certain embodiments of the present invention is reduced sensitivity, i.e., only in second and higher order effects, to an overlay error of a spot in or on the substrate that is being imaged and a conjugate image of a conjugate pixel of a multipixel detector during the acquisition of the respective electrical interference values for each spot in and/or on a substrate imaged using interferometric metrology systems. Overlay errors are errors in the set of four conjugate images of a respective set of conjugate detector pixels relative to the spot being imaged for either the bi-homodyne or quad-homodyne detection methods.

Another advantage of certain embodiments of the present invention is that the phase of an input beam component does not affect values of measured conjugated quadratures when operating in a frequency or temporal encoded mode of either the bi-homodyne or quad-homodyne detection methods.

Another advantage of certain embodiments of the present invention is the measurement of relative changes in position, orientation, and/or deformation between the reference and measurement objects based on phase measurements mod 2π.

Another advantage of certain embodiments of the present invention is the compensation for the residual effects of vibration and environmental changes including the effects of rotation and deformation in measured arrays of conjugated quadratures.

Another advantage of certain embodiments of the present invention is the control of the relative positions, orientations, and/or deformations of the reference and measurement objects using the measurements of relative changes in positions, orientations, and/or deformations between the reference and measurement objects based on phase measurements mod 2π.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1a is a diagram of an interferometric metrology system that uses homodyne detection methods.

FIG. 1b is a schematic diagram of an interferometric metrology system of the Fizeau type that uses homodyne detection methods and that may be configured to operate with or without use of phase shifting introduced by a relative translation of reference and measurement objects.

FIG. 1c is a schematic diagram of an external cavity diode laser (ECDL) with beam deflectors in the external cavity.

FIG. 1d is a schematic diagram of a source comprising two lasers operating in a master-slave mode.

FIG. 1e is a graph showing the temporal properties of the frequency of the output beam from an ECDL with beam deflectors in the external cavity.

FIG. 1f is a schematic diagram of an interferometer system of the Twyman-Green type that uses homodyne detection methods configured to operate with modulation of the optical path length difference between the reference and measurement objects.

FIG. 2 is a diagram of an interferometric metrology system and scanning system for scanning a measurement object.

FIG. 3a is a diagrammatic elevational view of a Fizeau-type interferometer.

FIG. 3b is a diagrammatic elevational view of a Fizeau-type interferometer with a scattering site near a reference surface.

FIG. 3c is a graph that shows properties of artifact fringe visibility achieved with an extended incoherent source to reduce effects of coherent noise.

FIG. 3d is a graph that shows properties of artifact fringe visibility achieved with the concentric ring incoherent source to reduce effects of coherent noise.

FIG. 3e is a graph that shows properties of artifact fringe visibility achieved with the variable frequency source to reduce effects of coherent noise.

FIG. 4a is a diagram of a source with a variable output beam direction that uses acousto-optic beam deflectors.

FIGS. 4b is diagram of an optical assembly for receiving an optical beam and generating an output beam comprising two components with wavefront of one output beam component inverted with respect to wavefront of the second output beam component.

FIG. 4c is a diagram of a variable frequency source that uses an optical assembly for receiving an optical beam and generating an output beam comprising two components with wavefront of one output beam component inverted with respect to wavefront of the second output beam component.

FIG. 4d is a graphical representation of properties of the variable frequency source.

FIG. 5 is a diagram of a source with a variable output beam directions that uses a tunable Fabry-Perot resonator.

### DETAILED DESCRIPTION

High speed, high resolution, high precision imaging with high signal-to-noise ratios are required for example in inspection of surfaces of optical elements and surfaces of masks and wafers in microlithography. One technique for obtaining high resolution imaging with high signal-to-noise ratios is interferometric metrology. However, acquisition of high signal-to-noise ratios with the high resolution imaging is generally limited by effects such as effects of coherent artifacts, vibrations, and environmental changes. Also the requirements for high signal-to-noise ratios with the high resolution imaging generally limits data rates in part by the necessity to acquire conjugated quadratures of fields of a reflected and/or scattered or transmitted beam for each spot in and/on a substrate being imaged. The determination of conjugated quadratures requires the measurement of at least three electrical interference signal values for the each spots in and/or on the substrate being imaged (see Section 7 of the article by Schwider, supra.).

It is well known that the effects of coherent artifacts can be suppressed or the fringe visibility of artifact fringes containing information about artifacts is reduced by replacing a point source in an interferometer system such as a Fizeau-type interferometer with a spatially extended incoherent source, i.e., a small disk incoherent source centered at the optical axis of the interferometer system suppresses effects of coherent artifacts. However, such a source in the interferometer system has the drawback that as the degree to which coherent noise from effects of coherent artifacts is suppressed, the visibility of interference fringes or fringe visibility of test surface fringes in interferograms containing information about the differences between test and reference surfaces is reduced. Also the reduction in visibility of test surface fringes increases with the increasing length of the interferometer cavity. Improvements beyond that achieved with the extended incoherent source are obtained with the concentric ring technique.

To understand certain embodiments of the present invention in the context of prior art, it will be useful to first examine the nature of the extended incoherent source. Any extended incoherent source can be thought of as a large number of physically separate incoherent point sources. From the perspective of each source point, the position of an artifact shifts in the field due to parallax. Therefore, a properly imaged final interferometric image can be made to be the sum of images from individual interferograms corresponding to all the incoherent point sources, effectively smearing out the interference patterns stemming from the artifact.

Visibility of Test Surface Fringes

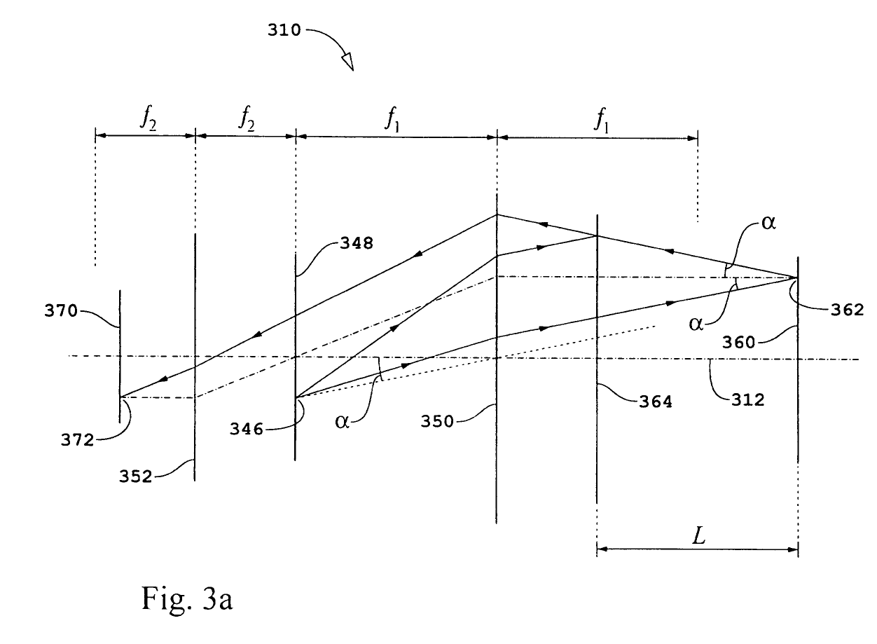

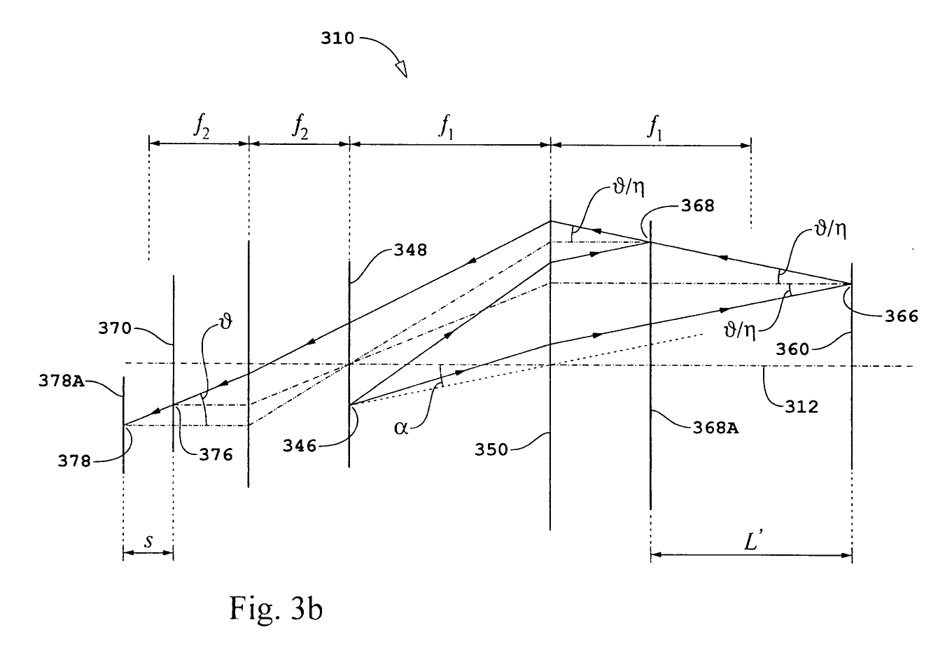

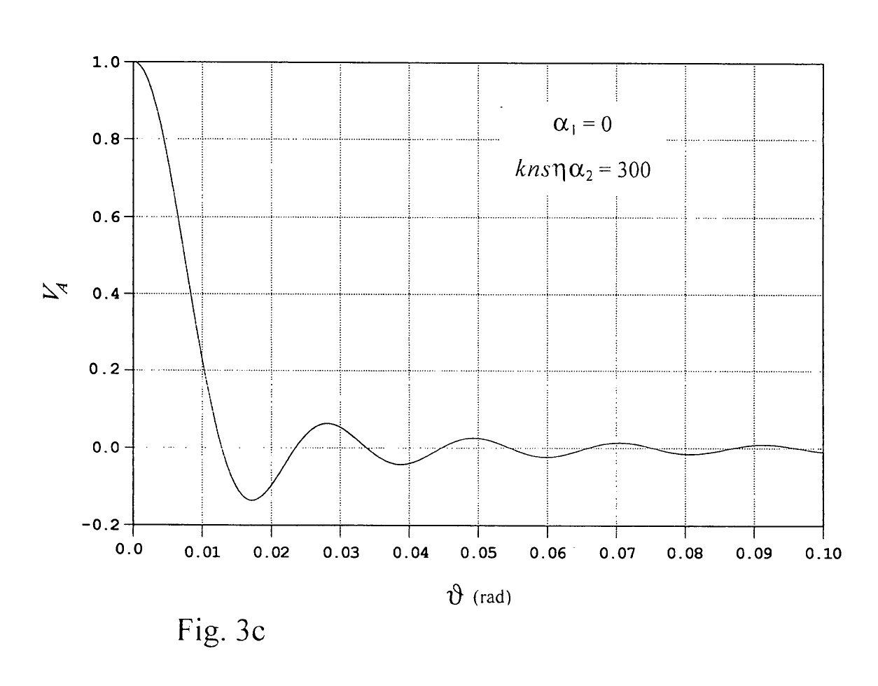

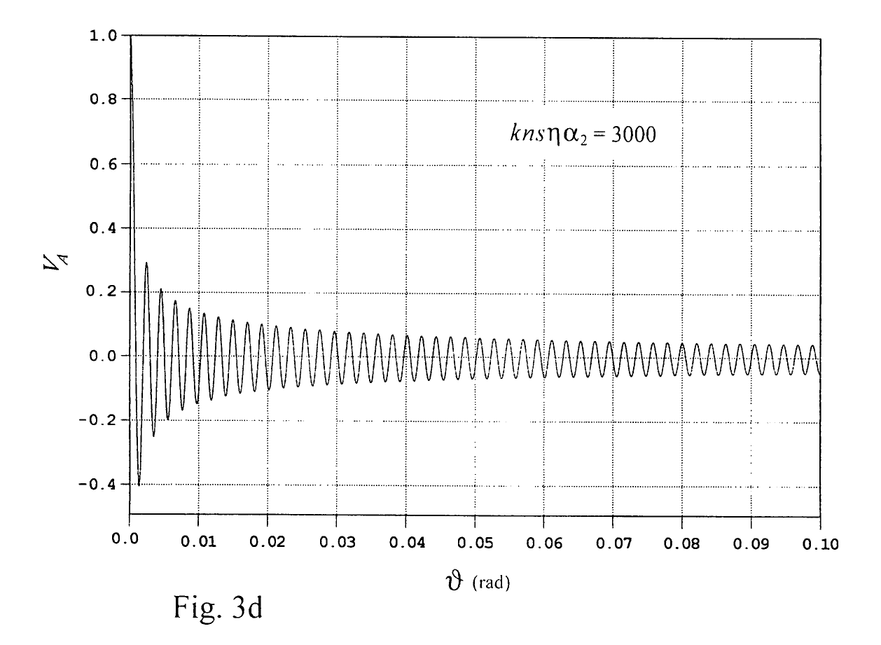

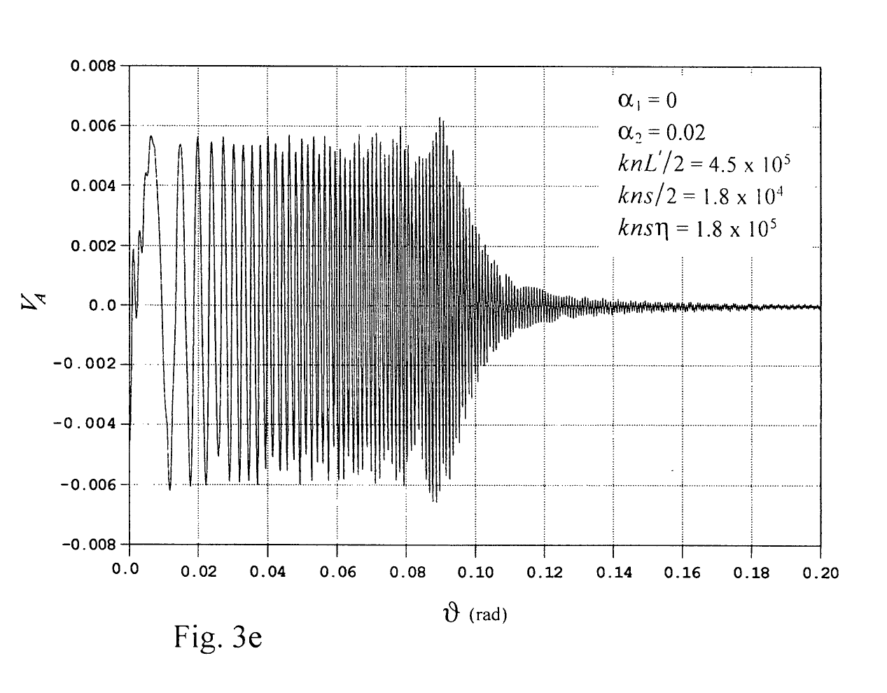

The differences between the effects of the typical extended source; the rotating source of U.S. Pat. No. 5,357,341 and the concentric ring source of U.S. Pat. No. 6,643,024 B2; and the source used in various embodiments of the present invention can be easily demonstrated by considering an interferometer 310 with a Fizeau configuration shown in FIG. 3a. The typical extended disk source and the concentric ring source are discussed herein as two cases of an extended incoherent source in the form of an annulus with inner and outer radii a₁ and a₂, respectively, centered on optic axis 312. The electrical interference signal S associated with a point on the surface of the extended annulus shaped source 348 can be written in the form
S=2|A₁||A₂|cos(φ+φ_{c}) (1)
where φ_{c} is related to the order of interference (2 nL cos α)/λ(r,ψ) of the interferometer cavity, i.e.,

$${φ}_{c} ( P , α ) = \frac{2 π}{λ ( r , ψ )} 2 nL cos α ; \qquad ( 2 )$$

phase φ represents the phase generated by twice the difference in the figures of test surface 360 and reference surface 364; |A₁| and |A₂| are the magnitudes of the amplitudes of the reference and measurement beams, respectively, associated with a point 362 on test surface 360; λ(r,ψ) is the wavelength of the light from point 346 on source 348 located at coordinates (r,ψ); L is the physical distance between test surface 360 and reference surface 364 that form the cavity of interferometer 310; n is the average value of the index of refraction of the medium in the cavity which depends on the path of a measurement beam in the cavity; and α is the half-angle of a cone with an apex located at the test point 362 with an axis parallel to the optical axis 312 of interferometer 310. The radial coordinate r is related to L and α by the formula
r=f₁ tan α (3)
where f₁ is the focal length of lens 350 of interferometer 310.

With an extended incoherent annulus ring source 348 with inner and outer radii a₁ and a₂, respectively, the fringe visibility V(a₁,a₂) of interferometer 310 is related to the radii a₁ and a₂ and cavity length L. Fringe visibility V(a₁,a₂) of fringes containing information about the differences between the test and reference surfaces is obtained as the average electrical interference signal S̅(a₁,a₂) by the integration of electrical interference signal S given by Eq. (1) over the surface of source 348 normalized by the area of source 348, i.e.,

$$\overline{S} ( {a}_{1} , {a}_{2} ) = \frac{2}{( {a}_{2}^{2} - {a}_{1}^{2} )} {\int }_{{a}_{1}}^{{a}_{2}} Sr ⅆ r . \qquad ( 4 )$$

With substitution of Eqs. (1) and (3) into Eq. (4) and assuming that |A₁| and |A₂| are independent of the location of source point 346, average electrical interference signal S̅(a₁,a₂) is expressed by the integral

$$\overline{S} ( {a}_{1} , {a}_{2} ) = 4 {A}_{1} {A}_{2} ( \frac{{f}_{1}^{2}}{{a}_{2}^{2} - {a}_{1}^{2}} ) {\int }_{{α}_{1}}^{{α}_{2}} [ cos ( φ + 2 knL cos α ) ] α ⅆ α \qquad ( 5 )$$

where α₁ and α₂ are the values of α for r=a₁ and r=a₂, respectively.

Trigonometric identities are used to rewrite Eq. (5) as

$$\overline{S} ( {a}_{1} , {a}_{2} ) = 4 {A}_{1} {A}_{2} ( \frac{{f}_{1}^{2}}{{a}_{2}^{2} - {a}_{1}^{2}} ) \times {\int }_{{α}_{1}}^{{α}_{2}} \{ \begin{matrix}cos ( φ + 2 knL ) cos [ 2 knL ( cos α - 1 ) ] - \\ sin ( φ + 2 knL ) sin [ 2 knL ( cos α - 1 ) ]\end{matrix} \} α ⅆ α . \qquad ( 6 )$$

The integration in Eq. (6) is next performed for α₂<<1 with the result

$$\overline{S} ( {a}_{1} , {a}_{2} ) = 4 {A}_{1} {A}_{2} ( \frac{{f}_{1}^{2}}{{a}_{2}^{2} - {a}_{1}^{2}} ) \{ \begin{matrix}[ \begin{matrix}\frac{sin 2 knL ( 1 - cos {α}_{2} )}{2 knL} - \\ \frac{sin 2 knL ( 1 - cos {α}_{1} )}{2 knL}\end{matrix} ] cos ( φ + 2 knL ) - \\ [ \begin{matrix}\frac{cos 2 knL ( 1 - cos {α}_{2} )}{2 knL} - \\ \frac{cos 2 knL ( 1 - cos {α}_{1} )}{2 knL}\end{matrix} ] sin ( φ + 2 knL )\end{matrix} \} . \qquad ( 7 )$$

With the further use of trigonometric identities, Eq. (7) is written in the form

$$\overline{S} ( {a}_{1} , {a}_{2} ) = 4 {A}_{1} {A}_{2} \frac{1}{knL} ( \frac{{f}_{1}^{2}}{{a}_{2}^{2} - {a}_{1}^{2}} ) \times \{ \begin{matrix}\begin{matrix}cos [ knL ( 2 - cos {α}_{2} - cos {α}_{1} ) ] sin \\ [ knL ( cos {α}_{1} - cos {α}_{2} ) ] cos ( φ + 2 knL ) +\end{matrix} \\ \begin{matrix}sin [ knL ( 2 - cos {α}_{2} - cos {α}_{1} ) ] sin \\ [ knL ( cos {α}_{1} - cos {α}_{2} ) ] sin ( φ + 2 knL )\end{matrix}\end{matrix} \} \qquad ( 8 )$$

or alternatively in a contracted form
S̅(a₁,a₂)=2A₁A₂V(a₁,a₂)cos[φ+knL(cos α₂+cos α₁)] (9)
where test surface fringe visibility V(a₁,a₂) is accordingly identified as

$$V ( {a}_{1} , {a}_{2} ) = \frac{2}{knL} ( \frac{{f}_{1}^{2}}{{a}_{2}^{2} - {a}_{1}^{2}} ) sin [ knL ( cos {α}_{1} - cos {α}_{2} ) ] . \qquad ( 10 )$$

The factor [f₁²/(a₂²−a₁²)] in Eq. (7) is next expressed in terms of tan² α₁ and tan² α₂ using the relationship given by Eq. (3) to obtain the result

$$V ( {a}_{1} , {a}_{2} ) = 2 ( \frac{cos {α}_{1} - cos {α}_{2}}{{tan}^{2} {α}_{2} - {tan}^{2} {α}_{1}} ) sin c [ knL ( cos {α}_{1} - cos {α}_{2} ) ] \qquad ( 11 )$$

where sin x=sinc x/x. The formula for test surface fringe visibility V(a₁, a₂) given by Eq. (11) is written in another form where a ratio of small differences is eliminated using trigonometric identities:

$$V ( {a}_{1} , {a}_{2} ) = ( 2 \frac{cos {α}_{1} cos {α}_{2}}{sec {α}_{1} + sec {α}_{2}} ) sin c [ knL ( cos {α}_{1} - cos {α}_{2} ) ] . \qquad ( 12 )$$

The factor 2 cos α₁ cos α₂/(sec α₁+sec α₂) in Eq. (12) is a slowly varying function of α₁² and α₂² compared to the properties of the sinc function in Eq. (12). Advantage is taken of this property by representing the factor in a power series expansion in α₁² and α₂². With the first few lower order terms in the factor retained, Eq. (12) is expressed as

$$V ( {a}_{1} , {a}_{2} ) [ 1 - \frac{3}{4} ( {α}_{1}^{2} + {α}_{2}^{2} ) + … ] sin c [ knL \frac{( {α}_{2}^{2} - {α}_{1}^{2} )}{2} ] . \qquad ( 13 )$$

The argument of the sinc function can be written in terms of the area of the source A_{S} with the result

$$V ( {a}_{1} , {a}_{2} ) = [ 1 - \frac{3}{4} ( {α}_{1}^{2} + {α}_{2}^{2} ) + … ] sin c ( \frac{n}{λ} \frac{1}{{f}_{1}^{2}} {LA}_{S} ) . \qquad ( 14 )$$

The case next considered is that of an extended source of radius a displaced from optic axis 312 by a distance ρ. The average electrical interference signal S̅(ρ,a) is expressed for this case by the integral

$$\overline{S} = ( ρ , a ) = 2 {A}_{1} {A}_{2} \frac{1}{π {a}^{2}} {\int }_{0}^{a} {a}^{′} ⅆ {a}^{′} {\int }_{0}^{2 π} [ cos ( φ + 2 knL cos α ) ] ⅆ ψ \qquad ( 15 )$$

where by the law of cosines cos α can be written as

$$cos α = cos \frac{ρ}{{f}_{1}} cos \frac{{a}^{′}}{{f}_{1}} + sin \frac{ρ}{{f}_{1}} sin \frac{{α}^{′}}{{f}_{1}} cos ψ , \qquad ( 16 )$$

a′ is the radial distance between end point of ρ and a point in extended source, and ψ is the angle between ρ and a′. With the use of Eq. (16), Eq. (15) is rewritten as

$$\overline{S} ( ρ , a ) = 2 {A}_{1} {A}_{2} \frac{1}{π {a}^{2}} {\int }_{0}^{a} {a}^{′} ⅆ {a}^{′} {\int }_{0}^{2 π} [ cos ( \begin{matrix}φ + 2 knL \frac{ρ}{{f}_{1}} cos \frac{{α}^{′}}{{f}_{1}} + \\ 2 knL sin \frac{ρ}{{f}_{1}} sin \frac{{α}^{′}}{{f}_{1}} cos ψ\end{matrix} ) ] ⅆ ψ . \qquad ( 17 )$$

The integration with respect to ψ is next performed with the result

$$\overline{S} ( ρ , a ) = 4 {A}_{1} {A}_{2} \frac{1}{{a}^{2}} {\int }_{0}^{a} [ \begin{matrix}cos ( φ + 2 knL cos \frac{ρ}{{f}_{1}} cos \frac{{α}^{′}}{{f}_{1}} ) \times \\ {J}_{0} ( 2 knL sin \frac{ρ}{{f}_{1}} sin \frac{{α}^{′}}{{f}_{1}} )\end{matrix} ] {a}^{′} ⅆ {a}^{′} \qquad ( 18 )$$

where J₀ is the order 0 Bessel function of the first kind.

The integrand in Eq. (18) is of the same type as the integrand in Eq. (30). An important domain to consider with respect to Eq. (18) is the case where a′≲ the value of a which yields a fringe visibility close to 1. The integration is performed for this restriction with the result

$$\overline{S} ( ρ , a ) = 2 {A}_{1} {A}_{2} cos ( φ + 2 knL cos \frac{ρ}{{f}_{1}} ) \frac{2 {J}_{1} [ 2 knL ( sin \frac{ρ}{{f}_{1}} ) \frac{{a}^{′}}{{f}_{1}} ]}{[ 2 knL ( sin \frac{ρ}{{f}_{1}} ) \frac{{a}^{′}}{{f}_{1}} ]} . \qquad ( 19 )$$

The corresponding fringe visibility V(ρ,a) is

$$V ( ρ , a ) = \frac{2 {J}_{1} [ 2 knL ( sin \frac{ρ}{{f}_{1}} ) \frac{{a}^{′}}{{f}_{1}} ]}{[ 2 knL ( sin \frac{ρ}{{f}_{1}} ) \frac{{a}^{′}}{{f}_{1}} ]} . \qquad ( 20 )$$

The result expressed by Eq. (20) will be used in discussing and designing a variable frequency source.
Test Surface Fringe Visibility/Restriction on Product of Cavity Length and Source Area: Extended Disk and Annulus Ring Sources

An important property exhibited by Eq. (14) is that the argument of the sinc function is proportional to the area A_{S} of the extended incoherent source. As a consequence, a restriction is placed on the maximum value of the product of the cavity length and the source area in order to maintain a certain level of test surface fringe visibility. For a test surface fringe visibility V(a₂,a₁)≳2/π, the corresponding restriction on the product is

$${LA}_{S} ≲ \frac{π}{2} ( \frac{λ}{n} ) {f}_{1}^{2} \qquad ( 21 )$$

independent of whether the source is an extended disk or an annulus in shape. For an example of a test surface fringe visibility of V (a₂,a₁)≳2/π with f₁=0.3 m, a₁=0 mm, a₂=1 mm, and NA_{S}=0.2, the corresponding restriction on the cavity length is L≲0.028 m.
Test Surface Fringe Visibility/Restriction on Product of Cavity Length and Source Area: Concentric Ring of Point Sources Including Effects of Diffraction

For a test surface fringe visibility V(a₂,a₁)≳2/π, there is a corresponding restriction on the product of the cavity length and radius aᵣ of the concentric ring source used in the concentric ring technique. That restriction is obtained using Eq. (13) with the value for (a₂−a₁) determined by the resolution of the source in the radial direction. The limiting resolution in the radial direction is determined by diffraction effects. The diffraction limited resolution in the radial direction is λ/2 nNA_{S} where NA_{S} is the numerical aperture for the source. For a test surface fringe visibility V(a₂,a₁)≳2/π, the resulting limit on the product of the cavity length and radius aᵣ of the concentric ring source is given by the formula

$${La}_{r} ≲ \frac{1}{2} {NA}_{S} {f}_{1}^{2} . \qquad ( 22 )$$

For an example of a test surface fringe visibility V(a₂,a₁)≳2/π with f₁=0.3 m, aᵣ=1 mm, and NA_{S}=0.2, the restriction on the cavity length is L≲9.0 m.
Test Surface Fringe Visibility/Restriction on Product Of Cavity Length and Source Area: Single Point Source and Variable Frequency Source Including Effects of Diffraction

For a test surface fringe visibility V(a₂,a₁)≳2/π, restrictions on the length of cavity for a single point source and on the variable frequency source are the same and arc obtained using Eq. (21) with the values for the respective values of A_{S} determined by the resolution of the source. For a diffraction limited resolution in two orthogonal directions of λ/2 nNA_{S}, the diffraction limited area of the source is approximated as π(λ/4 nNA_{S})². The resulting limits on the cavity lengths for the single point source and the variable frequency source are the same and given by the formula

$$L ≲ 2 ( \frac{n}{λ} ) {NA}_{S}^{2} {f}_{1}^{2} . \qquad ( 23 )$$

For the example of a test surface fringe visibility V(a₂,a₁)≳2/π with f₁=0.3 m, λ=0.63μ, and NA_{S}=0.2, the restriction on the cavity lengths is L≲11 km.

Visibility of Artifact Fringes

With reference to FIG. 3b, the electrical interference signal S_{A} associated with a point on the surface of the extended annulus shaped source 348 and an artifact 368 can be written in the form
S_{A}=2|A₃||A₄|cos φ_{A} (24)
where φ_{A} is the difference in phase between a beam origination from point 366 on test surface 360 and a beam generated by scattering from artifact 368 located on surface 368A and |A₃| and |A₄| are the magnitudes of the amplitudes of the beams, associated with a point 366 on test surface 360 with artifact 368, respectively. The paths of the beam generated by scattering from artifact 368 and the path of the beam originating from point 366 and passing through the location of artifact 368 are common paths post artifact 368. Surface 368A may be displaced from or coincide with reference surface 364 depending on the location of artifact 368. The separation between surface 368A and test surface 360 is L′. L′ may be the same as L or different from L depending on whether the artifact is located on test surface 360 or in or on some other element of interferometer 310.

The conjugate images of point 366 and artifact 368 are points 376 and 378, respectively, located on surfaces 370 and 378A, respectively. The separation of surfaces 370 and 378A is s and the angle of incidence of the common path at point 376 is ηα to a good approximation where η is the magnification of the afocal system formed by lenses 350 and 352.

The phase difference φ_{A} can be expressed as the combination of three phase terms. One phase term represents the spherical wavefront of the beam generated by scattering by artifact 368 converging to image point 378. A second phase term represents the plane wave generated by reflection from test surface 366. The third phase term represents the phase shift introduced by the non-common portions of paths of the beam from source point 346 and subsequently scattered by artifact 368 and from source point 346 and subsequently reflected at test surface point 366. The resulting phase difference φ_{A} is written as follows:
φ_{A}=kn[s(sec θ−cos θ′)−s tan θ sin θ′ cos ψ+2L′ cos α] (25)
where
η tan θ′=tan α, (26)
and angle θ is the angle of incidence of the scattered beam from artifact 368 at surface 378A when the angle of incidence is different from θ′.

Artifact fringe visibility V_{A}(a₁,a₂) of fringes is obtained as the average electrical interference signal S̅_{A}(a₁,a₂) by the integration of electrical interference signal S_{A} given by Eq. (25) over the surface of source 348 normalized by the area of source 348, i.e.,

$${\overline{S}}_{A} ( {a}_{1} , {a}_{2} ) = \frac{1}{π ( {a}_{2}^{2} - {a}_{1}^{2} )} {\int }_{{α}_{1}}^{{α}_{2}} r ⅆ r {\int }_{0}^{2 π} {S}_{A} ⅆ ψ . \qquad ( 27 )$$

With the substitution of Eqs. (3) and (24) into Eq. (27) and assuming that |A₃| and |A₄| are independent of the location of source point 346, average artifact electrical interference signal S̅_{A}(a₁,a2) is expressed by the integral

$$\begin{matrix}{\overline{S}}_{A} ( {a}_{1} , {a}_{2} ) = 2 {A}_{3} {A}_{4} [ \frac{{f}_{1}^{2}}{π ( {a}_{2}^{2} - {a}_{1}^{2} )} ] \times \\ {\int }_{{α}_{1}}^{{α}_{2}} α ⅆ α {\int }_{0}^{2 π} \\ \{ cos kn [ \begin{matrix}s ( sec ϑ - cos {ϑ}^{′} ) + 2 {L}^{′} cos α - \\ s tan ϑ sin {ϑ}^{′} cos ψ\end{matrix} ] \} ⅆ ψ .\end{matrix} \qquad ( 28 )$$

Trigonometric identities are used to rewrite Eq. (28) as

$$\begin{matrix}{\overline{S}}_{A} ( {a}_{1} , {a}_{2} ) = 2 {A}_{3} {A}_{4} [ \frac{{f}_{1}^{2}}{π ( {a}_{2}^{2} - {a}_{1}^{2} )} ] \times \\ {\int }_{{α}_{1}}^{{α}_{2}} α ⅆ α {\int }_{0}^{2 π} \\ \{ \begin{matrix}cos kn [ s ( sec ϑ - cos {ϑ}^{′} ) + 2 {L}^{′} cos α ] \times \\ cos [ kns ( tan ϑ sin {ϑ}^{′} cos ψ ) ] + \\ sin kns [ s ( sec ϑ - cos {ϑ}^{′} ) + 2 {L}^{′} cos α ] \times \\ sin [ kns ( tan ϑsin {ϑ}^{′} cos ψ ) ]\end{matrix} \} ⅆ ψ .\end{matrix} \qquad ( 29 )$$

The integrations in Eq. (29) with respect to ψ are next performed with the result

$$\begin{matrix}{\overline{S}}_{A} ( {a}_{1} , {a}_{2} ) = 4 {A}_{3} {A}_{4} [ \frac{{f}_{1}^{2}}{( {a}_{2}^{2} - {a}_{1}^{2} )} ] \times \\ {\int }_{{α}_{1}}^{{α}_{2}} [ \begin{matrix}cos kn ( s sec ϑ - s cos {ϑ}^{′} + 2 {L}^{′} cos α ) \times \\ {J}_{0} ( kns tan ϑ sin {ϑ}^{′} )\end{matrix} ] α ⅆ α\end{matrix} \qquad ( 30 )$$

Using Eq. (26) to write the sec θ′ in terms of α, Eq. (30) is written as

$$\begin{matrix}{\overline{S}}_{A} ( {a}_{1} , {a}_{2} ) = 4 {A}_{3} {A}_{4} [ \frac{{f}_{1}^{2}}{( {a}_{2}^{2} - {a}_{1}^{2} )} ] \times \\ {\int }_{{α}_{1}}^{{α}_{2}} \{ \begin{matrix}cos kn [ \begin{matrix}s ( sec ϑ - 1 ) + \\ 2 {L}^{′} - {L}^{′} \frac{{α}^{2}}{2}\end{matrix} ] \times \\ {J}_{0} ( kns tan ϑ sin ηα )\end{matrix} \} α ⅆ α\end{matrix} \qquad ( 31 )$$

where leading terms in power expansions of certain trigonometric functions have been retained.
Artifact Fringe Visibility: Single Point Source

The average electrical interference signal S̅_{A} is given by Eq. (28) with a diffraction limited resolution in two orthogonal directions of λ/2 nNA_{S}. From Eq. (28), it is observed that for θ=0 or the diffraction limited value, the artifact fringe visibility V_{A}≳2/π for L′ less than or of the order of the maximum cavity length given by Eq. (23).

Artifact Fringes Visibility: Extended Incoherent Disk Source

Information about the artifact fringe visibility is obtained for the extended incoherent disk source from the integration of Eq. (31). For the domain knL′α²/2≲0.79 wherein the factor cos(knL′α²/2)≳0.7, the integration in Eq. (31) is completed with the approximation that the cos(knL′α²/2) factor is constant and equal to 1. The result is

$$\begin{matrix}{\overline{S}}_{A} ( {a}_{1} , {a}_{2} ) = 4 {A}_{3} {A}_{4} [ \frac{{f}_{1}^{2}}{( {a}_{2}^{2} - {a}_{1}^{2} )} ] \times \\ \frac{1}{( kns η tan ϑ )} \{ \begin{matrix}{α}_{2} {J}_{1} [ ( kns tan ϑ ) {ηα}_{2} ] - \\ {α}_{1} {J}_{1} [ ( kns tan ϑ ) {ηα}_{1} ]\end{matrix} \}\end{matrix} \qquad ( 32 )$$

where J₁ is the order 1 Bessel function of the first kind. The corresponding artifact fringe visibility obtained from Eq. (32) is

$$\begin{matrix}{V}_{A} ≃ [ \frac{{f}_{1}^{2}}{2 ( {a}_{2}^{2} - {a}_{1}^{2} )} ] \times \\ \frac{1}{( kns η tan ϑ )} \{ \begin{matrix}{α}_{2} {J}_{1} [ ( kns tan ϑ ) {ηα}_{2} ] - \\ {α}_{1} {J}_{1} [ ( kns tan ϑ ) {ηα}_{1} ]\end{matrix} \} .\end{matrix} \qquad ( 33 )$$

For the case of α₁=0, the artifact fringe visibility expressed by Eq. (33) reduces to

$${V}_{A} ( {a}_{1} = 0 , {a}_{2} ) = \frac{1}{( kns tan ϑ ) {ηα}_{2}} 2 {J}_{1} [ ( kns tan ϑ ) {ηα}_{2} ] \qquad ( 34 )$$

for the domain knL′α²/2≲0.79. At θ=0, V_{S}(a₁=0,a₂)=1. The parameter (kns tan θ)ηα₂ which is the argument of the Bessel function J₁ in Eq. (34) may be expressed in a form that takes into account the domain restriction knL′α²/2≲0.79. That form is

$$( kns tan ϑ ) {ηα}_{2} = 3.16 ( \frac{ϑ}{{ηα}_{2}} ) . \qquad ( 35 )$$

The asymptotic form of Bessel function J₁(z) is J₁(z)=(2/πz )^{1/2} cos(z−3π/4) so that the artifact fringe visibility for knL′α²/2≲0.79 is

$${V}_{A} ( {a}_{1} = 0 , {a}_{2} ) ≃ \{ \begin{matrix}1 , & ϑ = 0 \\ ≳ 1 / \sqrt{2} , & ϑ < {ηα}_{2} \\ \frac{{2}^{3 / 2}}{{π}^{2}} {( \frac{{ηα}_{2}}{ϑ} )}^{3 / 2} cos [ 3.16 ( \frac{ϑ}{{ηα}_{2}} ) - \frac{3}{4} π ] , & ϑ >> {ηα}_{2}\end{matrix} . \qquad ( 36 )$$

Artifact fringe visibility for the extended incoherent source is shown graphically in FIG. 3c for knsηα₂=300. For an example of λ=0.7μ, n=1, η=5, and L′=0.1 m with knsηα₂=300, the corresponding value for α₂=1.7 mrad.
Artifact Fringe Visibility: Concentric Ring Source

The artifact fringe visibility for a concentric ring source is given by Eq. (31) as
V_{A}=J₀(kns tan θ sin ηα) (37)
The argument of Bessel function J₀ may be written in a convenient form as
kns tan θ sin ηα=knL′α(θ/ρ). (38)

Bessel function J₀(z)≳0.67 for z≲1.2,. The asymptotic form of Bessel function J₀(z) is J₀(z)=(2/πz)^{1/2} cos(z−π/4) so that the artifact fringe visibility is

$${V}_{A} ≃ \{ \begin{matrix}1 & kns tan ϑ sin ηα = 0 \\ ≳ 0.67 & kns tan ϑ sin ηα < 1.2 \\ {( \frac{2}{π} )}^{1 / 2} {( \frac{1}{{knL}^{′}} )}^{1 / 2} {( \frac{ηα}{ϑ} )}^{1 / 2} cos [ {knL}^{′} α ( \frac{ϑ}{η} ) - \frac{π}{4} ] & kns tan ϑ sin ηα >> 1.2\end{matrix} . \qquad ( 39 )$$

Artifact fringe visibility for the concentric ring source is shown graphically in FIG. 3d for knsηα₂=3000. For an example of λ=0.7μ, n=1, η=5, and L′=0.1 m with knsηα₂=3000, the corresponding value for α=17 mrad.

The artifact fringe visibilities shown graphically in FIGS. 3c and 3d are for the same interferometer system except that α of the concentric ring source is 10 times larger than the α that corresponds to α₂ of the extended incoherent disk source. The advantage of the concentric ring technique over the extended incoherent source technique with respect to the width of the respective peaks at θ=0 is evident on inspection of FIGS. 3c and 3d. However, it is also evident from FIGS. 3c and 3d as well as from the asymptotic properties listed in Eqs. (36) and (39) that the extended incoherent source technique has a significant greater reduction of effects of artifact fringes compared to that achieved with the concentric ring technique for values of θ where knsηα₂θ≳6.

Artifact Fringes Visibility: Variable Frequency Extended Incoherent Source

The artifact fringe visibility for the variable frequency source is given by Eq. (31) as

$${V}_{A} ( {a}_{1} , {a}_{2} ) = 2 [ \frac{{f}_{1}^{2}}{( {a}_{2}^{2} - {a}_{1}^{2} )} ] \times {\int }_{{α}_{1}}^{{α}_{2}} \{ cos kn [ s ( sec ϑ - 1 ) + 2 {L}^{′} - {L}^{′} \frac{{α}^{2}}{2} ] \times {J}_{0} ( kns tan ϑ sin ηα ) \} α ⅆ α \qquad ( 40 )$$

where leading terms in power expansions of certain trigonometric functions have been retained.

It is evident from inspection of Eq. (40) that the artifact fringe visibility for the variable frequency source is less than the artifact fringe visibilities obtained when using the extended incoherent disk source or the concentric ring source when one takes into account the corresponding restrictions on α₁ and α₂. Consider first the case where θ=0. The corresponding artifact fringe visibility for the variable frequency source is obtained with the integration of Eq. (40). The result is the same as the test surface fringe visibility given by Eq. (13) except that L is replaced by L′, i.e.,

$${V}_{A} ( {a}_{1} , {a}_{2} ) = [ 1 - \frac{3}{4} ( {α}_{1}^{2} + {α}_{2}^{2} ) + … ] sin c [ {knL}^{′} \frac{( {α}_{1}^{2} + {α}_{2}^{2} )}{2} ] . \qquad ( 41 )$$

Since the restriction on the product of the length of the cavity L′ and the area of the variable frequency source is the same as the restriction for a point coherent source [see the Subsection herein entitled “Artifact Fringe Visibility: Single Point Source”], the artifact fringe visibility for the variable frequency source can be <<1 at θ=0 compared to artifact fringe visibilities for the extended incoherent disk source and the concentric ring source [see Eqs. (36) and (39)].

A second important property of the artifact fringe visibility for the variable frequency source is that the asymptotic form of the artifact fringe visibility has a dependence on θ that is at least as large as the asymptotic dependence on θ of the artifact fringe visibility for the extended incoherent source which in turn is larger than the asymptotic dependence on θ of the artifact fringe visibility for the concentric ring source. This feature of the variable frequency source is shown graphically in FIG. 3e for α₂=0.2 rad, knL′/2=4.5×10⁵, kns/2=1.8×10⁴, and knsη=1.8×10⁵. For an example of λ=0.7μ, n=1, and η=5, L′=0.1 m for the three conditions knL′/2=4.5×10⁵, kns/2=1.8×10⁴, and knsη=1.8×10⁵ which are the same set of parameters used with respect to the examples given in the discussion of FIGS. 3c and 3d with L′=L.

The advantages of the variable frequency source in the reduction of the effects of artifact fringes over the entire range of values of θ are evident on comparison of the results displayed in FIGS. 3c, 3d, and 3e.

Variable Frequency Source

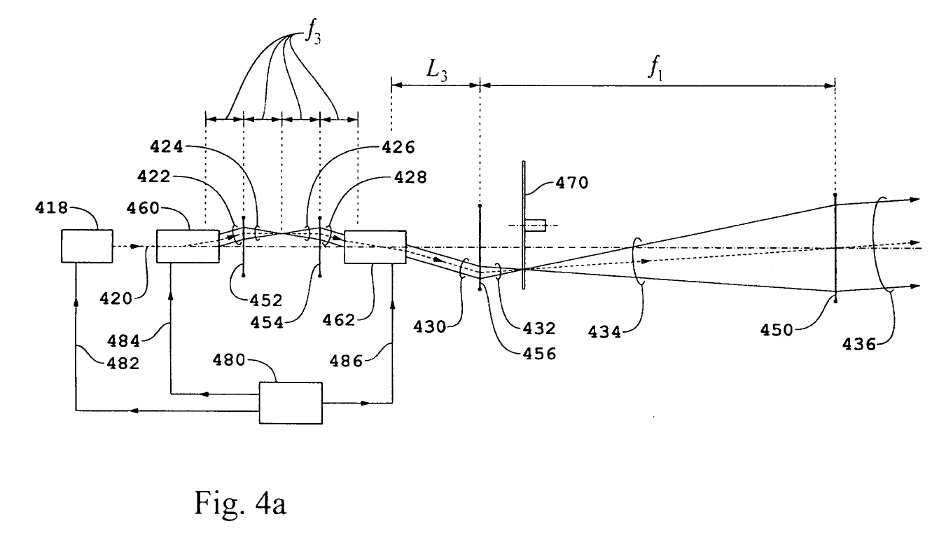

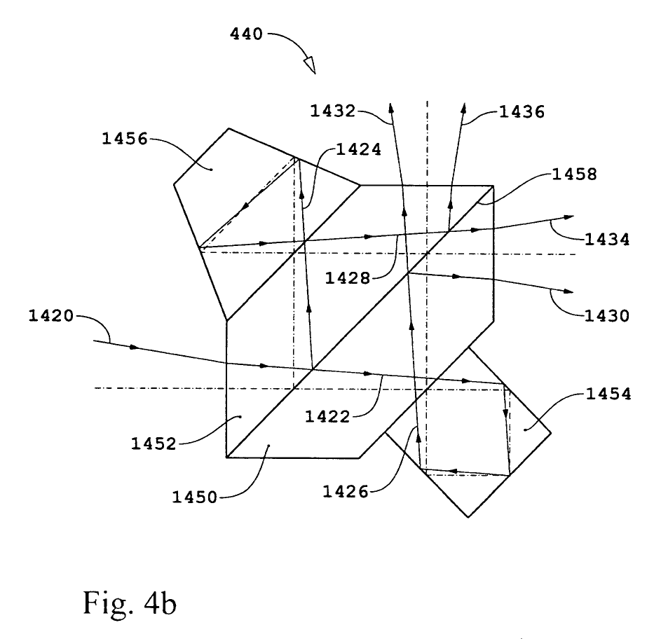

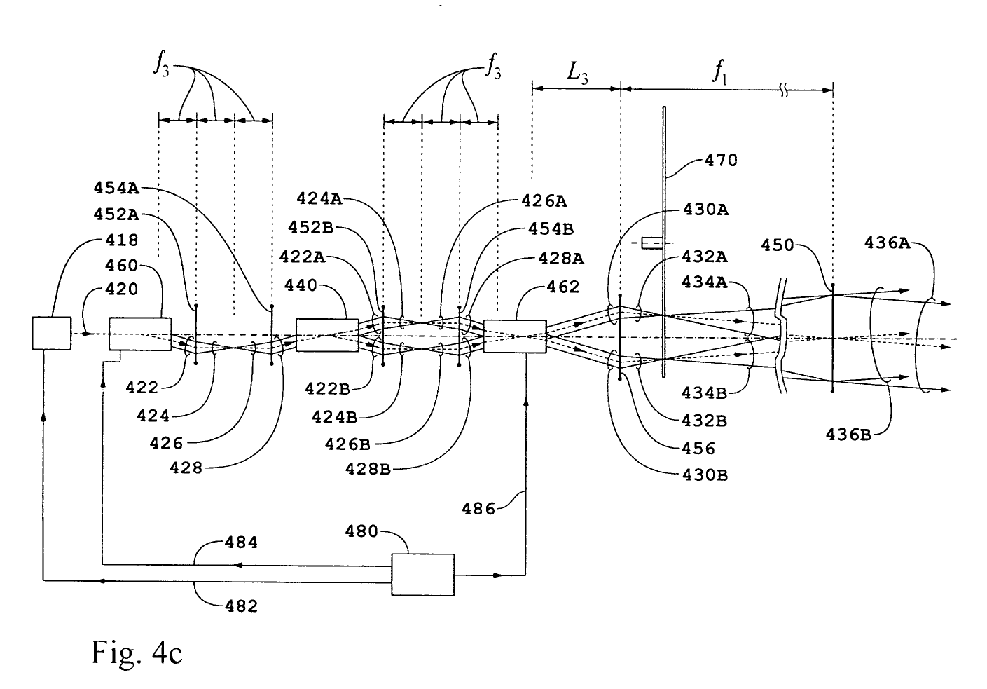

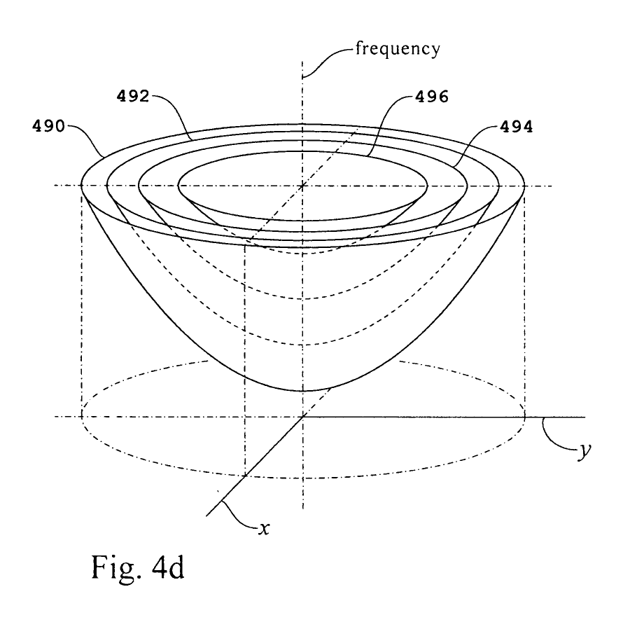

A variable frequency source that has multiple output beams with variable output beam directions is shown diagrammatically in FIG. 4a. The variable frequency source comprises a source 418, acousto-optic modulators 460 and 462 with multi-frequency acousto-optic diffraction, afocal attachment comprising lenses 452 and 454, lens 456 and diffuser 470. Source 418 generates beam 420 at a frequency that is variable as controlled by signal 482 from electronic processor and controller 480. Source 418 and its operation are subsequently described herein in the subsection entitled “Continuously Tunable External Cavity Diode Laser Source.” Electronic processor and controller 480 in this embodiment also perform the processing of the interference signal to integrate the interference signals and compute the interferogram of the surface of the measurement object.

The order of interference φ_{c} [see Eq. (2) and related discussion] of a cavity of an interferometer when using the variable frequency source is maintained constant mod 1 in the presence of the effects of vibrations and environmental changes and independent of the value of α associated with a position in the respective extended source of various embodiments of the present invention, i.e., wavelength λ(r,ψ) corresponding to the frequency of source 418 is controlled such φ_{c} is maintained constant mod 1 as the physical length L, the average value of the index of refraction n, and/or the value of α change. This is achieved in one embodiment in the presence of scanning, e.g., a spiral pattern, at a high speed focused or slightly defocused multiple beams illuminating diffuser 470 over the desired extended source and operation in the reference frame described in the subsection herein entitled “Continuously Tunable External Cavity Diode Laser Source.” Another pattern might be concentric rings, each ring associated with a given fixed angle of the beam(s) relative to the optical axis but scanning over the azimuthal angle. Note, however, that the cross-sectional shape of the desired extended source is not restricted to any one particular shape. Thus the test surface fringe visibility remains close to 1 for the extended source.

The frequency of source 418 is controlled by signal 482 from electronic processor and controller 480 to satisfy the condition that the order of interference is maintained constant mod 1. (Note that the optical path length of the cavity changes as the angle of the collimated beams changes relative to the optical axis; the change in frequency is meant to compensate for this.) As a result, the surface defined by the frequency corresponds to portions of the surfaces of a series of concentric paraboloids such as illustrated in FIG. 4d. The switching or stepping between the surfaces of the set of concentric paraboloids is employed to minimize the dynamic range of the required change in frequency and the set of concentric paraboloids change to compensate for effects of vibration and environmental changes. The extended source is incoherent since the beams from two different points on the extended source either do not overlap in time and/or because of the effect of diffuser 470.

The scan rates of the directions of the multiple output beams are higher, e.g., by factors such as 100 or 1000, than the read-out frame rate of a detector such as a CCD camera used to record a resulting interferogram and to the reciprocal of the integration time per frame of the detector. Thus the source of light used to generate the interferogram is an extended incoherent source with an arbitrary shape, i.e., the extended incoherent source may or may not have an axis of symmetry.

With reference to FIG. 4a, acousto-optic modulator 460 diffracts a portion of collimated beam 420 by acousto-optic interaction as one or more collimated beams 422 in the plane of FIG. 4a according to signal 484 from electronic processor and controller 480. The one or more collimated beams 422 are incident on afocal attachment comprising lenses 452 and 454 to generate corresponding one or more focused beams 424, one or more diverging beams 426, and one or more beams 428. The focal length of lenses 452 and 454 is f₃. Beams 428 are incident on acousto-optic modulator 462 that diffracts a portion thereof as beams 430 in a plane orthogonal to the plane of FIG. 4a according to signal 486 from electronic processor and controller 480. Beams 430 are focused as beams 432 by lens 456 to one or more spots on diffuser 470.

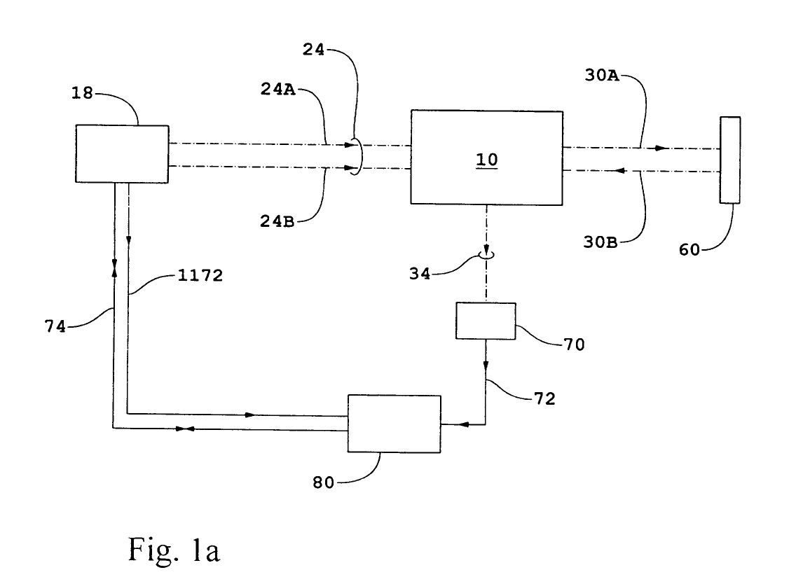

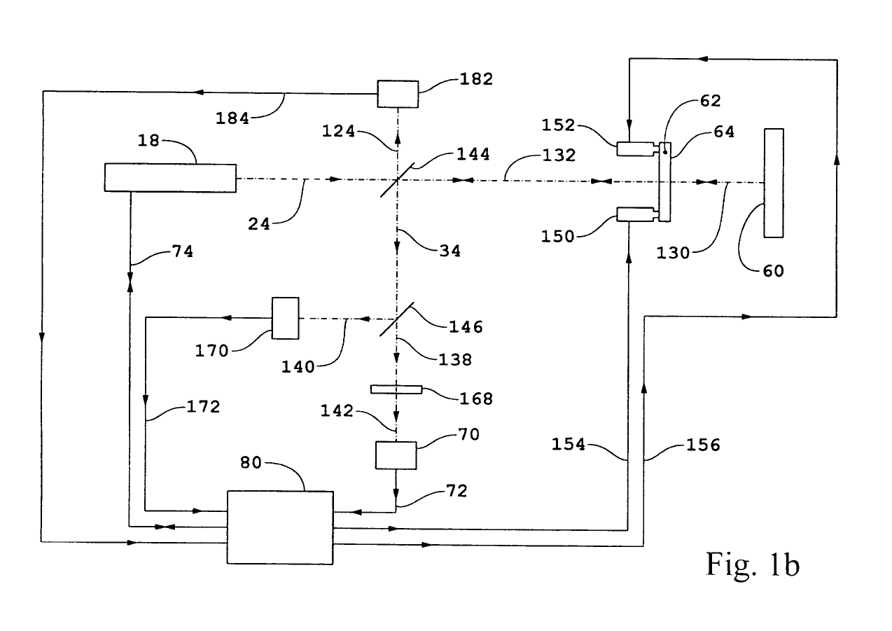

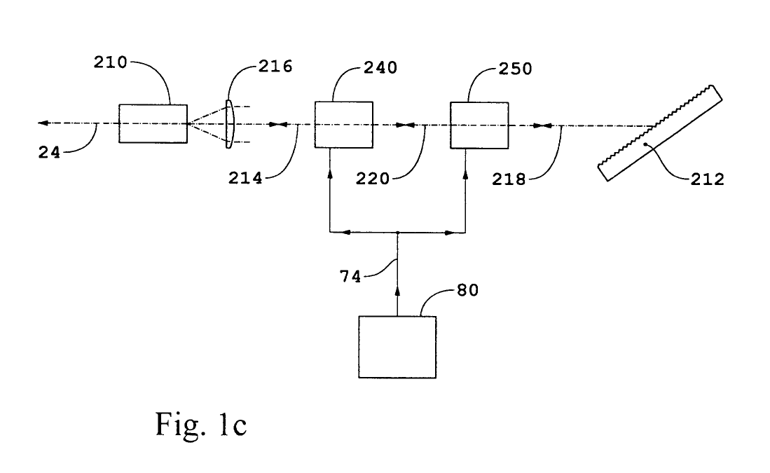

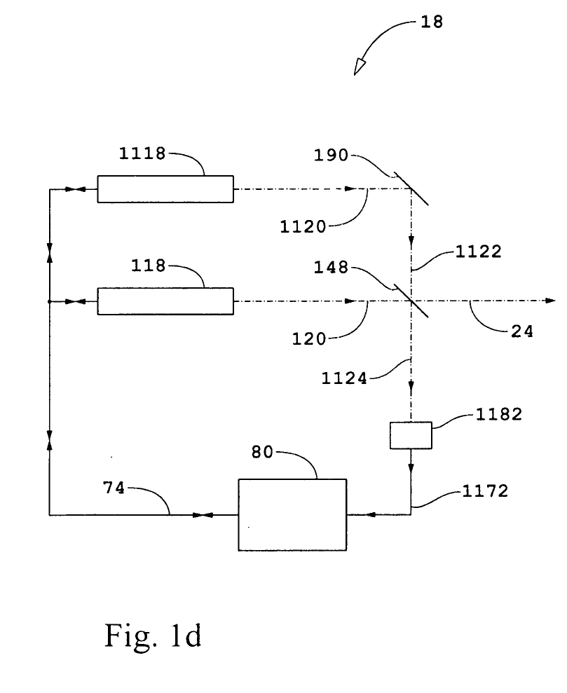

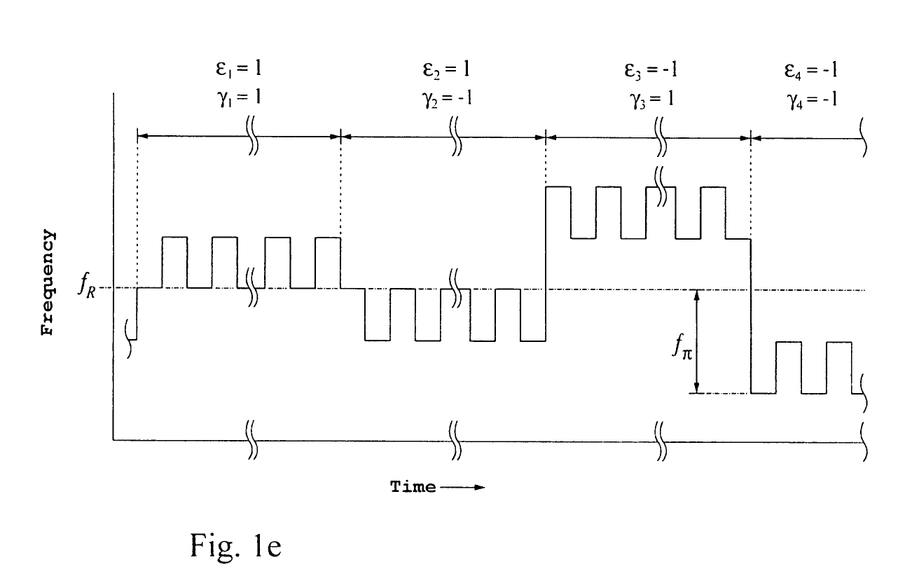

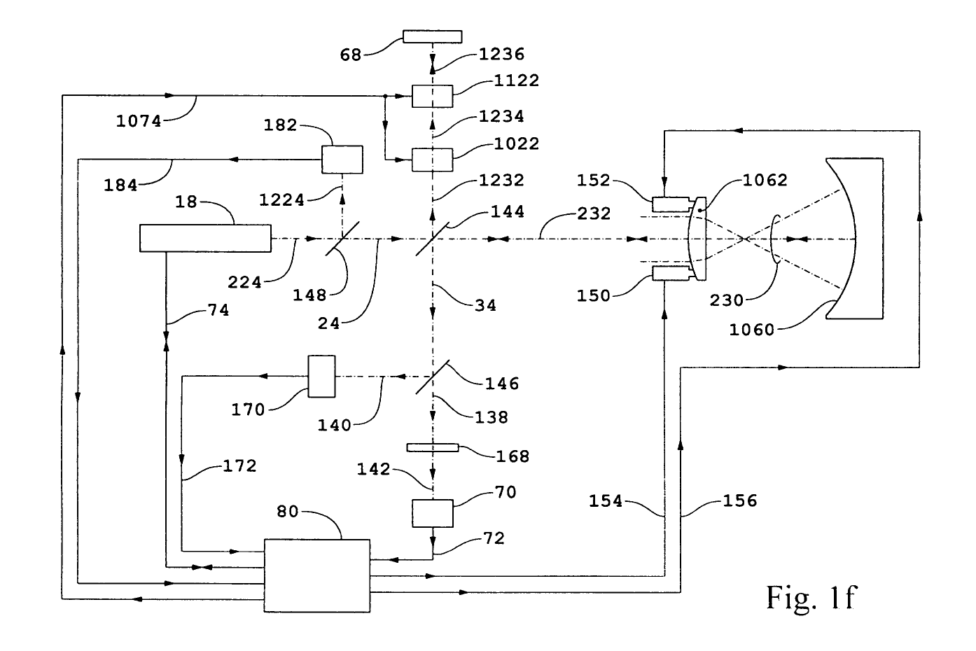

Diffuser 470 comprises one or more scattering disks where at least one is rotating to generate an incoherent source in the plane of diffuser 470 [see for example the discussion in Section 4.2.1 of Laser Speckle and Related Phenomena, Ed. J. C. Dainty, 2^{nd} Ed. Springer-Verlag (1984)]. The properties of the one or more scattering disks are selected so that each of the one or more beams of 432 are diffracted such as to fill the aperture of lens 450 to generate collimated beam 436 (which corresponds to the beam that is input to the wavefront interferometer, e.g. beam 132 in FIG. 1b). The focal length of lens 450 is f₁ and the description of lens 450 is the same as the description given for lens 350 in FIG. 3a. The distance L₃ is selected such that the required size of the extended source is obtained with the range of angles scanned by beams 430 in two orthogonal directions.

The diffracted beams generated by each of acousto-optic modulators 460 and 462 comprise multiple beams as a result of the use of multi-frequency acousto-optic diffraction [see Chapter 5 entitled “Multifrequency Acousto-optic Diffraction” in Acousto-Optic Devices: Principles, Design, and Applications, by J. Xu and R. Stroud, Ed. J. W. Goodman, Wiley (1992)]. The number of frequencies selected, e.g., 2, 3, or 4, depends on the respective values of α and the magnitude of the intermodulation products: the number of frequencies is limited by the requirement of a high test surface fringe visibility in the presence of the multiple values of α corresponding to the multiple frequencies including the components corresponding to the intermodulation products [see for example the article by M. G. Gazalet, J. C. Kastelik, C. Bruneel, O. Bazzi, and E. Bridoux entitled “Acousto-Optic Multifrequency Modulators: Reduction Of The Phase-Grating Intermodulation Products” Applied Optics 32, p 2455 (1993)]. For example, an order of interference decreased by 10 and 11 from the value of the order of interference corresponding to α=0, the use of two corresponding frequencies with the two additional frequencies from intermodulation products reduces the test surface fringe visibility by an average of 1.0% and for an order of interference decreased by 19, 20, and 21 from the value of the order of interference corresponding to α=0, the use of three corresponding frequencies with the four additional frequencies from intermodulation products reduces the test surface fringe visibility by an average of 2.5%.

Acousto-optic modulators 460 and 462 are of the anisotropic Bragg diffraction type with cells comprising for example paratellurite crystals, TeO₂ crystals, or Hg₂Cl₂ crystals. A configuration for acousto-optic modulators 460 and 462 is for example a rotated device such as described in Chapter 6 of Xu and Stroud, ibid.

Another embodiment of a variable frequency source that has a multiple output beams with variable output beam directions is shown diagrammatically in FIG. 4c. The variable frequency source shown in FIG. 4c comprises many of the same elements of the variable frequency source shown in FIG. 4a with the addition of an optical assembly shown generally as element 440 in FIG. 4b to passively double the number of output beams. Afocal attachment comprising lenses 452 and 454 is replaced by afocal attachment comprising lenses 452A and 454A and afocal attachment comprising lenses 452B and 454B with element 440 placed in between the two replacement afocal attachments. The focal lengths of lenses 452A, 454A, 452B, and 454B are f₃. In addition, each of the beams following element 440 that correspond to the beams following acousto-optic modulator 460 in FIG. 4a have the same numeric component with the suffix A in FIG. 4c and the beams generated as a result of the passive doubling by element 440 that are complimentary to the beams with the suffix A in FIG. 4c have the same numeric component with the suffix B.

Optical assembly 440 receives an optical beam 428 and generates an output beam comprising two components 422A and 422B (see FIG. 4c) with the wavefront of one output beam component inverted with respect to the wavefront of the second output beam component. In conjunction with the relative inversion of wavefronts, a change in direction of the input beam introduces changes in directions of the two output beam components that are equal in magnitude but opposite in direction. It is this property that is used to passively double the number of output beams of the source shown in FIG. 4a.

With reference to FIG. 4b, element 440 comprises prism elements 1450, 1452, 1454, and 1456. The interface between prism elements 1450 and 1452 is a non-polarizing beam-splitter interface 1458. Element 1456 is a Penta prism. Input beam 1420 in incident on beam-splitter interface 1458 and a first portion thereof is transmitted as beam 1422 and a second portion thereof is reflected as beam 1424. Beam 1422 is reflected at three surfaces of element 1454 as beam 1426 and beam 1424 is reflected by two surfaces of element 1456 as beam 1428. Beam 1426 is incident on beam-splitter 1458 and a first portion thereof is reflected as output beam 1430 and a second portion thereof is transmitted as a secondary output beam 1432. Beam 1428 is incident on beam-splitter 1458 and a first portion thereof is transmitted as output beam 1434 and a second portion thereof is reflected as a secondary output beam 1436. The directions of changes in the directions of output beams 1430 and 1434 are anti-correlated because of the odd and even number of reflections, respectively, experienced in elements 1454 and 1456, respectively.

The remaining description of the another embodiment of a variable frequency source is the same as corresponding portions of the description given of the embodiment shown in FIG. 4a.

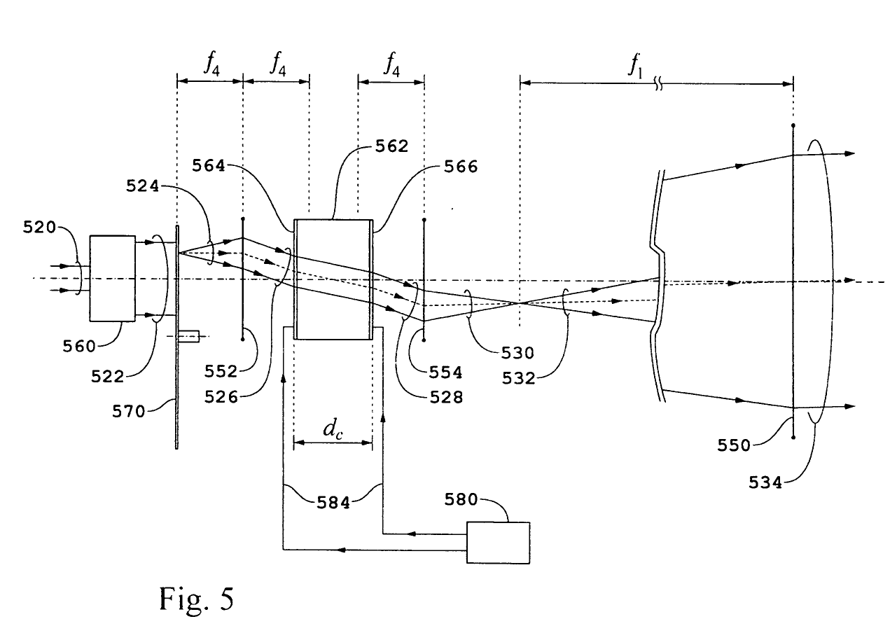

Yet another embodiment of a variable frequency source that has multiple output beams with variable output beam directions is shown diagrammatically in FIG. 5. The yet another embodiment comprises a source such as source 418 shown in FIG. 4a to generate beam 520, an afocal attachment 560 and the afocal attachment formed by lenses 552 and 554 with focal lengths f₄, diffuser 570, and Fabry-Perot resonator 562. Collimated beam 520 is expanded by afocal attachment 560 to generated collimated beam 522. Collimated beam 522 is incident on diffuser 570 that has at least one rotating element to generate a scattered beam with an array of scattered beam components such as scattered beam component 524. Scattered beam component 524 is incident on lens 552 to form collimated beam component 526. Collimated beam component 526 is incident on Fabry-Perot resonator 562 and a portion is transmitted as collimated beam component 528. Collimated beam component 528 is focused by lens 554 as beam component 530 to form a spot on the extended incoherent source. Beam component 532 diverging from the spot is incident on lens 550 to form collimated beam component 534. The description of lens 550 with focal length f₁ is the same as the description given for lens 350 in FIG. 3a.

Fabry-Perot resonator 562 comprises an electro-optic modulator element of thickness d_{c} coated with high-reflectivity dielectric mirrors and transparent electrodes 564 and 566 [see the discussion in Section 8.2 entitled “Electro-Optic Fabry-Perot Modulators” in Optical Waves In Crystals” by A Yariv and P. Yeh, Wiley (1984)]. The medium of resonator 562 is for example z-cut LiNbO₃ or LiTaO₃. The finesse and thickness d_{c} of resonator 562 are selected so that the transmission properties of resonator 562 yield a good fringe visibility for an interferometer using the source. The relationship between the thickness d_{c} of resonator 560 and the length L of the cavity of the interferometer is

$${d}_{c} = \frac{L}{{η}^{2}} \qquad ( 42 )$$

where η≅f₁/f₄ is the magnification of the optical system formed by lenses 552, 554, and 550. The electric field applied to resonator 560 is generated by signal 584 from electronic processor and controller 580 and controlled so that the order of interference of the cavity of the interferometer and of resonator 560 are the same mod an integer. The order of interference of resonator 560 is scanned by signal 584 in conjunction with the corresponding scanning of the frequency of beam 520 so that the full aperture of the extended incoherent source is available for use in generating an interferogram by the interferometer.

A general description is first given wherein effects of coherent artifacts are reduced in measured quantities without placing any limitation of the maximum length of an interferometer cavity, that preserves the optimal visibility of the respective interference fringes; and at the same time reduces, beyond the reduction that can be achieved using the concentric ring source, the effects of artifacts and intrinsic noise for the complete band of spatial frequencies the laser Fizeau-type interferometer is intended to measure.

The effects of vibration and environmental changes and the effects of artifact fringes are reduced in a given array of measured electrical interference signal values, and the resulting residual effects of vibration and environmental changes subsequently compensated. The effects of artifact fringes are reduced by the use of the variable frequency source. Arrays of phases obtained from corresponding arrays of conjugated quadratures that contain information about relative wavefronts of reference and measurement beams are measured with respective first order effects of vibration and environmental changes eliminated. In addition corresponding arrays of rates of phase changes of the array of phases of corresponding arrays of conjugated quadratures are measured with respective first order effects of vibration and environmental changes eliminated. The respective first order effects of vibration and environmental changes for the arrays of phases and the corresponding arrays of rates of phase changes are distinct one from the other, i.e., not the same quantities. Thus the arrays of phases contain errors which correspond to respective even order effects of vibration and environmental changes and the arrays of rate of phase changes contain errors which correspond to respective even order effects for the rate of change of effects of vibration and environmental changes.

Homodyne Detection Methods And Signal Processing

With reference to signal processing, the acquisition of the at least three interference signal values for the each spots places tight restrictions on acceptable levels of effects of coherent artifacts, vibration, and environmental changes and on how large a rate of scan can be employed in generation of images of measurement objects having artifacts down to of the order of 100 nm in size or smaller. Certain embodiments of the present invention relax the tight restriction on levels of vibration and environmental changes for applications of multiple-homodyne detection methods as a consequence of a reduction and compensation for effects of vibrations and environmental changes.

A general description is first given for interferometric metrology systems wherein multiple-homodyne detection methods are used for making joint or substantially joint, and time-delayed measurements of components of conjugated quadratures of fields of bcams reflected/scattered or transmitted/scattered by a measurement object. Referring to FIG. 1a, an interferometric metrology system is shown diagrammatically comprising an interferometer 10, a source 18, detector 70, an electronic processor and controller 80, and a measurement object or substrate 60. Source 18 generates beam 24 comprising one or more components that are encoded using frequency, polarization, temporal, or spatial encoding or some combination thereof.

Frequency encoding is described in commonly owned U.S. Provisional Patent Application No. 60/442,858 (Z1-47) and U.S. patent application Ser. No. 10/765,368 (Z1-47). Polarization encoding is described in commonly owned U.S. Provisional Patent Application No. 60/459,425 (Z1-50) and U.S. patent application Ser. No. 10/816,180 (Z1-50) wherein both are entitled “Apparatus and Method for Joint Measurement of Fields of Scattered/Reflected Orthogonally Polarized Beams by an Object in Interferometry” and both are by Henry A. Hill, the contents of which are herein incorporated in their entirety by reference. Temporal encoding is described in commonly owned U.S. Provisional Patent Application No. 60/602,046 (Z1-57) and U.S. patent application Ser. No. 11/204,758 (Z1-57) wherein both are entitled “Apparatus and Method for Joint And Time Delayed Measurements of Components of Conjugated Quadratures of Fields of Reflected/Scattered and Transmitted/Scattered Beams by an Object in Interferometry” by Henry A. Hill, the contents of which are herein incorporated in their entirety by reference. Spatial encoding is described in commonly owned U.S. Provisional Patent Application No. 60/501,666 (Z1-54) and U.S. patent application Ser. No. 10/938,408 (Z1-54) wherein both are entitled “Catoptric and Catadioptric Imaging Systems With Adaptive Catoptric Surfaces” and both are by Henry A. Hill, the contents of which are herein incorporated in their entirety by reference.

Input beam 24 is formed with components 24A and 24B that each comprise one or more encoded components. The relative orientation of polarizations of different components of beams 24A and 24B may be parallel or orthogonal or at some other angle according to the requirements of an end use application. The measurement beam components 24B of input beam 24 are coextensive in space and the corresponding reference beam components 24A are coextensive in space and have the same temporal window function as the temporal window function of the corresponding components of the measurement beam components although measurement beam components 24B and reference beam components 24A may be either spatially separated or spatially coextensive.

Measurement beam 30A incident on substrate 60 is generated either directly from beam 24B or in interferometer 10. Measurement beam 30B is a return measurement beam generated as a portion of measurement beam 30A reflected/scattered or transmitted/scattered by substrate 60. Return measurement beam 30B is combined with reference beam 24A in interferometer 10 to form output beam 34.

Output beam 34 is detected by detector 70 preferably by a quantum process to generate electrical interference signals for multiple-homodyne detection methods as signal 72. Detector 70 may further comprise an analyzer to select common polarization states of the reference and return measurement beam components of beam 34 to form a mixed beam. Alternatively, interferometer 10 may comprise an analyzer to select common polarization states of the reference and return measurement beam components such that beam 34 is a mixed beam.

In the practice, known phase shifts are introduced between the encoded reference and measurement beam components of output beam 34 by one or more different techniques depending on the method of encoding used in a homodyne detection method. In one technique, phase shifts are introduced between certain of the corresponding encoded reference and measurement beam components of input beam 24 by source 18 as controlled by a component of signal 74 from electronic processor and controller 80. In another technique, phase shifts are introduced between certain other of the corresponding encoded reference and measurement beam components as a consequence of a non-zero optical path difference between the reference and measurement objects in interferometer 10 and corresponding frequency shifts introduced to the certain other encoded components of input beam components 24A and 24B by source 18 as controlled by a component of signal 74 from electronic processor and controller 80 such as described in a corresponding portion of the description of the first embodiment of the present invention. In yet another technique, phase shifts are introduced between other certain other of the corresponding encoded reference and measurement beam components as a consequence of relative translations of the reference and measurement objects as controlled by electronic processor and controller 80 such as described in a corresponding portion of the description of the first embodiment of the present invention.

There are different ways to configure source 18 to meet the input beam requirements of different embodiments of the present invention. For applications where interferometer 10 is an interferometer such as a Fizeau or a Twyman-Green type interferometer, a combination of frequency and temporal encoding can be used with or without use of phase shifting introduced by a relative translation of reference and measurement objects for multiple-homodyne detection methods.

Continuing with the description of different ways to configure source 18 to meet the input beam requirements of different embodiments of the present invention, source 18 may comprise a pulsed source and/or a shutter. There are a number of different ways for producing a pulsed source comprising one or more frequencies such as described in referenced U.S. Provisional Patent Application No. 60/602,046 (Z1-57) and U.S. patent application Ser. No. 11/204,758 (Z1-57). Source 18 may be configured using for example beam-splitters to generate an output beam comprising two or more encoded components to form a coextensive measurement beam and a coextensive reference beam that are either spatially separated beams for input beam 24 or form a coextensive beam for input beam 24 as required in various embodiments of the present invention.

Source 18 may be configured using other techniques, e.g., acousto-optic modulators (AOMs), described in referenced U.S. Provisional Patent Applications No. 60/602,046 (Z1-57) and No. 60/442,858 (Z1-47) and U.S. patent applications Ser. No. 11/204,758 (Z1-57) and No. Ser. 10/765,368 (Z1-47). Source 18 may also be configured using intra-cavity beam deflectors in ECDLs such as described in commonly owned U.S. Provisional Patent Application No. 60/699,951 (Z1-72) by Henry A. Hill; U.S. Provisional Patent Application No. 60/805,104 (Z1-78) by Henry Hill, Steve Hamann, and Peter Shifflett; and U.S. patent application Ser. No. 11/457,025 (Z1-72) by Henry Hill, Steve Hamann, and Peter Shifflett wherein each of the provisional and non-provisional patent applications are entitled “Continuously Tunable External Cavity Diode Laser Sources With High Tuning Rates And Extended Tuning Ranges” and in commonly owned U.S. Provisional Patent Application No. 60/706,268 (Z1-71) and U.S. patent application Ser. No. 11/463,036 (Z1-71) wherein both are entitled “Apparatus and Methods of Reducing and Compensating for the Effects of Vibrations and Environment in Wavefront Interferometry” and both are by Henry A. Hill. The contents of the three provisional and two non-provisional applications are herein incorporated in their entirety by reference.

The first embodiment of the present invention is shown diagrammatically in FIG. 1b and is operated with a reference frame and a reference optical frequency f_{R} or corresponding reference wavelength λ_{R} wherein the order of interference corresponding to corresponding to the relative optical path length between a spot on surface 64 and a corresponding spot on measurement object 60 is maintained constant mod 1 at the reference optical frequency f_{R}. The first embodiment comprises interferometer 10 configured as a Fizeau interferometer that uses homodyne detection methods based on a combination of temporal and frequency encoding with or without use of phase shifting introduced by a relative translation of reference and measurement objects 62 and 60. The homodyne detection methods exhibit an intrinsic reduced sensitivity to vibrations and environmental changes.

In FIG. 1b, source 18 generates input beam 24 with a single frequency component that is switched between selected frequency values with a switching frequency that is preferably high compared to the frequencies of the effects of vibration and environmental changes that may be present. Source 18 of the first embodiment shown diagrammatically in FIG. 1c comprises an ECDL such as described in referenced U.S. Provisional Patent Application No. 60/699,951 (Z1-72) and No. 60/805,104 (Z1-78) and U.S. patent application Ser. No. 11/457,025 (Z1-72). In addition, the reference and measurement beam components of input beam 24 are coextensive in space for the first embodiment.

Continuously Tunable External Cavity Diode Laser Source

The ECDL is a continuously tunable external cavity source comprising a coherent light source and a dispersive system. The dispersive system directs a selected wavelength from the coherent light source back into the coherent light source by either diffraction and/or refraction. Two features of an external cavity comprising a dispersive system is a first order sensitivity of the double pass path length of the external cavity to lateral shears of a beam incident on the dispersive system and a first order sensitivity of the wavelength of the selected wavelength to changes in the direction of propagation of a beam incident on a dispersive element of the dispersive system. The ECDL exploits both of these features to obtain continuously tunable external cavity diode laser sources with high tuning rates and extended tuning ranges in comparison to prior art which exploits only the second of the two features.

Source 18 configured as an ECDL in a Littrow configuration is shown diagrammatically in FIG. 1c comprising grating 212. The ECDL further comprises laser source 210, beam forming optics 216, phase modulator 240, beam deflector 250, and electronic processor and controller 80. The output beam is beam 24.

Source 210 and beam forming optics 216 generate an intra-cavity collimated beam as a component of beam 214. The collimated component of beam 214 is incident on phase modulator 240 and a portion thereof is phase shifted as phase shifted component of beam 220. A portion of the phase shifted beam component of beam 220 is subsequently deflected by beam deflector 250 as deflected beam component of beam 218.

For the Littrow cavity configuration shown in FIG. 1c, a portion of the deflected component of beam 218 is diffracted as a diffracted component of beam 218. The path of diffracted beam component of beam 218 through the external cavities of FIG. 1c to source 210 coincides with the components of the intra-cavity components propagating to the right in FIG. 1c. A portion of diffracted beam component of beam 218 incident on source 210 is double passed by the cavity of source 210 after reflection by a reflector on the left side of source 210. The double passed beam corresponds to the component of collimated beam component of beam 214.

Also for the Littrow cavity configuration shown in FIG. 1c, a second portion of the diffracted beam component of beam 218 incident on source 210 is transmitted by the reflector on the left side of source 210 as output beam 24.

The two features of an external cavity with a dispersive system are exploited by the introduction and use of phase modulator 240 and beam deflector 250 which generate both phase shifts and changes in direction of propagation of intra-cavity beams. The amount of phase shift and change in direction of propagation of the intra-cavity beams generated by phase modulator 240 and beam deflector 250 are controlled by components of signal 74 from electronic processor and controller 80. Phase modulator 240 and beam deflector 250 may comprise either electro-optic modulators (EOMs) or AOMs. The properties of the ECDL are listed in Table 1 for a set of different media used as birefringent media for phase modulator 240 and beam deflector 250 configured as EOMs.

It is relevant to note that the tuning ranges in frequency and wavelength are equal to 2δf and 2Δλ, respectively. The response time τ is the response time for changing the frequency of the ECDL without mode hoping between different longitudinal modes of the external cavity.

The function of source 18 in the first embodiment may alternatively be served by use of a master-slave source configuration such as shown diagrammatically in FIG. 1d. With reference to FIG. 1d, the frequency of laser 1118 are controlled by a servo feedback as a component of signal 74 to control the frequency difference between the frequencies of master and slave lasers 118 and 1118, respectively. The frequency of laser 118 is controlled by a component of signal 74 from electronic processor and controller 80. A first portion of beam 120 generated by laser 118 is transmitted by a non-polarizing beam-splitter 148 as a first component of output beam 24 and a second portion of beam 120 is reflected by non-polarizing beam-splitter 148 as a first component of beam 1124. A first portion of Beam 1120 generated by laser 1118 is reflected by mirror 190 as beam 1122. A first portion of beam 1122 is reflected by non-polarizing beam-splitter 148 as a second component of output beam 24 and a second portion of beam 1122 is transmitted by non-polarizing beam-splitter 148 as a second component of beam 124.

TABLE 1
Performance Properties Of ECDLs Configured With Electro-Optic Effect
Modulators: Littrow External Cavity

| | δf/V | V₂ | δf | Δλ | τ |
|---|---|---|---|---|---|
| Medium | (MHz/volt) | (volts) | (GHz) | (nm) | (n sec) |
| LiNbO₃ | 14.4 | 100 | 1.4 | 0.0019 | 12 |
| | | 400 | 5.8 | 0.0077 | |
| BSN x = 0.60 | 126 | 10 | 1.26 | 0.00167 | 18 |
| | | 40 | 5.0 | 0.0067 | |
| | | 100 | 12.6 | 0.0167 | |
| | | 400 | 50.2 | 0.0670 | |
| BSN x = 0.75 | 732 | 10 | 7.3 | 0.0097 | 39 |
| | | 40 | 29 | 0.039 | |
| | | 100 | 73 | 0.097 | |
| | | 400 | 293 | 0.39 | |

The components of beam 124 are mixed with respect to polarization in detector if beam 124 is not a mixed beam and detected by detector 1182 preferably by a quantum process to generate electrical interference signal 1172. The difference in frequencies of beams 120 and 1120 corresponds to the frequency of electrical interference signal 1172. The difference in frequencies is compared to a value determined by electronic processor and controller 80 to generate an error signal. The error signal is used by electronic processor and controller 80 to a generate servo control signal component of signal 74 to control the frequency of laser 1118 relative to the frequency of laser 118.

With reference to FIG. 1b, interferometer interferometer 10 comprises non-polarizing beam-splitter 144, reference object 62 with reference surface 64; measurement object 60; transducers 150 and 152; detectors 70, 170, and 182; and electronic processor and controller 80. Input beam 24 is incident on non-polarizing beam splitter 144 and a first portion thereof transmitted as beam 132 and a second portion thereof reflected as monitor beam 124. Beam 132 is subsequently incident on reference object 62 and a first portion thereof reflected by surface 64 of object 62 as a reflected reference beam component of beam 132 and a second portion thereof transmitted as a measurement component of beam 130. The measurement beam component of beam 130 is incident on measurement object 60 and a portion thereof reflected/scattered as a reflected measurement beam component of beam 130. The reflected measurement beam component of beam 130 is incident on reference object 62 and a portion thereof transmitted as the reflected measurement beam component of beam 132. The reflected reference and measurement beam components of beam 134 are next incident on beam-splitter 144 and a portion thereof reflected as output beam 34.

Continuing with the description of the first embodiment, output beam 34 is incident on non-polarizing beam-splitter 146 and first and second portions thereof transmitted and reflected, respectively, as beams 138 and 140, respectively. Beam 138 is detected by detector 70 preferably by a quantum process to generate electrical interference signal 72 after transmission by shutter 168 if required to generate beam 142 as a gated beam. Shutter 168 is controlled by electronic processor and controller 80. The function of shutter may be alternatively served by a shutter integrated into detector 70. Electrical interference signal 72 contains information about the difference in surface profiles of surface 64 and the reflecting surface of measurement object 60.

Beam 140 is incident on and detected by detector 170 preferably by a quantum process to generate electrical interference signal 172 to generate the respective transmitted beam as a mixed beam. If beam 140 is not a mixed beam, it is passed through an analyzer in detector 170 to form a mixed beam prior to detection by detector 170. Detector 170 comprises one or more high speed detectors where each of the high speed detectors may comprise one or more pixels. The photosensitive areas of each of the one or more high speed detectors overlaps a portion of the wavefront of beam 140. Electrical interference signal 172 contains information about the relative changes in the optical path lengths between the reference and measurement objects 62 and 60 at positions corresponding to the portions of the wavefront of beam 140 incident on each of the high speed detectors. The information contained in electrical interference signal 172 is processed and used by electronic processor and controller 80 to establish and maintain the reference frame and to detect changes in relative orientation and/or deformation of the reference and measurement objects 62 and 60.

Beam 124 is incident on detector 182 and detected preferably by a quantum process to generate electrical interference signal 184. Electrical interference signal 184 is processed and used by electronic processor and controller 80 to monitor and control the amplitude of beam 24 through a component of signal 74.

An advantage is that electrical interference signal 172 is processed by electronic processor and controller 80 using a homodyne detection method that is compatible with the multiple-homodyne detection method used by electronic processor and controller 80 to process electrical interference signal 72. In particular, if the first embodiment is configured to use multiple-homodyne detection methods based on a sequence of N≧3 phase shift values for the processing of electrical interference signal 72, the homodyne detection method used to process electrical interference signal 172 can be and is configured to operate with the same sequence of N≧3 phase shift values so as to not impose any restrictions on the selection of sequences of phase shift values and on the processing of electrical interference signals 72.

The homodyne detection method used to process electrical interference signal 172 takes advantage of the property of the multiple-homodyne detection methods wherein joint measurements of components of conjugated quadratures are measured, the temporal encoding used in the multiple-homodyne detection methods, and of the use of the reference frame. The homodyne detection method is in addition different from the multiple-homodyne detection methods with respect to sampling or integration times of respective detectors. The switching time of source 18 and the sampling time or integration time of detector 170 are much less than the inverse of the bandwidth of the effects of vibration and of environmental changes. The sampling time or integration time of detector 70 is based on signal-to-noise considerations including both systematic and statistical error sources. Accordingly, information about changes in the optical path length between the reference and measurement objects 62 and 60 due to effects of vibrations and effects of environmental changes can be obtained without imposing any restrictions on the sampling or integration times of detector 70 or on the processing of electrical interference signals 72.

The homodyne detection method used to process electrical interference signal 172 corresponds to a variant of a single homodyne detection method that takes advantage of the electrical interference signal values 172 being acquired in the reference frame of the first embodiment. In the reference frame, the phase of the conjugated quadratures is maintained zero or substantially zero by a feedback system. As a consequence, only one component of the respective conjugated quadratures needs to be monitored in order to detect changes in the relative displacement of reference and measurement objects 62 and 60. The one component of the respective conjugated quadratures corresponds to the component that is nominally equal to zero and which exhibits an extremum in sensitivity to changes in the relative optical path length. Since the phase shift associated with the difference in frequency of the two components of input beam 24 corresponding to two components of a conjugated quadratures is π/2, the associated difference between the two respective, i.e., contiguous, interference signal values contains in the first embodiment information about the component of the conjugated quadratures that has an extremum in sensitivity to changes in the relative optical path length. The information is in the form of ± the component of the conjugated quadratures which will be further described in the description of the first embodiment of the present invention.

The value of the optical frequency of the ECDL used as source 18 is controlled by components of signal 74 from electronic processor and controller 80 as drive voltages V₁ and V₂ for EOM beam deflectors 140 and 150, respectively. The relationship between V₁, V₂, and the optical frequency of the ECDL is described in referenced U.S. Provisional Patent Applications No. 60/706,268 (Z1-71), No. 60/699,951 (Z1-72), and No. 60/805,104 (Z1-78) and U.S. patent applications Ser. No. 11/463,036 (Z1-71) and No. Ser. 11/457,025 (Z1-72). The value of the reference frequency f_{R} will change as the difference in physical path length l between the reference and measurement objects changes due for example to vibrations and as the index of refraction of a refractive medium, e.g., gas, in the optical path of the measurement beam between the reference and measurement objects changes due for example to environmental changes. Changes in the relative optical path length due to vibrations and environmental effects are detected by monitoring the component of the conjugated quadratures of electrical interference signal 172 and the measured changes used as an error signal to control the value of reference frequency f_{R} by controlling the voltages V₁ and V₂ such that the optical path length is kept constant mod 2π. Actual knowledge of reference frequency f_{R} or of the physical path length l is not required.

In a given reference frame, the rate of change of a frequency of beam 24 with respect to the phase of electrical interference signal 72 is required to implement a homodyne detection method. That rate of change is denoted as f_{π}, the change in frequency of beam 24 required to introduce a π phase shift in the conjugated quadratures representing the electrical interference signal 72. The rate of frequency change per π phase shift change f_{π} is determined by first measuring the value of the electrical interference signal value as a function of changes of frequency of the ECDL and then analyzing the measured time sequence of the conjugated quadratures representing the electrical interference signal 72 for a value of f_{π}. The measured value of f_{π} is used in the implementation of either single- or multiple homodyne detection methods for electrical interference signal 72.

It is important to note that knowledge of the value of l is not required a priori and as noted above, the actual physical path length difference l is not measured in the determination of f_{π}. It is also important to note that the actual value of f_{π} need not measured or used as a frequency but the corresponding values of changes in voltages, V_{1,π} and V_{2,π}, are measured and subsequently used. Accordingly, the actual physical path length difference l is not measured and can not be determined from knowledge of V_{1,π} and V_{2,π} without knowledge of the conversion of changes in V₁ and V₂ to changes in frequency of the ECDL.

The waveforms of drive voltages V₁ and V₂ are preferably rectangle functions. Shown in FIG. 1e is the corresponding frequency of beam 24. The corresponding binary modulation of the frequency of beam 24 between two different frequency values is used in temporal encoding of the reference and measurement beams and in particular does not generate two frequency components such as when using source 18 configured as a master and slave lasers 118 and 1118. For the multiple-homodyne detection methods, the period of the rectangle functions is much less than the periods defined by the binary states of εⱼ and γⱼ (see the description of εⱼ and γⱼ given herein with respect to the bi-homodyne detection method).

With reference to FIG. 1b, the phase shifting is achieved either with shifting the frequencies of components of input beam 24 or in conjunction with phase shifting introduced by translation and/or rotation of reference object 62 by transducers 150 and 152 which are controlled by signals 154 and 156, respectively, from electronic processor and controller 80. A third transducer located out of the plane of FIG. 1b (not shown in figure) is used to introduce changes in angular orientation of reference object 62 that are orthogonal to the changes in angular orientation introduced by transducers 150 and 152.

By operating in the reference frame, the integration or sampling time for detector 70 can be selected to optimize the signal-to-noise ratio for the conjugated quadratures obtained from analyzing the arrays of electrical interference values 72 independent of vibration effects and environmental effects that generate linear and/or rotational displacement effects. In the reference frame, measurement object 60 is stationary with respect to reference object 62 with respect to linear and/or rotational displacement effects. Therefore the integration or sampling time controlled by shutter 168 or a shutter in detector 70 may be long compared to a characteristic time of vibrations and environmental changes that generate linear and/or rotational displacement effects. The effects of rotation and deformation and gradients in environmental changes can be reduced by a rotation and/or deformation of reference object 62 relative to measurement object 60 by use of transducers and/or compensated in processing of measured arrays of electrical signal values.

Bandwidth for reduction of effects of vibration and environmental changes can be of the order of the maximum frequency switching time of source 18 which is of the order of 1 MHz for a source such as the ECDL described in referenced U.S. Provisional Patent Applications No. 60/706,268 (Z1-71), No. 60/699,951 (Z1-72), and No. 60/805,104 (Z1-78) and U.S. patent applications Ser. No. 11/463,036 (Z1-71) and Ser. No. 11/457,025 (Z1-72). The wavelength of the ECDL may for example be in the visible or infrared. With respect to the signal acquisition and processing, the conjugated quadratures of fields of return measurement beams are obtained by making a set of at least three measurements of the electrical interference signal 72. In the single-homodyne detection method, a known sequence of phase shifts is introduced between the reference beam component and the return measurement beam component of the output beam 34 in the acquisition of the at least three measurements of the electrical interference signal 72. A sequence of commonly used four phase shift values is 0, π/4, π/2, and 3π/2. For reference, the data processing procedure used to extract the conjugated quadratures of the reflected/scattered fields for the set of phase shifts values for a single-homodyne detection method is the same as the corresponding procedure described for example in U.S. Pat. No. 6,445,453 (Z1-14) entitled “Scanning Interferometric Near-Field Confocal Microscopy” by Henry A. Hill, the contents of which are incorporated herein in their entirety by reference. The processing procedure is also described by Schwider supra.

The bi-homodyne detection method uses a single detector element for each electrical interference signal value obtained and an input beam to an interferometer system comprising two encoded components wherein each encoded component corresponds to a component of a conjugated quadratures. The encoding may be employ frequency encoding such as described in referenced U.S. Provisional Patent Application No. 60/442,858 (Z1-47) and U.S. patent application Ser. No. 10/765,368 (Z1-47); polarization encoding such as described in referenced U.S. Provisional Patent Application No. 60/459,425 (Z1-50) and U.S. patent application Ser. No. 10/816,180 (Z1-50); temporal encoding such as described in referenced U.S. Provisional Patent Application No. 60/602,046 (Z1-57) and U.S. patent application Ser. No. 11/204,758 (Z1-57); and spatial encoding such as described in referenced U.S. Provisional Patent Application No. 60/501,666 (Z1-54) and U.S. patent application Ser. No. 10/938,408 (Z1-54).

One encoded component of a reference beam and a corresponding encoded component of a measurement beam are used to generate an electrical interference signal component corresponding to a first component of conjugated quadratures of a field of a corresponding measurement beam comprising either a reflected and/or scattered or transmitted field from a spot in or on a measurement object that is conjugate to the detector element. A second encoded component of the reference beam and a corresponding encoded component of the measurement beam are used to generate a second electrical interference signal component corresponding to a respective second component of the conjugated quadratures of the field. Information about the first and second components of the conjugated quadratures are obtained jointly as a consequence of the two encoded components of the reference beam being coextensive in space and the two corresponding encoded components of the measurement beam being coextensive in space and also having the same or effectively the same temporal window function in the interferometer system.

The quad-homodyne detection method uses two detectors and an input beam to an interferometer system comprising four coextensive measurement beams and corresponding reference beams in the interferometer system simultaneously to obtain four electrical signal values wherein each measured value of an electrical interference signal contains simultaneously information about two orthogonal components of a conjugated quadratures for a joint measurement of conjugated quadratures of a field of a beam either reflected and/or scattered or transmitted by a spot on or in a substrate. One detector element is used to obtain two electrical interference signal values and the second detector element is used to obtain two other of the four electrical interference signal values.

The four coextensive measurement beams and corresponding reference beams are generated in the interferometer system simultaneously by using an input beam that comprises four frequency components wherein each frequency component corresponds to a measurement and corresponding reference beam. The frequency differences of the four frequency components are such that the four frequency components are resolved by an analyzer into two beams incident on the two different detector elements wherein each of the two beams comprises two different frequency components and the frequency differences are large compared to the frequency bandwidth of the detector. One of the two frequency components incident on a first detector element is used to generate an electrical interference signal component corresponding to a first component of conjugated quadratures of a field of a corresponding measurement beam comprising either a reflected and/or scattered or transmitted far-field or near-field from a spot in or on a measurement object that is conjugate to a detector element. The second of the two frequency components incident on the first detector element is used to generate a second electrical interference signal component corresponding to a respective second component of the conjugated quadratures of the field. The description for the second detector element with respect to frequency components and components of conjugated quadratures is the same as the corresponding description with respect to the first detector element.

Information about the first and second components of the conjugated quadratures are accordingly obtained jointly as a consequence of the four frequency components being coextensive in space and having the same temporal window function in the interferometer system. The temporal window function when operating in a scanning mode corresponds to the window function or a respective envelop of a frequency component of input beam 24 to the interferometer system.

Referring to the single- and bi-homodyne detection methods used in various embodiments of the present invention, a set of at least three electrical interference signal values are obtained for each spot on and/or in substrate 60 being imaged. The set of at least three electrical interference signal values Sⱼ, j=1,2,3, . . . ,q where q is an integer, used for obtaining conjugated quadratures of fields for a single spot on and/or in a substrate being imaged is represented for the single- and bi-homodyne detection methods within a scale factor by the formula

$${S}_{j} = {P}_{j} \{ \begin{matrix}{ξ}_{j}^{2} {\vert {A}_{1} \vert}^{2} + {ζ}_{j}^{2} {\vert {B}_{1} \vert}^{2} + {η}_{j}^{2} {\vert {C}_{1} \vert}^{2} + {ζ}_{j} {η}_{j} 2 \vert {B}_{1} \vert \vert {C}_{1} \vert cos {φ}_{{B}_{1} {C}_{1} {ɛ}_{j}} + \\ {ξ}_{j} {ζ}_{j} 2 \vert {A}_{1} \vert \vert {B}_{1} \vert cos {φ}_{{A}_{1} {B}_{1} {ɛ}_{j}} + {ɛ}_{j} {ξ}_{j} {η}_{j} 2 \vert {A}_{1} \vert \vert {C}_{1} \vert cos {φ}_{{A}_{1} {C}_{1} , j} + \\ {ξ}_{j}^{2} {\vert {A}_{2} \vert}^{2} + {ζ}_{j}^{2} {\vert {B}_{2} \vert}^{2} + {η}_{j}^{2} {\vert {C}_{2} \vert}^{2} + {ζ}_{j} {η}_{j} 2 \vert {B}_{2} \vert \vert {C}_{2} \vert cos {φ}_{{B}_{2} {C}_{2} {γ}_{j}} + \\ {ξ}_{j} {ζ}_{j} 2 \vert {A}_{2} \vert \vert {B}_{2} \vert cos {φ}_{{A}_{2} {B}_{2} {γ}_{j}} + {γ}_{j} {ξ}_{j} {η}_{j} 2 \vert {A}_{2} \vert \vert {C}_{2} \vert cos {φ}_{{A}_{2} {C}_{2} , j}\end{matrix} \} \qquad ( 43 )$$

where φ_{A}_{₁}_{C}_{₁}_{,j} and φ_{A}_{₂}_{C}_{₂}_{,j} include the effects of the phase shifts introduced by vibrations, environmental changes, and/or a tilt between reference and measurement object 62 and 60; coefficients A₁ and A₂ represent the amplitudes of the reference beams corresponding to the first and second frequency components of the input beam; coefficients B₁ and B₂ represent the amplitudes of background beams corresponding to reference beams A₁ and A₂, respectively; coefficients C₁ and C₂ represent the amplitudes of the return measurement beams corresponding to reference beams A₁ and A₂, respectively; Pⱼ represents the integrated intensity of the first frequency component of the input beam during the integration period used by detector 70 to acquire electrical interference signal value Sⱼ; and εⱼ=±1 and γⱼ=±1. The change in the values of εⱼ and γⱼ from 1 to −1 or from −1 to 1 correspond to changes in relative phases of respective reference and measurement beams. The coefficients ξⱼ, ζⱼ, and ηⱼ represent effects of variations in properties of a conjugate set of four pinholes such as size and shape if used in the generation of the spot on and/or in substrate 60 and the sensitivities of a conjugate set of four detector pixels corresponding to the spot on and/or in substrate 60 for the reference beam, the background beam, and the return measurement beam, respectively.

A set of values for εⱼ and γⱼ is listed in Table 2 for single-homodyne detection methods when using a set of 4 phase shift values. The phase shifting algorithm corresponding to εⱼ and γⱼ values listed in Table 2 as a schedule 1 corresponds to the algorithm based on the standard set of four phase shift values of 0, π/2, π, and 3π/2. The corresponding single-homodyne detection method exhibits a first order sensitivity to effects of vibrations and environmental changes with a peak in sensitivity at a zero frequency value for components of the Fourier spectrum of effects of vibrations and environmental changes.

A phase shift algorithm based on five phase shift values that exhibits a second order sensitivity to effects of vibrations and environmental changes was introduced by J. Schwider, R. Burow, K.-E. Elssner, J. Grzanna, R. Spolaczyk, and K. Merkel in an article entitled “Digital wave-front measuring interferometry: some systematic error sources,” Appl. Opt. 22, pp 3421-3432 (1983) (also see discussion by P. de Groot in an article entitled “Vibration in phase-shifting interferometry,” J.

TABLE 2
Single-Homodyne Detection Method: Schedule 1

| j | εⱼ | γⱼ | εⱼγⱼ |
|---|---|---|---|
| 1 | +1 | 0 | 0 |
| 2 | 0 | +1 | 0 |
| 3 | −1 | 0 | 0 |
| 4 | 0 | −1 | 0 |

K. Merkel in an article entitled “Digital wave-front measuring interferometry: some systematic error sources,” Appl. Opt. 22, pp 3421-3432 (1983) (also see discussion by P. de Groot in an article entitled “Vibration in phase-shifting interferometry,” J. Opt. Soc. Am. A 12, pp 354-365 (1995)). The phase shift algorithm based on five phase shift values exhibits in addition to the second order sensitivity a peak in sensitivity at a non-zero frequency value for components of the Fourier spectrum of effects of vibrations and environmental changes. The phase shift algorithm based on five phase shift values was later popularized by P. Hariharan, B. F. Oreb, and T. Eiju in an article entitled “Digital phase-shifting interferometry: a simple error-compensating phase calculation algorithm,” Appl. Opt. 26, pp 2504-2506 (1987) and by J. E. Breivenkamp and J. H. Bruning in an article entitled “Phase shifting interferometry,” in Optical Shop Testing, D. Malacara, ed. (Wiley, N.Y., 1992). The advantage represented by a second order sensitivity as compared to a first order sensitivity has been important for large-aperture interferometry because of the difficulty in precisely calibrating piezoelectric transducers that perform the phase stepping and because of complications that arise with fast spherical cavities.

There are sets of four phase shift values disclosed herein for use in single-homodyne detection methods that also exhibit only a second order sensitivity to effects of vibrations and environmental changes, e.g., a first set 0, π/2, −π/2, and ±π and a set π/2, 0, ±π, and −π/2. A set of values of εⱼ and γⱼ corresponding to a second set of phase shifts 0, π/2, −π/2, and ±π is listed in Table 3 as Schedule 2. The algorithm based on the first set of phase shift values listed in Table 3 exhibits only a second order sensitivity to effects of vibrations and environmental changes with a peak in sensitivity at a non-zero frequency value for components of the Fourier spectrum of effects of vibrations and environmental changes.

TABLE 3
Single-Homodyne Detection Method: Schedule 2

| j | εⱼ | γⱼ | εⱼγⱼ |
|---|---|---|---|
| 1 | +1 | 0 | 0 |
| 2 | 0 | +1 | 0 |
| 3 | 0 | −1 | 0 |
| 4 | −1 | 0 | 0 |

Table 4 lists as schedule 3 a set of values for εⱼ and γⱼ for a bi-homodyne detection method that corresponds to the standard set of phase shifts 0, π/2, π, and 3π/2 which is the same as Table 1 in U.S. Provisional Patent Application No. 60/442,858 (Z1-47) and U.S. patent application Ser. No. 10/765,368 (Z1-47). The bi-homodyne detection method using the set of values of εⱼ and γⱼ listed in Table 4 exhibits a first order sensitivity to effects of vibration and environmental changes with a peak in sensitivity at a zero frequency value for components of the Fourier spectrum of effects of vibrations and environmental changes.

There are disclosed herein sets of values of εⱼ and γⱼ, an example of which is listed in Table 5 as schedule 4, for a bi-homodyne detection method that exhibits for a sequence of q phase shift values where q is an even integer value a second order sensitivity to effects of vibrations.

TABLE 4
Bi-Homodyne Detection Method: Schedule 3

| j | εⱼ | γⱼ | εⱼγⱼ |
|---|---|---|---|
| 1 | +1 | +1 | +1 |
| 2 | −1 | −1 | +1 |
| 3 | −1 | +1 | −1 |
| 4 | +1 | −1 | −1 |

TABLE 5
Bi-Homodyne Detection Method: Schedule 4
q ≦ 10

| j | εⱼ | γⱼ | εⱼγⱼ |
|---|---|---|---|
| 1 | +1 | +1 | +1 |
| 2 | +1 | −1 | −1 |
| 3 | −1 | +1 | −1 |
| 4 | −1 | −1 | +1 |
| 5 | +1 | +1 | +1 |
| 6 | +1 | −1 | −1 |
| 7 | −1 | +1 | −1 |
| 8 | −1 | −1 | +1 |

and environmental changes with a peak in sensitivity at a non-zero frequency value for components of the Fourier spectrum of effects of vibrations and environmental changes. The properties of the bi-homodyne detection methods with respect to whether there is a second order sensitivity to effects of vibrations and environmental changes is determined by the symmetry properties of εⱼγⱼ about the value of j, i.e., j=(q+1)/2. The second order sensitivity to effects of vibration and environmental changes is further described in the description of the first embodiment of the present invention.

In summary, the single homodyne set of εⱼ and γⱼ given in Table 2 and the bi-homodyne set of εⱼ and γⱼ given in Table 4 lead to first order sensitivities of respective measured conjugated quadratures to vibrations and environmental changes with a peak in sensitivity at a zero frequency value for components of the Fourier spectrum of effects of vibrations and environmental changes and the single homodyne set of εⱼ and γⱼ given in Table 3 and the bi-homodyne set of εⱼ and γⱼ given in Table 5 lead for values of q=4 and 8 to second order sensitivities of respective measured conjugated quadratures to vibrations and environmental changes with a peak in sensitivity at a non-zero frequency value for components of the Fourier spectrum of effects of vibrations and environmental changes approximately zero frequencies. These properties with respect to Tables 2, 3, 4, and 5 are developed in the subsequent description of the first embodiment of the present invention as well the properties with respect to representation or appearance of the effects of vibrations and environmental changes as cyclic errors.

Note that first four rows of Table 5 are obtained from Table 4 by the simple permutation of row 2 and row 4.

It is assumed in Eq. (43) that the ratio of |A₂|/|A₁| is not dependent on j or on the value of Pⱼ. In order to simplify the representation of Sⱼ so as to project the important features, it is also assumed in Eq. (43) that the ratio of the amplitudes of the return measurement beams corresponding to A₂ and A₁ is dependent on j or on the value of Pⱼ although this can be accommodated in the first embodiment by replacing Pⱼ with P_{j,m} for amplitude Aₘ. However, the ratio |C₂|/|C₁| will be different from the ratio |A₂|/|A₁| when the ratio of the amplitudes of the measurement beam components corresponding to A₂ and A₁ are different from the ratio |A₂|/|A₁|.

Noting that cos φ_{A}_{₂}_{C}_{₂}_{,j}=±sin φ_{A}_{₁}_{C}_{₁}_{,j} by the control of the relative phase shifts between corresponding reference and return measurement beam components in beam 34, Eq. (43) may be rewritten as

$${S}_{j} = {P}_{j} \{ \begin{matrix}{ξ}_{j}^{2} ( {\vert {A}_{1} \vert}^{2} + {\vert {A}_{2} \vert}^{2} ) + {ζ}_{j}^{2} ( {\vert {B}_{1} \vert}^{2} + {\vert {B}_{2} \vert}^{2} ) + {η}_{j}^{2} ( {\vert {C}_{1} \vert}^{2} + {\vert {C}_{2} \vert}^{2} ) + \\ 2 {ξ}_{j} {ζ}_{j} ( \vert {A}_{1} \vert \vert {B}_{1} \vert cos {φ}_{{A}_{1} {B}_{1} {ɛ}_{j}} + \vert {A}_{2} \vert \vert {B}_{2} \vert cos {φ}_{{A}_{2} {B}_{2} {γ}_{j}} ) + \\ 2 {ξ}_{j} {η}_{j} [ {ɛ}_{j} \vert {A}_{1} \vert \vert {C}_{1} \vert cos {φ}_{{A}_{1} {C}_{1} , j} + {γ}_{j} ( \frac{\vert {A}_{2} \vert}{\vert {A}_{1} \vert} ) ( \frac{\vert {C}_{2} \vert}{\vert {C}_{1} \vert} ) \vert {A}_{1} \vert \vert {C}_{1} \vert sin {φ}_{{A}_{1} {C}_{1} , j} ] + \\ 2 {ζ}_{j} {η}_{j} ( {ɛ}_{j} \vert {B}_{1} \vert \vert {C}_{1} \vert cos {φ}_{{B}_{1} {C}_{1} {ɛ}_{j}} + {γ}_{j} \vert {B}_{2} \vert \vert {C}_{2} \vert cos {φ}_{{B}_{2} {C}_{2} {γ}_{j}} )\end{matrix} \} \qquad ( 44 )$$

where the relationship φ_{A}_{₂}_{C}_{₂}_{,j}=sin φ_{A}_{₁}_{C}_{₁}_{,j} has been used.

The change in phase φ_{A}_{₁}_{B}_{₁}_{ε}_{ⱼ} for a change in εⱼ and the change in phase φ_{A}_{₁}_{B}_{₁}_{ε}_{ⱼ} for a change in γⱼ may be different from π in embodiments depending on where and how the background beam is generated. It may be of value in evaluating the effects of the background beams to note that the factor cos φ_{B}_{₁}_{C}_{₁}_{ε}_{ⱼ} may be written as cos[φ_{A}_{₁}_{C}_{₁}_{,j}+(φ_{B}_{₁}_{C}_{₁}_{ε}_{ⱼ}−φ_{A}_{₁}_{C}_{₁}_{,j})] where the phase difference (φ_{B}_{₁}_{C}_{₁}_{ε}_{ⱼ}−φ_{A}_{₁}_{C}_{₁}_{,j}) is the same as the phase φ_{A}_{₁}_{B}_{₁}_{ε}_{ⱼ}, i.e., cos φ_{B}_{₁}_{C}_{₁}_{ε}_{ⱼ}=cos(φ_{A}_{₁}_{C}_{₁}_{,j}+φ_{A}_{₁}_{B}_{₁}_{ε}_{ⱼ}).

It is evident from inspection of Eq. (44) that the term in Eq. (44) corresponding to the component of conjugated quadratures |C₁|cos φ_{A}_{₁}_{C}_{₁}_{,j} is a rectangular function that has a mean value of zero and is antisymmetric about j=2.5 since εⱼ is antisymmetric about j=2.5 with respect to the values of εⱼ in Table 4 and has a mean value of zero and is antisymmetric about j=(q+1)/2 for q=4,8, . . . since εⱼ is antisymmetric about j=(q+1)/2 with respect to the values of εⱼ in Table 5. In addition the term in Eq. (44) corresponding to the component of conjugated quadratures |C₁|sin φ_{A}_{₁}_{C}_{₁}_{,j} in Eq. (44) is a rectangular function that has a mean value of zero and is antisymmetric about j=(q+1)/2 for q=4,8, . . . since γⱼ is a antisymmetric function about j=(q+1)/2 with respect to the respective values of γⱼ in both Tables 4 and 5. Another important property by the design of the bi-homodyne detection method for values of q=4 and 8 is that the conjugated quadratures |C₁|cos φ_{A}_{di 1}_{C}_{₁}_{,j} and |C₁|sin φ_{A}_{₁}_{C}_{₁}_{,j} terms are orthogonal over the range of j=1,2, . . . ,q since εⱼ and γⱼ are orthogonal over the range of j=1,2, . . . ,q i.e., Σⱼ₌₁^{q}εⱼγⱼ=0 with respect to the values of corresponding εⱼ and γⱼ in both Tables 4 and 5.

Information about conjugated quadratures |C₁|cos φ_{A}_{₁}_{C}_{₁}_{,j} and |C₁|sin φ_{A}_{di 1}_{C}_{₁}_{,j} are obtained using the symmetric and antisymmetric properties and orthogonality property of the conjugated quadratures terms in Eq. (44) as represented by the following digital filters applied to the signal values Sⱼ for the cases of q=4,8, . . . :

$$\begin{matrix}{F}_{1} ( S ) = {\sum }_{j = 1}^{q} {ɛ}_{j} \frac{{S}_{j}}{{P}_{j}^{′} {ξ}_{j}^{′2}} = ( {\vert {A}_{1} \vert}^{2} + {\vert {A}_{2} \vert}^{2} ) {\sum }_{j = 1}^{m} {ɛ}_{j} ( \frac{{P}_{j}}{{P}_{j}^{′}} ) ( \frac{{ξ}_{j}^{2}}{{ξ}_{j}^{′2}} ) + ( {\vert {B}_{1} \vert}^{2} + {\vert {B}_{2} \vert}^{2} ) {\sum }_{j = 1}^{q} {ɛ}_{j} ( \frac{{P}_{j}}{{P}_{j}^{′}} ) ( \frac{{ξ}_{j}^{2}}{{ξ}_{j}^{′2}} ) + ( {\vert {C}_{1} \vert}^{2} + {\vert {C}_{2} \vert}^{2} ) {\sum }_{j = 1}^{m} {ɛ}_{j} ( \frac{{P}_{j}}{{P}_{j}^{′}} ) ( \frac{{η}_{j}^{2}}{{ξ}_{j}^{′2}} ) + 2 \vert {A}_{1} \vert \vert {C}_{1} \vert {\sum }_{j = 1}^{q} {ɛ}_{j}^{2} ( \frac{{P}_{j}}{{P}_{j}^{′}} ) ( \frac{{ξ}_{j} {η}_{j}^{2}}{{ξ}_{j}^{′2}} ) cos {φ}_{{A}_{1} {C}_{1} , j} + 2 ( \frac{\vert {A}_{2} \vert}{\vert {A}_{1} \vert} ) ( \frac{\vert {C}_{2} \vert}{\vert {C}_{1} \vert} ) \vert {A}_{1} \vert \vert {C}_{1} \vert {\sum }_{j = 1}^{q} {ɛ}_{j} {γ}_{j} ( \frac{{P}_{j}}{{P}_{j}^{′}} ) ( \frac{{ξ}_{j} {η}_{j}}{{ξ}_{j}^{′2}} ) sin {φ}_{{A}_{1} {C}_{1} , j} + 2 \vert {A}_{1} \vert \vert {B}_{1} \vert {\sum }_{j = 1}^{q} {ɛ}_{j} ( \frac{{P}_{j}}{{P}_{j}^{′}} ) ( \frac{{ξ}_{j} {ζ}_{j}}{{ξ}_{j}^{′2}} ) cos {φ}_{{A}_{1} {B}_{1} {ɛ}_{j}} + 2 \vert {A}_{2} \vert \vert {B}_{2} \vert {\sum }_{j = 1}^{q} {ɛ}_{j} ( \frac{{P}_{j}}{{P}_{j}^{′}} ) ( \frac{{ξ}_{j} {ζ}_{j}}{{ξ}_{j}^{′2}} ) cos {φ}_{{A}_{2} {B}_{2} {γ}_{j}} + 2 \vert {B}_{1} \vert \vert {C}_{1} \vert {\sum }_{j = 1}^{q} {ɛ}_{j} ( \frac{{P}_{j}}{{P}_{j}^{′}} ) ( \frac{{ξ}_{j} {η}_{j}}{{ξ}_{j}^{′2}} ) cos {φ}_{{B}_{1} {C}_{1} {ɛ}_{j}} + 2 \vert {B}_{2} \vert \vert {C}_{2} \vert {\sum }_{j = 1}^{q} {ɛ}_{j} {γ}_{j} ( \frac{{P}_{j}}{{P}_{j}^{′}} ) ( \frac{{ξ}_{j} {η}_{j}}{{ξ}_{j}^{′2}} ) cos {φ}_{{B}_{2} {C}_{2} {γ}_{j}} , & ( 45 ) \\ {F}_{2} ( S ) = {\sum }_{j = 1}^{q} {γ}_{j} \frac{{S}_{j}}{{P}_{j}^{′} {ξ}_{j}^{′2}} = ( {\vert {A}_{1} \vert}^{2} + {\vert {A}_{2} \vert}^{2} ) {\sum }_{j = 1}^{m} {γ}_{j} ( \frac{{P}_{j}}{{P}_{j}^{′}} ) ( \frac{{ξ}_{j}^{2}}{{ξ}_{j}^{′2}} ) + ( {\vert {B}_{1} \vert}^{2} + {\vert {B}_{2} \vert}^{2} ) {\sum }_{j = 1}^{q} {γ}_{j} ( \frac{{P}_{j}}{{P}_{j}^{′}} ) ( \frac{{ξ}_{j}^{2}}{{ξ}_{j}^{′2}} ) + ( {\vert {C}_{1} \vert}^{2} + {\vert {C}_{2} \vert}^{2} ) {\sum }_{j = 1}^{m} {γ}_{j} ( \frac{{P}_{j}}{{P}_{j}^{′}} ) ( \frac{{η}_{j}^{2}}{{ξ}_{j}^{′2}} ) + 2 \vert {A}_{1} \vert \vert {C}_{1} \vert {\sum }_{j = 1}^{q} {ɛ}_{j} {γ}_{j} ( \frac{{P}_{j}}{{P}_{j}^{′}} ) ( \frac{{ξ}_{j} {η}_{j}}{{ξ}_{j}^{′2}} ) cos {φ}_{{A}_{1} {C}_{1} , j} + 2 ( \frac{\vert {A}_{2} \vert}{\vert {A}_{1} \vert} ) ( \frac{\vert {C}_{2} \vert}{\vert {C}_{1} \vert} ) \vert {A}_{1} \vert \vert {C}_{1} \vert {\sum }_{j = 1}^{q} {γ}_{γ}^{2} ( \frac{{P}_{j}}{{P}_{j}^{′}} ) ( \frac{{ξ}_{j} {η}_{j}}{{ξ}_{j}^{′2}} ) sin {φ}_{{A}_{1} {C}_{1} , j} + 2 \vert {A}_{1} \vert \vert {B}_{1} \vert {\sum }_{j = 1}^{q} {γ}_{j} ( \frac{{P}_{j}}{{P}_{j}^{′}} ) ( \frac{{ξ}_{j} {ζ}_{j}}{{ξ}_{j}^{′2}} ) cos {φ}_{{A}_{1} {B}_{1} {ɛ}_{j}} + 2 \vert {A}_{2} \vert \vert {B}_{2} \vert {\sum }_{j = 1}^{q} {γ}_{j} ( \frac{{P}_{j}}{{P}_{j}^{′}} ) ( \frac{{ξ}_{j} {ζ}_{j}}{{ξ}_{j}^{′2}} ) cos {φ}_{{A}_{2} {B}_{2} {γ}_{j}} + 2 \vert {B}_{1} \vert \vert {C}_{1} \vert {\sum }_{j = 1}^{q} {ɛ}_{j} {γ}_{j} ( \frac{{P}_{j}}{{P}_{j}^{′}} ) ( \frac{{ξ}_{j} {η}_{j}}{{ξ}_{j}^{′2}} ) cos {φ}_{{B}_{1} {C}_{1} {ɛ}_{j}} + 2 \vert {B}_{2} \vert \vert {C}_{2} \vert {\sum }_{j = 1}^{q} ( \frac{{P}_{j}}{{P}_{j}^{′}} ) ( \frac{{ξ}_{j} {η}_{j}}{{ξ}_{j}^{′2}} ) cos {φ}_{{B}_{2} {C}_{2} {γ}_{j}} & ( 46 )\end{matrix}$$

where ξ′ⱼ and P′ⱼ are values used in the digital filters to represent ξⱼ and Pⱼ.

The parameter
[(|A₂|/|A₁|)(|C₂|/|C₁|)] (47)
in Eqs. (45) and (46) needs to be determined in order complete the determination of a conjugated quadratures. The parameter given in Eq. (47) can be measured for example by introducing π/2 phase shifts into the relative phase of the reference beam and the measurement beam and repeating the measurement for the conjugated quadratures. The ratio of the amplitudes of the conjugated quadratures corresponding to (sin φ_{A}_{₁}_{C}_{₁}/cos φ_{A}_{₁}_{C}_{₁}) from the first measurement divided by the ratio of the amplitudes of the conjugated quadratures corresponding to (sin φ_{A}_{₁}_{C}_{₁}/cos φ_{A}_{₁}_{C}_{₁}) from the second measurement is equal to
[(|A₂|/|A₁|)(|C₂|/|C₁|)]². (48)

Note that certain of the factors in Eqs. (45) and (46) have nominal values of q within scale factors, e.g.,

$${\sum }_{j = 1}^{q} ( \frac{{P}_{j}}{{P}_{j}^{′}} ) ( \frac{{ξ}_{j} {η}_{j}}{{ξ}_{j}^{′2}} ) ≃ q , {\sum }_{j = 1}^{q} ( \frac{{P}_{j}}{{P}_{j}^{′}} ) ( \frac{{ξ}_{j} {η}_{j}}{{ξ}_{j}^{′2}} ) ≃ q . \qquad ( 49 )$$

The scale factors correspond to the average values for the ratios of ξ′ⱼ/ηⱼ and ξ′ⱼ/ζⱼ, respectively, assuming that the average value of Pⱼ/P′ⱼ≅1. Certain other of the factors in Eqs. (45) and (46) have nominal values of zero for values of q=4,8, . . . , e.g.,

$${\sum }_{j = 1}^{q} {ɛ}_{j} ( \frac{{P}_{j}}{{P}_{j}^{′}} ) ( \frac{{ξ}_{j}^{2}}{{ξ}_{j}^{′2}} ) ≃ 0 , {\sum }_{j = 1}^{q} {ɛ}_{j} ( \frac{{P}_{j}}{{P}_{j}^{′}} ) ( \frac{{ζ}_{j}^{2}}{{ξ}_{j}^{′2}} ) ≃ 0 , \\ {\sum }_{j = 1}^{q} {ɛ}_{j} ( \frac{{P}_{j}}{{P}_{j}^{′}} ) ( \frac{{η}_{j}^{2}}{{ξ}_{j}^{′2}} ) ≃ 0 , \\ {\sum }_{j = 1}^{q} {γ}_{j} ( \frac{{P}_{j}}{{P}_{j}^{′}} ) ( \frac{{ξ}_{j}^{2}}{{ξ}_{j}^{′2}} ) ≃ 0 , {\sum }_{j = 1}^{q} {γ}_{j} ( \frac{{P}_{j}}{{P}_{j}^{′}} ) ( \frac{{ξ}_{j}^{2}}{{ξ}_{j}^{′2}} ) ≃ 0 , \\ {\sum }_{j = 1}^{q} {ɛ}_{j} ( \frac{{P}_{j}}{{P}_{j}^{′}} ) ( \frac{{η}_{j}^{2}}{{ξ}_{j}^{′2}} ) ≃ 0 , \\ {\sum }_{j = 1}^{q} {ɛ}_{j} {γ}_{j} ( \frac{{P}_{j}}{{P}_{j}^{′}} ) ( \frac{{ξ}_{j} {η}_{j}}{{ξ}_{j}^{′2}} ) ≃ 0.$$

The remaining factors,

$${\sum }_{j = 1}^{q} {ɛ}_{j} ( \frac{{P}_{j}}{{P}_{j}^{′}} ) ( \frac{{ξ}_{j} {ζ}_{j}}{{ξ}_{j}^{′2}} ) cos {φ}_{{A}_{1} {B}_{1} {ɛ}_{j}} , {\sum }_{j = 1}^{q} {ɛ}_{j} ( \frac{{P}_{j}}{{P}_{j}^{′}} ) ( \frac{{ξ}_{j} {ζ}_{j}}{{ξ}_{j}^{′2}} ) cos {φ}_{{A}_{2} {B}_{2} {γ}_{j}} , \\ {\sum }_{j = 1}^{q} ( \frac{{P}_{j}}{{P}_{j}^{′}} ) ( \frac{{ξ}_{j} {η}_{j}}{{ξ}_{j}^{′2}} ) cos {φ}_{{B}_{1} {C}_{1} {ɛ}_{j}} , {\sum }_{j = 1}^{q} {ɛ}_{j} {γ}_{j} ( \frac{{P}_{j}}{{P}_{j}^{′}} ) ( \frac{{ξ}_{j} {η}_{j}}{{ξ}_{j}^{′2}} ) cos {φ}_{{B}_{2} {C}_{2} {γ}_{j}} , \\ {\sum }_{j = 1}^{q} {γ}_{j} ( \frac{{P}_{j}}{{P}_{j}^{′}} ) ( \frac{{ξ}_{j} {ζ}_{j}}{{ξ}_{j}^{′2}} ) cos {φ}_{{A}_{1} {B}_{1} {ɛ}_{j}} , {\sum }_{j = 1}^{q} {γ}_{j} ( \frac{{P}_{j}}{{P}_{j}^{′}} ) ( \frac{{ξ}_{j} {ζ}_{j}}{{ξ}_{j}^{′2}} ) cos {φ}_{{A}_{2} {B}_{2} {γ}_{j}} , \\ {\sum }_{j = 1}^{q} {ɛ}_{j} {γ}_{j} ( \frac{{P}_{j}}{{P}_{j}^{′}} ) ( \frac{{ζ}_{j} {η}_{j}}{{ξ}_{j}^{′2}} ) cos {φ}_{{B}_{1} {C}_{1} {ɛ}_{j}} , {\sum }_{j = 1}^{q} {ɛ}_{j} {γ}_{j} ( \frac{{P}_{j}}{{P}_{j}^{′}} ) ( \frac{{ζ}_{j} {η}_{j}}{{ξ}_{j}^{′2}} ) cos {φ}_{{B}_{2} {C}_{2} {γ}_{j}} , \qquad ( 51 )$$

will have for values of q=4,8, . . . nominal magnitudes rangining from approximately zero to approximately q times a cosine factor and either the average value of factor (Pⱼ/P′ⱼ)(ξⱼζⱼ/ξ′ⱼ²) or (Pⱼ/P′ⱼ)(ζⱼηⱼ/ξ′ⱼ²) depending on the properties respective phases. For the portion of the background with phases that do not track to a first approximation the phases of the respective measurement beams, the magnitudes of all of the terms listed in the Eq. (51) will be approximately zero. For the portion of the background with phases that do track to a first approximation the phases of the respective measurement beams, the magnitudes of the terms listed in Eq. (51) will be approximately q times a cosine factor and either the average value of factor (Pⱼ/P′ⱼ)(ξⱼζⱼ/ξ′ⱼ²) and or factor (Pⱼ/P′ⱼ)(ζⱼηⱼ/ξ′ⱼ²).

The two largest terms in Eqs. (45) and (46) are generally the terms that have the factors (|A₁|²+|A₂|²) and (|B₁|²+|B₂|²). However, the corresponding terms are substantially eliminated by selection of ξ′ⱼ values for the terms that have (|A₁|²+|A₂|²) as a factor and by the design of ζⱼ values for the terms that have (|B₁|²+|B₂|²) as a factor as shown in Eqs. (45) and (46).

The largest contribution from effects of background is represented by the contribution to the interference term between the reference beam and the portion of the background beam generated by the measurement beam 30A. This portion of the effect of the background can be measured by measuring the corresponding conjugated quadratures of the portion of the background with the return measurement beam component of beam 34 set equal to zero, i.e., measuring the respective electrical interference signals Sⱼ with substrate 60 removed and with either |A₂|=0 or |A₁|=0 and visa versa. The measured conjugated quadratures of the portion of the effect of the background can than used to compensate for the respective background effects beneficially in an end use application if required.

Information about the largest contribution from effects of background amplitude 2ξⱼζⱼ|A₁||B₁| and phase φ_{A}_{₁}_{B}_{₁}_{ε}_{ⱼ}, i.e., the interference term between the reference beam and the portion of background beam generated by the measurement beam 30A, may be obtained by measuring Sⱼ for j=1,2, . . . ,q as a function of relative phase shift between reference beam and the measurement beam 30A with substrate 60 removed and either |A₂|=0 or |A₁|=0 and visa versa and Fourier analyzing the measured values of Sⱼ. Such information can be used to help identify the origin of the respective background.

Other techniques may be incorporated to reduce and/or compensate for the effects of background beams such as described in commonly owned U.S. Pat. No. 5,760,901 entitled “Method And Apparatus For Confocal Interference Microscopy With Background Amplitude Reduction and Compensation,” U.S. Pat. No. 5,915,048 entitled “Method and Apparatus for Discrimination In-Focus Images from Out-of-Focus Light Signals from Background and Foreground Light Sources,” and U.S. Pat. No. 6,480,285 B1 wherein each of the three patents are by Henry A. Hill. The contents of each of the three patents are herein incorporated in their entirety by reference.

The selection of values for ξ′ⱼ is based on information about coefficients ξⱼ for j=1,2, . . . ,q that may be obtained by measuring the Sⱼ for j=1,2, . . . ,q with only the reference beam present in the interferometer system. In certain embodiments of the present invention, this may correspond simply blocking the measurement beam components of input beam 24 and in certain other embodiments, this may correspond to simply measuring the Sⱼ for j=1,2, . . . ,q with substrate 60 removed.

A test of the correctness of a set of values for ξ′ⱼ is the degree to which the (|A₁|²+|A₂|²) terms in Eqs. (45) and (46) are zero for even values of q=4,8, . . . (see subsequent description of the section entitled herein as “Interpretation of Effects of Vibrations and Environmental Changes as Cyclic Errors”).

Information about coefficients ξⱼηⱼ for j=1,2, . . . ,q may be obtained by scanning an artifact past the spots corresponding to the respective q conjugate detector pixels with either |A₂|=0 or |A₁|=0 and measuring the conjugated quadratures component 2|A₁||C₁|cos φ_{A}_{₁}_{C}_{₁} or 2|A₁||C₁|sin φ_{A}_{₁}_{C}_{₁}, respectively. A change in the amplitude of the 2|A₁||C₁|cos φ_{A}_{₁}_{C}_{₁} or 2|A₁||C₁|sin φ_{A}_{₁}_{C}_{₁} term corresponds to a variation in ξⱼηⱼ as a function of j. Information about the coefficients ξⱼηⱼ for j=1,2, . . . ,q may be used for example to monitor the stability of one or more elements of interferometer system 10.

Detector 70 may comprise a CCD configured with an architecture that pairs each photosensitive pixel with a blanked-off storage pixel to which the integrated charge is shifted at the moment of an interline transfer. The interline transfer occurs in <1 μs and separates the odd and even fields of one image frame. If used with shutter 68 operated as synchronized shutter, adjacent integrations for corresponding electrical interference signal values, e.g., Sⱼ and Sⱼ₊₁, of a millisecond or less can be recorded on either side of the moment of the line transfer. The interlaced electrical interference signal values may than be read-out at the frame rate of the respective CCD. With a readout system of this CCD configuration, the time to complete the acquisition of a sequence of the electrical signal values with q=4 is equal to the inverse of the frame read-out rate.

It is important that the advantage of using the CCD configured with the interline transfer architecture is enabled by the use of source 18 based on the ECDL described in referenced U.S. Provisional Patent Applications No. 60/699,951 (Z1-72) and No. 60/805,104 (Z1-78) and U.S. patent application Ser. No. 11/457,025 (Z1-72) wherein the frequency of beam 24 can be switched at high rates, e.g., a MHz.

The bi-homodyne detection method is a robust technique for the determination of conjugated quadratures of fields. First, the conjugated quadratures |C₁|cos φ_{A}_{₁}_{C}_{₁} and |C₁|sin φ_{A}_{₁}_{C}_{₁} are the primary terms in the digitally filtered values F₁(S) and F₂(S), respectively, as expressed by Eqs. (45) and (46), respectively, since as noted in the discussion with respect to Eqs (45) and (46), the terms with the factors (|A₁|²+|A₂|²) and (|B₁|²+|B₂|²) are substantially zero for even values of q.

Secondly, the coefficients of factors |C₁|cos φ_{A}_{₁}_{C}_{₁} and |C₂|sin φ_{A}_{₁}_{C}_{₁} in Eqs. (45) and (46) are identical. Thus highly accurate measurements of the interference terms between the return measurement beam and the reference beam with respect to amplitudes and phases, i.e., highly accurate measurements of conjugated quadratures of fields can be measured wherein first order variations in ξⱼ and first order errors in normalizations such as (Pⱼ/P′ⱼ) and (ξⱼ²/ξ′ⱼ²) enter in only second or higher order. This property translates in a significant advantage. Also, the contributions to each component of the conjugated quadratures |C₁|cos φ_{A}_{₁}_{C}_{₁} and |C₂|sin φ_{A}_{₁}_{C}_{₁} from a respective set of q electrical interference signal values have the same window function and thus are obtained as jointly determined values.

Other distinguishing features of the bi-homodyne technique are evident in Eqs. (45) and (46): the coefficients of the conjugated quadratures |C₁|cos φ_{A}_{₁}_{C}_{₁} and |C₁|sin φ_{A}_{₁}_{C}_{₁} in Eqs. (45) and (46), respectively, corresponding to the first equation of Eqs. (49) are identical independent of errors in assumed values for ξⱼ′ coefficients of the conjugated quadratures |C₁|sin φ_{A}_{₁}_{C}_{₁} and |C₁|cos φ_{A}_{₁}_{C}_{₁} in Eqs. (45) and (46), respectively, corresponding to the last equation of Eqs. (50) are indentical independent of errors in assumed values for ξⱼ′. Thus highly accurate values of the phases corresponding to conjugated quadratures can be measured with first order variations in ξⱼ and first order errors in normalizations such as (Pⱼ/P′ⱼ) and (ξⱼ²/ξ′ⱼ²) enter in only through some high order effect.

It is also evident that since the conjugated quadratures of fields are obtained jointly when using the bi-homodyne detection method, there is a signficant reduction in the potential for an error in tracking phase as a result of a phase redundancy unlike the situation possible in single-homodyne detection of conjugated quadratures of fields.

The appearance of effects of vibrations and environmental changes is determined by expressing φ_{A}_{₁}_{C}_{₁}_{,j}=φ_{A}_{₁}_{C}_{₁}+Δφⱼ in Eqs. (45) and (46) where Δφ comprises the effects of vibration, environmental changes, and tilts between reference object 62 and measurement object 60. Eqs. (45) and (46) are rewritten accordingly as

$$\begin{matrix}{F}_{1} ( S ) = {\sum }_{j = 1}^{q} {ɛ}_{j} \frac{{S}_{j}}{{P}_{j}^{′} {ξ}_{j}^{′2}} = ( {\vert {A}_{1} \vert}^{2} + {\vert {A}_{2} \vert}^{2} ) {\sum }_{j = 1}^{q} {ɛ}_{j} ( \frac{{P}_{j}}{{P}_{j}^{′}} ) ( \frac{{ξ}_{j}^{2}}{{ξ}_{j}^{′2}} ) + ( {\vert {B}_{1} \vert}^{2} + {\vert {B}_{2} \vert}^{2} ) {\sum }_{j = 1}^{q} {ɛ}_{j} ( \frac{{P}_{j}}{{P}_{j}^{′}} ) ( \frac{{ζ}_{j}^{2}}{{ξ}_{j}^{′2}} ) + ( {\vert {C}_{1} \vert}^{2} + {\vert {C}_{2} \vert}^{2} ) {\sum }_{j = 1}^{q} {ɛ}_{j} ( \frac{{P}_{j}}{{P}_{j}^{′}} ) ( \frac{{η}_{j}^{2}}{{ξ}_{j}^{′2}} ) + 2 \vert {A}_{1} \vert \vert {C}_{1} \vert {\sum }_{j = 1}^{q} {ɛ}_{j}^{2} ( \frac{{P}_{j}}{{P}_{j}^{′}} ) ( \frac{{ξ}_{j} {η}_{j}}{{ξ}_{j}^{′2}} ) ( \begin{matrix}cos {φ}_{{A}_{1} {C}_{1}} cos {Δφ}_{j} - \\ sin {φ}_{{A}_{1} {C}_{1}} sin {Δφ}_{j}\end{matrix} ) + 2 ( \frac{\vert {A}_{2} \vert}{\vert {A}_{1} \vert} ) ( \frac{\vert {C}_{2} \vert}{\vert {C}_{1} \vert} ) \vert {A}_{1} \vert \vert {C}_{1} \vert {\sum }_{j = 1}^{q} {ɛ}_{j} {γ}_{j} ( \frac{{P}_{j}}{{P}_{j}^{′}} ) ( \frac{{ξ}_{j} {η}_{j}}{{ξ}_{j}^{′2}} ) ( \begin{matrix}sin {φ}_{{A}_{1} {C}_{1}} cos {Δφ}_{j} + \\ cos {φ}_{{A}_{1} {C}_{1}} sin {Δφ}_{j}\end{matrix} ) + … , & ( 52 ) \\ {F}_{2} ( S ) = {\sum }_{j = 1}^{q} {γ}_{j} \frac{{S}_{j}}{{P}_{j}^{′} {ξ}_{j}^{′2}} = ( {\vert {A}_{1} \vert}^{2} + {\vert {A}_{2} \vert}^{2} ) {\sum }_{j = 1}^{q} {γ}_{j} ( \frac{{P}_{j}}{{P}_{j}^{′}} ) ( \frac{{ξ}_{j}^{2}}{{ξ}_{j}^{′2}} ) + ( {\vert {B}_{1} \vert}^{2} + {\vert {B}_{2} \vert}^{2} ) {\sum }_{j = 1}^{q} {γ}_{j} ( \frac{{P}_{j}}{{P}_{j}^{′}} ) ( \frac{{ζ}_{j}^{2}}{{ξ}_{j}^{′2}} ) + ( {\vert {C}_{1} \vert}^{2} + {\vert {C}_{2} \vert}^{2} ) {\sum }_{j = 1}^{q} {γ}_{j} ( \frac{{P}_{j}}{{P}_{j}^{′}} ) ( \frac{{η}_{j}^{2}}{{ξ}_{j}^{′2}} ) + 2 \vert {A}_{1} \vert \vert {C}_{1} \vert {\sum }_{j = 1}^{q} {ɛ}_{j} {γ}_{j} ( \frac{{P}_{j}}{{P}_{j}^{′}} ) ( \frac{{ξ}_{j} {η}_{j}}{{ξ}_{j}^{′2}} ) ( \begin{matrix}cos {φ}_{{A}_{1} {C}_{1}} cos {Δφ}_{j} - \\ sin {φ}_{{A}_{1} {C}_{1}} sin {Δφ}_{j}\end{matrix} ) + 2 ( \frac{\vert {A}_{2} \vert}{\vert {A}_{1} \vert} ) ( \frac{\vert {C}_{2} \vert}{\vert {C}_{1} \vert} ) \vert {A}_{1} \vert \vert {C}_{1} \vert {\sum }_{j = 1}^{q} {γ}_{j}^{2} ( \frac{{P}_{j}}{{P}_{j}^{′}} ) ( \frac{{ξ}_{j} {η}_{j}}{{ξ}_{j}^{′2}} ) ( \begin{matrix}sin {φ}_{{A}_{1} {C}_{1}} cos {Δφ}_{j} + \\ cos {φ}_{{A}_{1} {C}_{1}} sin {Δφ}_{j}\end{matrix} ) + … , & ( 53 )\end{matrix}$$

respectively.
Esq. (52) and (53) are next written in a contracted form as
F₁(S)=a₁₁ cos φ_{A}_{₁}_{C}_{₁}+a₁₂ sin φ_{A}_{₁}_{C}_{₁}+a₁+ . . . , (54)
F₂(S)=a₂₁ cos φ_{A}_{₁}_{C}_{₁}+a₂₂ sin φ_{A}_{₁}_{C}_{₁}+a₂+ . . . , (55)
where
a₁₁=b₁₁+c₁₁, (56)
a₁₂=b₁₂+c₁₂, (57)
a₂₁=b₂₁+c₂₁, (58)
a₂₂=b₂₂+c₂₂, (59)

$$\begin{matrix}{a}_{1} = ( {\vert {A}_{1} \vert}^{2} + {\vert {A}_{2} \vert}^{2} ) {\sum }_{j = 1}^{q} {ɛ}_{j} ( \frac{{P}_{j}}{{P}_{j}^{′}} ) ( \frac{{ξ}_{j}^{2}}{{ξ}_{j}^{′2}} ) + ( {\vert {B}_{1} \vert}^{2} + {\vert {B}_{2} \vert}^{2} ) {\sum }_{j = 1}^{q} {ɛ}_{j} ( \frac{{P}_{j}}{{P}_{j}^{′}} ) ( \frac{{ζ}_{j}^{2}}{{ξ}_{j}^{′2}} ) + ( {\vert {C}_{1} \vert}^{2} + {\vert {C}_{2} \vert}^{2} ) {\sum }_{j = 1}^{q} {ɛ}_{j} ( \frac{{P}_{j}}{{P}_{j}^{′}} ) ( \frac{{η}_{j}^{2}}{{ξ}_{j}^{′2}} ) , & ( 60 ) \\ {a}_{2} = ( {\vert {A}_{1} \vert}^{2} + {\vert {A}_{2} \vert}^{2} ) {\sum }_{j = 1}^{q} {γ}_{j} ( \frac{{P}_{j}}{{P}_{j}^{′}} ) ( \frac{{ξ}_{j}^{2}}{{ξ}_{j}^{′2}} ) + ( {\vert {B}_{1} \vert}^{2} + {\vert {B}_{2} \vert}^{2} ) {\sum }_{j = 1}^{q} {γ}_{j} ( \frac{{P}_{j}}{{P}_{j}^{′}} ) ( \frac{{ζ}_{j}^{2}}{{ξ}_{j}^{′2}} ) + ( {\vert {C}_{1} \vert}^{2} + {\vert {C}_{2} \vert}^{2} ) {\sum }_{j = 1}^{q} {γ}_{j} ( \frac{{P}_{j}}{{P}_{j}^{′}} ) ( \frac{{η}_{j}^{2}}{{ξ}_{j}^{′2}} ) , & ( 61 ) \\ {b}_{11} = 2 \vert {A}_{1} \vert \vert {C}_{1} \vert {\sum }_{j = 1}^{q} {ɛ}_{j}^{2} ( \frac{{P}_{j}}{{P}_{j}^{′}} ) ( \frac{{ξ}_{j} {η}_{j}}{{ξ}_{j}^{′2}} ) cos {Δφ}_{j} , & ( 62 ) \\ {b}_{12} = - 2 \vert {A}_{1} \vert \vert {C}_{1} \vert {\sum }_{j = 1}^{q} {ɛ}_{j}^{2} ( \frac{{P}_{j}}{{P}_{j}^{′}} ) ( \frac{{ξ}_{j} {η}_{j}}{{ξ}_{j}^{′2}} ) sin {Δφ}_{j} , & ( 63 ) \\ {b}_{21} = 2 ( \frac{\vert {A}_{2} \vert}{\vert {A}_{1} \vert} ) ( \frac{\vert {C}_{2} \vert}{\vert {C}_{1} \vert} ) \vert {A}_{1} \vert \vert {C}_{1} \vert {\sum }_{j = 1}^{q} {γ}_{j}^{2} ( \frac{{P}_{j}}{{P}_{j}^{′}} ) ( \frac{{ξ}_{j} {η}_{j}}{{ξ}_{j}^{′2}} ) sin {Δφ}_{j} , & ( 64 ) \\ {b}_{22} = 2 ( \frac{\vert {A}_{2} \vert}{\vert {A}_{1} \vert} ) ( \frac{\vert {C}_{2} \vert}{\vert {C}_{1} \vert} ) \vert {A}_{1} \vert \vert {C}_{1} \vert {\sum }_{j = 1}^{q} {γ}_{j}^{2} ( \frac{{P}_{j}}{{P}_{j}^{′}} ) ( \frac{{ξ}_{j} {η}_{j}}{{ξ}_{j}^{′2}} ) cos {Δφ}_{j} , & ( 65 ) \\ {c}_{11} = 2 ( \frac{\vert {A}_{2} \vert}{\vert {A}_{1} \vert} ) ( \frac{\vert {C}_{2} \vert}{\vert {C}_{1} \vert} ) \vert {A}_{1} \vert \vert {C}_{1} \vert {\sum }_{j = 1}^{q} {ɛ}_{j} {γ}_{j} ( \frac{{P}_{j}}{{P}_{j}^{′}} ) ( \frac{{ξ}_{j} {η}_{j}}{{ξ}_{j}^{′2}} ) sin {Δφ}_{j} , & ( 66 ) \\ {c}_{12} = 2 ( \frac{\vert {A}_{2} \vert}{\vert {A}_{1} \vert} ) ( \frac{\vert {C}_{2} \vert}{\vert {C}_{1} \vert} ) \vert {A}_{1} \vert \vert {C}_{1} \vert {\sum }_{j = 1}^{q} {ɛ}_{j} {γ}_{j} ( \frac{{P}_{j}}{{P}_{j}^{′}} ) ( \frac{{ξ}_{j} {η}_{j}}{{ξ}_{j}^{′2}} ) cos {Δφ}_{j} , & ( 67 ) \\ {c}_{21} = 2 \vert {A}_{1} \vert \vert {C}_{1} \vert {ɛ}_{j} {γ}_{j} ( \frac{{P}_{j}}{{P}_{j}^{′}} ) ( \frac{{ξ}_{j} {η}_{j}}{{ξ}_{j}^{′2}} ) cos {Δφ}_{j} , & ( 68 ) \\ {c}_{22} = - 2 \vert {A}_{1} \vert \vert {C}_{1} \vert {\sum }_{j = 1}^{q} {ɛ}_{j} {γ}_{j} ( \frac{{P}_{j}}{{P}_{j}^{′}} ) ( \frac{{ξ}_{j} {η}_{j}}{{ξ}_{j}^{′2}} ) sin {Δφ}_{j} . & ( 69 )\end{matrix}$$

The elements c₁₁, c₁₂, c₂₁, and c₂₂ are zero for non-multiple homodyne detection methods and generally non-zero for multiple homodyne detection methods.

The phase φ_{A}_{₁}_{C}_{₁} of a conjugated quadratures is obtained from the sin φ_{A}_{₁}_{C}_{₁} and cos φ_{A}_{₁}_{C}_{₁} solutions of the simultaneous Eqs. (54) and (55) as

$$tan {φ}_{{A}_{1} {C}_{1}} = \frac{{a}_{11} ( {F}_{2} - {a}_{2} ) - {a}_{21} ( {F}_{1} - {a}_{1} )}{{a}_{22} ( {F}_{1} - {a}_{1} ) - {a}_{12} ( {F}_{2} - {a}_{2} )} . \qquad ( 70 )$$

The error δφ_{A}_{₁}_{C}_{₁} in φ_{A}_{₁}_{C}_{₁} due to errors δa₁, δa₂, δa₁₁, δa₁₂, δa₂₁, and δa₂₂ is obtained using the the formula
δφ_{A}_{₁}_{C}_{₁}=−sin φ_{A}_{₁}_{C}_{₁}δ(cos φ_{A}_{₁}_{C}_{₁})+cos φ_{A}_{₁}_{C}_{₁}δ(sin φ_{A}_{₁}_{C}_{₁}) (71)
which voids the handling of singularities. The result is

$${δφ}_{{A}_{1} {C}_{1}} = \frac{1}{( {a}_{11} {a}_{22} - {a}_{12} {a}_{21} )} [ ( {F}_{2} - {a}_{2} ) δ {a}_{1} - ( {F}_{1} - {a}_{1} ) δ {a}_{2} ] + \frac{1}{2 {( {a}_{11} {a}_{22} - {a}_{12} {a}_{21} )}^{2}} \times \{ \begin{matrix}2 ( {F}_{1} - {a}_{1} ) ( {F}_{2} - {a}_{2} ) ( \begin{matrix}{a}_{22} δ {a}_{11} - {a}_{21} δ {a}_{12} + \\ {a}_{12} δ {a}_{21} - {a}_{11} δ {a}_{22}\end{matrix} ) + \\ [ {( {F}_{1} - {a}_{1} )}^{2} + {( {F}_{2} - {a}_{2} )}^{2} ] ( \begin{matrix}- {a}_{12} δ {a}_{11} + {a}_{11} δ {a}_{12} - \\ {a}_{22} δ {a}_{21} + {a}_{21} δ {a}_{22}\end{matrix} ) - \\ [ {( {F}_{1} - {a}_{1} )}^{2} - {( {F}_{2} - {a}_{2} )}^{2} ] ( \begin{matrix}{a}_{12} δ {a}_{11} - {a}_{11} δ {a}_{12} - \\ {a}_{22} δ {a}_{21} + {a}_{21} δ {a}_{22}\end{matrix} )\end{matrix} \} . \qquad ( 72 )$$

The errors δa₁₁, δa₁₂, δa₂₁, and δa₂₂ in Eq. (72) are expressed in more fundamental quantities which are errors δb₁₁, δb₁₂, δb₂₁, δb₂₂, δc₁₁, δc₁₂, δc₂₁, and δc₂ to obtain the formula

$${δφ}_{{A}_{1} {C}_{1}} = \frac{1}{( {a}_{11} {a}_{22} - {a}_{12} {a}_{21} )} [ ( {F}_{2} - {a}_{2} ) δ {a}_{1} - ( {F}_{1} - {a}_{1} ) δ {a}_{2} ] + \frac{1}{{( {a}_{11} {a}_{22} - {a}_{12} {a}_{21} )}^{2}} \times \{ \begin{matrix}- 2 ( {F}_{1} - {a}_{1} ) ( {F}_{2} - {a}_{2} ) [ \begin{matrix}( {\overline{b}}_{11} δ {b}_{22} - {\overline{b}}_{22} δ {b}_{11} ) + \\ ( {\overline{b}}_{11} δ {c}_{22} - {\overline{b}}_{22} δ {c}_{11} )\end{matrix} ] + \\ [ {( {F}_{1} - {a}_{1} )}^{2} + {( {F}_{2} - {a}_{2} )}^{2} ] [ \begin{matrix}( {\overline{b}}_{11} δ {b}_{12} - {\overline{b}}_{22} δ {b}_{21} ) + \\ ( {\overline{b}}_{11} δ {c}_{12} - {\overline{b}}_{22} δ {c}_{21} )\end{matrix} ] + \\ [ {( {F}_{1} - {a}_{1} )}^{2} - {( {F}_{2} - {a}_{2} )}^{2} ] [ \begin{matrix}( {\overline{b}}_{11} δ {b}_{12} + {\overline{b}}_{22} δ {b}_{21} ) + \\ ( {\overline{b}}_{11} δ {c}_{12} + {\overline{b}}_{22} δ {c}_{21} )\end{matrix} ]\end{matrix} \} + … , \qquad ( 73 )$$

where first order terms are shown and

$$\begin{matrix}{\overline{b}}_{11} = 2 \vert {A}_{1} \vert \vert {C}_{1} \vert {\sum }_{j = 1}^{q} {ɛ}_{j}^{2} ( \frac{{P}_{j}}{{P}_{j}^{′}} ) ( \frac{{ξ}_{j} {η}_{j}}{{ξ}_{j}^{′2}} ) , & ( 74 ) \\ {\overline{b}}_{22} = 2 ( \frac{\vert {A}_{2} \vert}{\vert {A}_{1} \vert} ) ( \frac{\vert {C}_{2} \vert}{\vert {C}_{1} \vert} ) \vert {A}_{1} \vert \vert {C}_{1} \vert {\sum }_{j = 1}^{q} {γ}_{j}^{2} ( \frac{{P}_{j}}{{P}_{j}^{′}} ) ( \frac{{ξ}_{j} {η}_{j}}{{ξ}_{j}^{′2}} ) . & ( 75 )\end{matrix}$$

The interpretation of Eq. (73) in terms of cyclic errors is helped with the expression of factors (F₁−a₁)(F₂−a₂), [(F₁−a₁)²+(F₂−a₂)²], and [(F₁−a₁)^{2-(F}₂−a₂)²] in terms of trigonometric functions with arguments proportional to φ_{A}_{₁}_{C}_{₁}:

$$\begin{matrix}2 ( {F}_{1} - {a}_{1} ) ( {F}_{2} - {a}_{2} ) = ( {a}_{11} {a}_{22} + {a}_{12} {a}_{21} ) sin ( 2 {φ}_{{A}_{1} {C}_{1}} ) + 2 {a}_{11} {{a}_{21} ( cos {φ}_{{A}_{1} {C}_{1}} )}^{2} + 2 {a}_{22} {{a}_{12} ( sin {φ}_{{A}_{1} {C}_{1}} )}^{2} + … = {\overline{b}}_{11} {\overline{b}}_{22} sin ( 2 {φ}_{{A}_{1} {C}_{1}} ) + … , & ( 76 ) \\ [ {( {F}_{1} - {a}_{1} )}^{2} + {( {F}_{2} - {a}_{2} )}^{2} ] = ( {a}_{11}^{2} + {a}_{21}^{2} ) {( cos {φ}_{{A}_{1} {C}_{1}} )}^{2} + ( {a}_{22}^{2} + {a}_{12}^{2} ) {( sin {φ}_{{A}_{1} {C}_{1}} )}^{2} + ( {a}_{11} {a}_{12} + {a}_{22} {a}_{21} ) sin 2 {φ}_{{A}_{1} {C}_{1}} + … = {{\overline{b}}_{11}^{2} ( cos {φ}_{{A}_{1} {C}_{1}} )}^{2} + {{\overline{b}}_{22}^{2} ( sin {φ}_{{A}_{1} {C}_{1}} )}^{2} + … , = \frac{1}{2} ( {\overline{b}}_{11}^{2} + {\overline{b}}_{22}^{2} ) + \frac{1}{2} ( {\overline{b}}_{11}^{2} - {\overline{b}}_{22}^{2} ) cos 2 {φ}_{{A}_{1} {C}_{1}} + … , & ( 77 ) \\ [ {( {F}_{1} - {a}_{1} )}^{2} - {( {F}_{2} - {a}_{2} )}^{2} ] = ( {a}_{11}^{2} - {a}_{21}^{2} ) {( cos {φ}_{{A}_{1} {C}_{1}} )}^{2} - ( {a}_{22}^{2} - {a}_{12}^{2} ) {( sin {φ}_{{A}_{1} {C}_{1}} )}^{2} + ( {a}_{11} {a}_{12} - {a}_{22} {a}_{21} ) sin 2 {φ}_{{A}_{1} {C}_{1}} + … = \frac{1}{2} ( {\overline{b}}_{11}^{2} + {\overline{b}}_{22}^{2} ) cos 2 {φ}_{{A}_{1} {C}_{1}} + \frac{1}{2} ( {\overline{b}}_{11}^{2} - {\overline{b}}_{22}^{2} ) + … & ( 78 )\end{matrix}$$

Interpretation of Effects of Vibrations and Environmental Changes as Cyclic Errors

It is evident from Eq. (76) that the leading term with the factor 2(F₁−a₁)(F₂−a₂) is b̅₁₁ b̅₂₂ sin 2φ_{A}_{₁}_{C}_{₁}, from Eq. (77) that the leading term with the factor [(F₁−a₁)²+(F₂−a₂)²] is ( b̅₁₁²+ b̅₂₂²)/2, and from Eq. (78) that the leading term with the factor [(F₁−a₁)²−(F₂−a₂)²] is [( b̅₁₁²+ b̅₂₂²)/2] cos 2φ_{A}_{₁}_{C}_{₁}. Accordingly with reference to Eq. (73), the effects of vibrations and environmental changes are present in the form of cyclic errors at zero spatial frequency and as conjugated quadratures at the second harmonic of phase φ_{A}_{₁}_{C}_{₁}. Note that cyclic errors also appear as conjugated quadratures at the first harmonic of phase φ_{A}_{₁}_{C}_{₁} generated by errors a₁ and a₂ which are determined by errors in the selection of values of ξ′ⱼ and P′ⱼ [see Eqs. (60) and (61)].

The transformation of the effects of vibrations and environmental changes and the effects of errors in the selection of values of ε′ⱼ and P′ⱼ into cyclic errors that are represented as harmonics of phase φ_{A}_{₁}_{C}_{₁} represents a significant advantage of the use of the detection methods of various embodiments of the present invention with respect to understanding, reducing, and compensating the effects of vibrations and environmental changes.

The Cyclic Errors Reduced by Operating in the Reference Frame

The cyclic error that appears as a zeroth harmonic of φ_{A}_{₁}_{C}_{₁} represents a fixed offset in φ_{A}_{₁}_{C}_{₁} and as such does not present a problem in wavefront interferometry. The fixed offset in φ_{A}_{₁}_{C}_{₁} corresponds to a piston type of optical aberration. The amplitudes of the cyclic errors that appear as components of conjugated quadratures at the second harmonic of φ_{A}_{₁}_{C}_{₁} are determined by properties of the vibrations and environmental changes present during the acquisition of the corresponding electrical signal values. These amplitudes of the cyclic errors are reduced in the first embodiment of the present invention by operating in the reference frame where the optical path length of the cavity formed by the reference and measurement objects is maintained at or near a constant value mod 2π through the control of the reference frequency f_{R}.

The electrical interference signal 172 is processed for changes of one of the components of the corresponding conjugated quadratures and the measured changes of one of the components is used by electronic processor and controller 80 as an error signal to control the reference frequency of source 18.

The maintenance of optical path length of the cavity at or near a constant value mod 2π may alternatively be achieved by a combination of controlling with the error signal the reference frequency of source 18 and the relative physical length of the cavity by transducers 150 and 152 (see FIG. 1b). Transducers 150 and 152 which generally have a slower frequency response than that of source 18 may be beneficially used to extend the range over which the reference frequency may be controlled.

The contributions of changes in relative orientation due to vibrations and environmental changes of the reference and measurement objects that are detected by processing electrical interference signal 172 by electronic processor and controller 80 are used by electronic processor and controller 80 to generate corresponding error signals. The corresponding error signals may be used by electronic processor and controller 80 to control the relative orientation of reference and measurement objects 62 and 60 by transducers 150 and 152.

The contributions of changes in relative deformation due to vibrations and environmental changes of the reference and measurement objects that are detected by processing electrical interference signal 172 by electronic processor and controller 80 are used by electronic processor and controller 80 to generate other corresponding error signals. The other corresponding error signals may be used by electronic processor and controller 80 to control the relative deformation of reference and measurement objects 62 and 60 by transducers 150 and 152 augmented to introduce torques to reference object 62. Additional transducers other than augmented transducers 150 and 152 may be used beneficially in end use applications.

A primary advantage of operating in the reference frame is that the linearity and calibration of source 18 and of transducers 150 and 152 is not an issue since the reference frame is maintained by an active servo control system. The linearity and calibration of transducers generally are an issue in prior art wavefront interferometry.

Another advantage is that the error signals that are detected by processing electrical interference signal 172 by electronic processor and controller 80 can be monitored whether or not used as error signals in the control of the properties of the cavity and used to limit the amplitude of cyclic errors. The amplitudes of the cyclic errors are computed on-line as a function of time by electronic processor and controller 80 using Eqs. (62), (63), (64), (65), (66), and (67). When one or more computed amplitudes of cyclic errors reach respective preset values, shutter 168 is closed. Thus the length of the window corresponding the integration period used by detector 70 is controlled by shutter 168 to limit the amplitudes of cyclic errors so as to not exceed the preset values.

Compensation for the Cyclic Errors Based on Measured Changes in Properties of Cavity

The compensation of effects of the cyclic errors generated by effects of vibrations and environmental changes and the effects of errors in the selection of values of ξ′ⱼ may be addressed in several different ways: the effects reduced by operating in the reference frame without any subsequent compensation; the effects reduced by operating in the reference frame and the residual effects of the cyclic errors generated by effects of vibrations and environmental changes, the residual effects of vibrations and environmental changes measured as changes in properties of the cavity, the amplitudes of the corresponding cyclic errors computed from the measured residual effects, and the computed amplitudes of cyclic errors used to compensate for the effects of cyclic errors; and the amplitudes of the cyclic errors due to the effects measured and the measured amplitudes of the cyclic errors used to compensate for the effects of cyclic errors.

The compensation of effects of the cyclic errors generated by effects of vibrations and environmental changes and the effects of errors in the selection of values of ξ′ⱼ may be addressed in several different ways: the effects reduced by operating in the reference frame without any subsequent compensation; the effects reduced by operating in the reference frame and the residual effects of the cyclic errors generated by effects of vibrations and environmental changes, the residual effects of vibrations and environmental changes measured as changes in properties of the cavity, the amplitudes of the corresponding cyclic errors computed from the measured residual effects, and the computed amplitudes of cyclic errors used to compensate for the effects of cyclic errors; and the amplitudes of the cyclic errors due to the effects measured and the measured amplitudes of the cyclic errors used to compensate for the effects of cyclic errors.

The contributions of the residual effects of vibrations and environmental changes that are present when operating in the reference frame are detected and measured by processing electrical interference signal 172 by electronic processor and controller 80. The measured residual effects are used by electronic processor and controller 80 to compute the amplitudes of respective cyclic errors using Eqs. (62), (63), (64), (65), (66), and (67). The computed amplitudes of respective cyclic errors are subsequently used to compensate for the effects of cyclic errors.

Compensation for the Cyclic Errors Based on Measured Amplitudes of Cyclic Errors

The amplitudes of the cyclic errors are measured by the introduction of a tilt in the relative wavefronts of the reference and measurement beams. The cyclic errors are measured as first and second harmonics of the contribution to phase φ_{A}_{₁}_{C}_{₁} by the tilt. The measured amplitudes of the cyclic errors are subsequently used to compensate for the effects of the cyclic errors.

The measurement of the amplitudes of the cyclic errors may be repeated for several different tilts in order to compensate for the effects of a relative periodic surface structure of the reference and measurement objects that accidentally coincided with the spatial frequency introduced by a particular tilt value and orientation.

From Eq. (73), we have for the error in phase the equation

$${δφ}_{{A}_{1} {C}_{1}} = \frac{1}{( {a}_{11} {a}_{22} - {a}_{12} {a}_{21} )} [ {\overline{b}}_{22} δ {a}_{1} sin {φ}_{{A}_{1} {C}_{1}} - {\overline{b}}_{11} δ {a}_{2} cos {φ}_{{A}_{1} {C}_{1}} ] + \frac{1}{4 {( {a}_{11} {a}_{22} - {a}_{12} {a}_{21} )}^{2}} \times \{ \begin{matrix}2 ( {\overline{b}}_{22} δ {b}_{11} - {\overline{b}}_{11} δ {b}_{22} ) {\overline{b}}_{11} {\overline{b}}_{22} sin 2 {φ}_{{A}_{1} {C}_{1}} - \\ ( {\overline{b}}_{22} δ {b}_{21} - {\overline{b}}_{11} δ {b}_{12} ) [ ( {\overline{b}}_{11}^{2} + {\overline{b}}_{22}^{2} ) + ( {\overline{b}}_{11}^{2} - {\overline{b}}_{22}^{2} ) cos 2 {φ}_{{A}_{1} {C}_{1}} ] + \\ ( {\overline{b}}_{22} δ {b}_{21} + {\overline{b}}_{11} δ {b}_{12} ) [ ( {\overline{b}}_{11}^{2} + {\overline{b}}_{22}^{2} ) cos 2 {φ}_{{A}_{1} {C}_{1}} + ( {\overline{b}}_{11}^{2} - {\overline{b}}_{22}^{2} ) ]\end{matrix} \} + \frac{1}{4 {( {a}_{11} {a}_{22} - {a}_{12} {a}_{21} )}^{2}} \times \{ \begin{matrix}2 ( {\overline{b}}_{22} δ {c}_{11} - {\overline{b}}_{11} δ {c}_{22} ) {\overline{b}}_{11} {\overline{b}}_{22} sin 2 {φ}_{{A}_{1} {C}_{1}} - \\ ( {\overline{b}}_{22} δ {c}_{21} - {\overline{b}}_{11} δ {c}_{12} ) [ ( {\overline{b}}_{11}^{2} + {\overline{b}}_{22}^{2} ) + ( {\overline{b}}_{11}^{2} - {\overline{b}}_{22}^{2} ) cos 2 {φ}_{{A}_{1} {C}_{1}} ] + \\ ( {\overline{b}}_{22} δ {c}_{21} + {\overline{b}}_{11} δ {c}_{12} ) [ ( {\overline{b}}_{11}^{2} + {\overline{b}}_{22}^{2} ) cos 2 {φ}_{{A}_{1} {C}_{1}} + ( {\overline{b}}_{11}^{2} - {\overline{b}}_{22}^{2} ) ]\end{matrix} \} + … \qquad ( 79 )$$

Eq. (79) reduces to the following equation where terms representing first order effects are shown:

$${δφ}_{{A}_{1} {C}_{1}} = \frac{1}{{\overline{b}}_{11} {\overline{b}}_{22}} ( {\overline{b}}_{22} δ {a}_{1} sin {φ}_{{A}_{1} {C}_{1}} - {\overline{b}}_{11} δ {a}_{2} cos {φ}_{{A}_{1} {C}_{1}} ) + \frac{1}{4 {( {\overline{b}}_{11} {\overline{b}}_{22} )}^{2}} \times [ \begin{matrix}2 ( {\overline{b}}_{22} δ {b}_{11} - {\overline{b}}_{11} δ {b}_{22} ) {\overline{b}}_{11} {\overline{b}}_{22} sin 2 {φ}_{{A}_{1} {C}_{1}} - \\ ( {\overline{b}}_{22} δ {b}_{21} - {\overline{b}}_{11} δ {b}_{12} ) ( {\overline{b}}_{11}^{2} + {\overline{b}}_{22}^{2} ) + \\ ( {\overline{b}}_{22} δ {b}_{21} + {\overline{b}}_{11} δ {b}_{12} ) ( {\overline{b}}_{11}^{2} + {\overline{b}}_{22}^{2} ) cos 2 {φ}_{{A}_{1} {C}_{1}}\end{matrix} ] + \frac{1}{4 ( {\overline{b}}_{11} {\overline{b}}_{22} )} \times [ \begin{matrix}2 ( {\overline{b}}_{22} δ {c}_{11} - {\overline{b}}_{11} δ {c}_{22} ) {\overline{b}}_{11} {\overline{b}}_{22} sin 2 {φ}_{{A}_{1} {C}_{1}} - \\ ( {\overline{b}}_{22} δ {c}_{21} - {\overline{b}}_{11} δ {c}_{12} ) ( {\overline{b}}_{11}^{2} + {\overline{b}}_{22}^{2} ) + \\ ( {\overline{b}}_{22} δ {c}_{21} + {\overline{b}}_{11} δ {c}_{12} ) ( {\overline{b}}_{11}^{2} + {\overline{b}}_{22}^{2} ) cos 2 {φ}_{{A}_{1} {C}_{1}}\end{matrix} ] + … \qquad ( 80 )$$

Single-Homodyne Detection Methods

For the single-homodyne detection methods where an electrical interference signal value contains information about a single component of a conjugated quadratures, the product εⱼγⱼ=0 (see Tables 2 and 3). As a consequence,
cᵢⱼ=0 (81)
[see Eqs. (66), (67), (68), and (69)] and Eq. (80) reduces to the expression

$${δφ}_{{A}_{1} {C}_{1}} = \frac{1}{{\overline{b}}_{11} {\overline{b}}_{22}} ( {\overline{b}}_{22} δ {a}_{1} sin {φ}_{{A}_{1} {C}_{1}} - {\overline{b}}_{11} δ {a}_{2} cos {φ}_{{A}_{1} {C}_{1}} ) + \frac{1}{4 {( {\overline{b}}_{11} {\overline{b}}_{22} )}^{2}} \times [ \begin{matrix}2 ( {\overline{b}}_{22} δ {b}_{11} - {\overline{b}}_{11} δ {b}_{22} ) {\overline{b}}_{11} {\overline{b}}_{22} sin 2 {φ}_{{A}_{1} {C}_{1}} - \\ ( {\overline{b}}_{22} δ {b}_{21} - {\overline{b}}_{11} δ {b}_{12} ) ( {\overline{b}}_{11}^{2} + {\overline{b}}_{22}^{2} ) + \\ ( {\overline{b}}_{22} δ {b}_{21} + {\overline{b}}_{11} δ {b}_{12} ) ( {\overline{b}}_{11}^{2} + {\overline{b}}_{22}^{2} ) cos 2 {φ}_{{A}_{1} {C}_{1}}\end{matrix} ] + … \qquad ( 82 )$$

Note that the cyclic error at zero spatial frequency corresponds to a constant offset in φ_{A}_{₁}_{C}_{₁} or a piston type of optical aberration that is unimportant in determining properties of the differences in reference and measurement beam wavefronts. However, that offset can be used in certain cases as an error signal for reducing the effects of vibrations and environmental changes as will be described.

The phase shifting algorithm corresponding to εⱼ and γⱼ values listed in Table 2 as a Schedule 1 corresponds to the algorithm based on the standard set of four phase shift values of 0, π/2, π, and 3π/2. The corresponding single-homodyne detection method exhibits according to Eq. (82) a first order sensitivity to effects of vibrations and environmental changes with a peak in sensitivity at a zero frequency value for components of the Fourier spectrum of effects of vibrations and environmental changes. For a constant rate of change of the optical path length, δb₂₁=δb₁₂ and δb_{12 is proportional to the constant rate of change [see Eqs. (}63) and (64)].

A set of values of εⱼ and γⱼ corresponding to a second set of phase shifts 0, π/2, −π/2, and ±π is listed in Table 3 as Schedule 2 for a single-homodyne detection method. The algorithm based on the first set of phase shift values listed in Table 3 exhibits according to Eq. (82) only a second order sensitivity to effects of vibrations and environmental changes with a peak in sensitivity at a non-zero frequency value for components of the Fourier spectrum of effects of vibrations and environmental changes. For a constant rate of change of the optical path length, δb₂₁=δb₁₂=0 [see Eqs. (63) and (64)]. As a consequence, the effects of vibrations and environmental changes contribute to the factor b̅₂₂δb₂₁+ b̅₁₁δb₁₂ in Eq. (82) only through second and higher order effects. Because of the properties of δb₁₁ and δb₂₂ as exhibited in Eqs. (65) and (66), the effects of vibrations and environmental changes contribute to the factor ( b̅₂₂δb₁₁− b̅₁₁δb₂₂) in Eq. (82) through second and higher order effects.

Thus an advantage of the single-homodyne detection method based on the values of εⱼ and γⱼ corresponding to the second set of phase shifts 0, π/2, −π/2, and ±π listed in Table 3 is an intrinsic reduced sensitivity to effects of vibrations and environmental changes.

Bi-Homodyne Detection Methods

Table 4 lists as Schedule 3 a set of values for εⱼ and γⱼ for a bi-homodyne detection method that corresponds to the standard set of phase shifts 0, π/2, π, and 3π/2 which is the same as Table 1 in U.S. Provisional Patent Application No. 60/442,858 (Z1-47) and U.S. patent application Ser. No. 10/765,368 (Z1-47). The bi-homodyne detection method using the set of values of εⱼ and γⱼ listed in Table 4 exhibits according to Eq. (80) a first order sensitivity to effects of vibration and environmental changes with a peak in sensitivity at a zero frequency value for components of the Fourier spectrum of effects of vibrations and environmental changes.

For a constant rate of change of the optical path length, δb₂₁=δb₁₂₌₀ [see Eqs. (63) and (64)]. As a consequence, the effects of vibrations and environmental changes contribute to the factor b̅₂₂δb₂₁+ b̅₁₁δb₁₂ in Eq. (80) only through second and higher order effects. Because of the properties of δb₁₁ and δb₂₂ as exhibited in Eqs. (65) and (66), the effects of vibrations and environmental changes contribute to the factor ( b̅₂₂δb₁₁− b̅₁₁δb₂₂) in Eq. (82) through second and higher order effects.

Also for a constant rate of change of the optical path length, δc₂₁=δc₁₂=0 [sec Eqs. (67) and (68)]. As a consequence, the effects of vibrations and environmental changes contribute to the factor b̅₂₂δc₂₁+ b̅₁₁δc₁₂ in Eq. (80) only through second and higher order effects.

However, δc₂₁=−δc₁₂ and δc₁₂ is proportional the constant rate of change of the optical path length [see Eqs. (66) and (69)]. As a consequence, the factor ( b̅₂₂δ₁₁− b̅₁₁δc₂₂) in Eq. (80) has a first order sensitivity to a constant rate of change of the optical path length.

There are disclosed herein sets of values of εⱼ and γⱼ, an example of which is listed in Table 5 as schedule 4, for a bi-homodyne detection method that exhibits according to Eq. (80) for a sequence of q phase shift values where q=4,8, . . . a second order sensitivity to effects of vibrations and environmental changes with a peak in sensitivity at a non-zero frequency value for components of the Fourier spectrum of effects of vibrations and environmental changes. The properties of the bi-homodyne detection methods with respect to whether there is a second order sensitivity to effects of vibrations and environmental changes is determined by the symmetry properties of εⱼγⱼ about the value of j, i.e., j=(q+1)/2.

For a constant rate of change of the optical path length, δb₂₁=δb₁₂=0 [see Eqs. (63) and (64)]. As a consequence, the effects of vibrations and environmental changes contribute to the factor b̅₂₂δb₂₁+ b̅₁₁δb₁₂ in Eq. (80) only through second and higher order effects. Because of the properties of δb₁₁ and δb₂₂ as exhibited in Eqs. (65) and (66), the effects of vibrations and environmental changes contribute to the factor ( b̅₂₂δb₁₁− b̅₁₁δb₂₂) in Eq. (82) through second and higher order effects.

In addition for a constant rate of change of the optical path length, δc₂₁=δc₁₂=0 [see Eqs. (67) and (68)]. As a consequence, the effects of vibrations and environmental changes contribute to the factor b̅₂₂δc₂₁+ b̅₁₁δc₁₂ in Eq. (80) only through second and higher order effects.

However, δ6c₁₁=δc₂₂=0 for the constant rate of change of the optical path length [see Eqs. (66) and (69)]. As a consequence, the effects of vibrations and environmental changes contribute to the factor ( b̅₂₂δc₁₁− b̅₁₁δc₂₂) in Eq. (80) only through second and higher order effects.

Thus an advantage of the bi-homodyne detection method based on the value of εⱼ and γⱼ listed in Table 5 is an intrinsic reduced sensitivity to effects of vibrations and environmental changes.

In summary, the single homodyne set of εⱼ and γⱼ given in Table 2 and the bi-homodyne set of εⱼ and γⱼ given in Table 4 lead to first order sensitivities of respective measured conjugated quadratures to vibrations and environmental changes with a peak in sensitivity at a zero frequency value for components of the Fourier spectrum of effects of vibrations and environmental changes. In contrast, the single-homodyne set of εⱼ and γⱼ given in Table 3 and the bi-homodyne set of εⱼ and γⱼ given in Table 5 lead for values of q=4 and 8 to second and higher order sensitivities of respective measured conjugated quadratures to effects of vibrations and environmental changes with a peak in sensitivity at a non-zero frequency value for components of the Fourier spectrum of effects of vibrations and environmental changes approximately zero frequencies.

In summary, the single homodyne set of εⱼ and γⱼ given in Table 2 and the bi-homodyne set of εⱼ and γⱼ given in Table 4 lead to first order sensitivities of respective measured conjugated quadratures to vibrations and environmental changes with a peak in sensitivity at a zero frequency value for components of the Fourier spectrum of effects of vibrations and environmental changes. In contrast, the single-homodyne set of εⱼ and γⱼ given in Table 3 and the bi-homodyne set of εⱼ and γⱼ given in Table 5 lead for values of q=4 and 8 to second and higher order sensitivities of respective measured conjugated quadratures to effects of vibrations and environmental changes with a peak in sensitivity at a non-zero frequency value for components of the Fourier spectrum of effects of vibrations and environmental changes approximately zero frequencies.

There are a number of advantages of the bi-homodyne detection method as a consequence of the conjugated quadratures of fields being jointly acquired quantities. One advantage is a reduced sensitivity the effects of an overlay error of a spot in or on the substrate that is being imaged and a conjugate image of conjugate pixel of a multipixel detector during the acquisition of four electrical interference signal values of each spot in and/or on a substrate imaged using interferometric far-field and/or near-field confocal and non-confocal microscopy. Overlay errors are errors in the set of four conjugate images of a respective set of conjugate detector pixels relative to the spot being imaged.

Another advantage is that when operating in the scanning mode there is a reduced sensitivity to effects of pinhole-to-pinhole variations in properties of a conjugate set of pinholes used in a confocal microscopy system that are conjugate to a spot in or on the substrate being imaged at different times during the scan.

Another advantage is that when operating in the scanning mode there is a reduced sensitivity to effects of pixel-to-pixel variation of properties within a set of conjugate pixels that are conjugate to a spot in or on the substrate being imaged at different times during the scan.

Another advantage is that when operating in the scanning mode there is reduced sensitivity to effects of pulse sequence to pulse sequence variations of a respective conjugate set of pulse sequences of the input beam 24 to the interferometer system.

The pinholes and pixels of a multipixel detector of a set of conjugate pinholes and conjugate pixels of a multipixel detector may comprise contiguous pinholes of an array of pinholes and/or contiguous pixels of a multipixel detector or may comprise selected pinholes from an array of pinholes and/or pixels from an array of pixels wherein the separation between the selected pinholes is an integer number of pinhole spacings and the separation between an array of respective pixels corresponds to an integer number of pixel spacings without loss of lateral and/or longitudinal resolution and signal-to-noise ratios. The corresponding scan rate would be equal to the integer times the spacing of spots on the measurement object 60 conjugate to set of conjugate pinholes and/or set of conjugate pixels divided by the read out rate of the multipixel detector. This property permits a significant increase in throughput for an interferometric far-field or near-field confocal or non-confocal microscope with respect to the number of spots in and/or on a substrate imaged per unit time.

Referring to the quad-homodyne detection method, a set of electrical interference signal values are obtained for each spot on and/or in substrate 60 being imaged. The properties of the quad-homodyne detection method with respect to effects of vibration and environmental changes are developed herein for the case of q equal to 4 in order to display the features relating to effects of vibration and environmental changes. The results for q equal to 4 can easily be extended to the cases of q equal to 8, 12, . . . . The corresponding set of electrical interference signal values Sⱼ for q equal to 4 used for obtaining conjugated quadratures of fields for a single a spot on and/or in a substrate being imaged is represented for the quad-homodyne detection within a scale factor by the formulae

$$\begin{matrix}{S}_{1} = {P}_{1} \{ \begin{matrix}\begin{matrix}\begin{matrix}{ξ}_{1}^{2} {\vert {A}_{1} \vert}^{2} + {ζ}_{1}^{2} {\vert {B}_{1} \vert}^{2} + {η}_{1}^{2} {\vert {C}_{1} \vert}^{2} + {ζ}_{1} {η}_{1} 2 \vert {B}_{1} \vert \vert {C}_{1} \vert cos {φ}_{{B}_{1} {C}_{1} {ɛ}_{1}} + \\ {ξ}_{1} {ζ}_{1} 2 \vert {A}_{1} \vert \vert {B}_{1} \vert cos {φ}_{{A}_{1} {B}_{1} {ɛ}_{1}} + {ɛ}_{1} {ξ}_{1} {η}_{1} 2 \vert {A}_{1} \vert \vert {C}_{1} \vert cos {φ}_{{A}_{1} {C}_{1} , 1} +\end{matrix} \\ {ξ}_{1}^{2} {\vert {A}_{2} \vert}^{2} + {ζ}_{1}^{2} {\vert {B}_{2} \vert}^{2} + {η}_{1}^{2} {\vert {C}_{2} \vert}^{2} + {ζ}_{1} {η}_{1} 2 \vert {B}_{2} \vert \vert {C}_{2} \vert cos {φ}_{{B}_{1} {C}_{1} {γ}_{1}} +\end{matrix} \\ {ξ}_{1} {ζ}_{1} \vert {A}_{2} \vert \vert {B}_{2} \vert cos {φ}_{{A}_{2} {B}_{2} {γ}_{1}} + {γ}_{1} {ξ}_{1} {η}_{1} 2 \vert {A}_{2} \vert \vert {C}_{2} \vert cos {φ}_{{A}_{2} {C}_{2} , 1}\end{matrix} \} , & ( 83 ) \\ {S}_{2} = {P}_{2} \{ \begin{matrix}\begin{matrix}\begin{matrix}{ξ}_{2}^{2} {\vert {A}_{3} \vert}^{2} + {ζ}_{2}^{2} {\vert {B}_{3} \vert}^{2} + {η}_{2}^{2} {\vert {C}_{3} \vert}^{2} + {ζ}_{2} {η}_{2} 2 \vert {B}_{3} \vert \vert {C}_{3} \vert cos {φ}_{{B}_{3} {C}_{3} {ɛ}_{2}} + \\ {ξ}_{2} {ζ}_{2} 2 \vert {A}_{3} \vert \vert {B}_{3} \vert cos {φ}_{{A}_{3} {B}_{3} {ɛ}_{2}} + {ɛ}_{2} {ξ}_{2} {η}_{2} 2 \vert {A}_{3} \vert \vert {C}_{3} \vert cos {φ}_{{A}_{3} {C}_{3} , 2} +\end{matrix} \\ {ξ}_{2}^{2} {\vert {A}_{4} \vert}^{2} + {ζ}_{2}^{2} {\vert {B}_{4} \vert}^{2} + {η}_{2}^{2} {\vert {C}_{4} \vert}^{2} + {ζ}_{2} {η}_{2} 2 \vert {B}_{4} \vert \vert {C}_{4} \vert cos {φ}_{{B}_{4} {C}_{4} {γ}_{2}} +\end{matrix} \\ {ξ}_{2} {ζ}_{2} \vert {A}_{4} \vert \vert {B}_{4} \vert cos {φ}_{{A}_{4} {B}_{4} {γ}_{2}} + {γ}_{2} {ξ}_{2} {η}_{2} 2 \vert {A}_{4} \vert \vert {C}_{4} \vert cos {φ}_{{A}_{4} {C}_{4} , 2}\end{matrix} \} , & ( 84 ) \\ {S}_{1} = {P}_{3} \{ \begin{matrix}\begin{matrix}\begin{matrix}{ξ}_{1}^{2} {\vert {A}_{1} \vert}^{2} + {ζ}_{1}^{2} {\vert {B}_{1} \vert}^{2} + {η}_{1}^{2} {\vert {C}_{1} \vert}^{2} + {ζ}_{1} {η}_{1} 2 \vert {B}_{1} \vert \vert {C}_{1} \vert cos {φ}_{{B}_{1} {C}_{1} {ɛ}_{1}} + \\ {ξ}_{1} {ζ}_{1} 2 \vert {A}_{1} \vert \vert {B}_{1} \vert cos {φ}_{{A}_{1} {B}_{1} {ɛ}_{1}} + {ɛ}_{1} {ξ}_{1} {η}_{1} 2 \vert {A}_{1} \vert \vert {C}_{1} \vert cos {φ}_{{A}_{1} {C}_{1} , 1} +\end{matrix} \\ {ξ}_{1}^{2} {\vert {A}_{2} \vert}^{2} + {ζ}_{1}^{2} {\vert {B}_{2} \vert}^{2} + {η}_{1}^{2} {\vert {C}_{2} \vert}^{2} + {ζ}_{1} {η}_{1} 2 \vert {B}_{2} \vert \vert {C}_{2} \vert cos {φ}_{{B}_{1} {C}_{1} {γ}_{1}} +\end{matrix} \\ {ξ}_{1} {ζ}_{1} \vert {A}_{2} \vert \vert {B}_{2} \vert cos {φ}_{{A}_{2} {B}_{2} {γ}_{1}} + {γ}_{1} {ξ}_{1} {η}_{1} 2 \vert {A}_{2} \vert \vert {C}_{2} \vert cos {φ}_{{A}_{2} {C}_{2} , 1}\end{matrix} \} , & ( 85 ) \\ {S}_{2} = {P}_{4} \{ \begin{matrix}\begin{matrix}\begin{matrix}{ξ}_{2}^{2} {\vert {A}_{3} \vert}^{2} + {ζ}_{2}^{2} {\vert {B}_{3} \vert}^{2} + {η}_{2}^{2} {\vert {C}_{3} \vert}^{2} + {ζ}_{2} {η}_{2} 2 \vert {B}_{3} \vert \vert {C}_{3} \vert cos {φ}_{{B}_{3} {C}_{3} {ɛ}_{2}} + \\ {ξ}_{2} {ζ}_{2} 2 \vert {A}_{3} \vert \vert {B}_{3} \vert cos {φ}_{{A}_{3} {B}_{3} {ɛ}_{2}} + {ɛ}_{2} {ξ}_{2} {η}_{2} 2 \vert {A}_{3} \vert \vert {C}_{3} \vert cos {φ}_{{A}_{3} {C}_{3} , 2} +\end{matrix} \\ {ξ}_{2}^{2} {\vert {A}_{4} \vert}^{2} + {ζ}_{2}^{2} {\vert {B}_{4} \vert}^{2} + {η}_{2}^{2} {\vert {C}_{4} \vert}^{2} + {ζ}_{2} {η}_{2} 2 \vert {B}_{4} \vert \vert {C}_{4} \vert cos {φ}_{{B}_{4} {C}_{4} {γ}_{2}} +\end{matrix} \\ {ξ}_{2} {ζ}_{2} \vert {A}_{4} \vert \vert {B}_{4} \vert cos {φ}_{{A}_{4} {B}_{4} {γ}_{2}} + {γ}_{2} {ξ}_{2} {η}_{2} 2 \vert {A}_{4} \vert \vert {C}_{4} \vert cos {φ}_{{A}_{4} {C}_{4} , 2}\end{matrix} \} , & ( 86 )\end{matrix}$$

where coefficients A₁, A₂, A₃, and A₄ represent the amplitudes of the reference beams corresponding to the first, second, third, and fourth frequency components, respectively, of input beam 24; coefficients B₁, B₂, B₃, and B₄ represent the amplitudes of background beams corresponding to reference beams A₁, A₂, A₃, and A₄, respectively; coefficients C₁, C₂, C₃, and C₄ represent the amplitudes of the return measurement beams corresponding to reference beams A₁, A₂, A₃, and A₄, respectively; P₁ and P₂ represent the integrated intensities of the first frequency component in the first and second windows, respectively, of the input beam 24; and the values for εⱼ and γⱼ are listed in Tables 4 and 5. The description of the coefficients ξⱼ, ζ_{,}and ηⱼ for the quad-homodyne detection method is the same as the corresponding portion of the description given for ξⱼ, ζⱼ, and ηⱼ of the bi-homodyne detection method.

It is assumed in Eqs. (83), (84), (85), and (86) that the ratios of |A₂|/|A₁| and |A₄|/|A₃| are not dependent on j or the value of Pⱼ. In order to simplify the representation of Sⱼ So as to project the important features, it is also assumed in Eqs. (83), (84), (85), and (86) that the ratios of the amplitudes of the return measurement beams corresponding to |A₂|/|A₁| and |A₄|/|A₃| are not dependent on j or the value of Pⱼ. However, the ratios |C₂|/|C₁| and |C₄|/|C₃| will be different from the ratios |A₂|/|A₁| and |A₄|/|A₃|, respectively, when the ratio of the amplitudes of the measurement beam components corresponding to |A₂|/|A₁| and |A₄|/|A₃|, respectively, are different from the ratios |A₂|/|A₁| and |A₄|/|A₃|, respectively.

Noting that cos φ_{A}_{₂}_{C}_{₂}_{,j}=±sin φ_{A}_{₁}_{C}_{₁}_{,j} by the control of the relative phase shifts between corresponding reference and measurement beam components in beam 32, Eqs. (83), (84), (85), and (86) may be written, respectively, as

$$\begin{matrix}{S}_{1} = {P}_{1} \{ \begin{matrix}\begin{matrix}\begin{matrix}{ξ}_{1}^{2} ( {\vert {A}_{1} \vert}^{2} + {\vert {A}_{2} \vert}^{2} ) + {ζ}_{1}^{2} ( {\vert {B}_{1} \vert}^{2} + {\vert {B}_{2} \vert}^{2} ) + {η}_{1}^{2} ( {\vert {C}_{1} \vert}^{2} + {\vert {C}_{2} \vert}^{2} ) + \\ 2 {ζ}_{1} {η}_{1} [ \vert {B}_{1} \vert \vert {C}_{1} \vert cos {φ}_{{B}_{1} {C}_{1} {ɛ}_{1}} + \vert {B}_{2} \vert \vert {C}_{2} \vert cos {φ}_{{B}_{2} {C}_{2} {γ}_{1}} ] +\end{matrix} \\ 2 {ξ}_{1} {η}_{1} [ \begin{matrix}{ɛ}_{1} \vert {A}_{1} \vert \vert {C}_{1} \vert cos {φ}_{{A}_{1} {C}_{1} , 1} + \\ {γ}_{1} ( \frac{\vert {A}_{2} \vert}{\vert {A}_{1} \vert} ) ( \frac{\vert {C}_{2} \vert}{\vert {C}_{1} \vert} ) \vert {A}_{1} \vert \vert {C}_{1} \vert sin {φ}_{{A}_{1} {C}_{1} , 1}\end{matrix} ] +\end{matrix} \\ 2 {ξ}_{1} {ζ}_{1} [ \vert {A}_{1} \vert \vert {B}_{1} \vert cos {φ}_{{A}_{1} {B}_{1} {ɛ}_{1}} + \vert {A}_{2} \vert \vert {B}_{2} \vert cos {φ}_{{A}_{2} {B}_{2} {γ}_{1}} ]\end{matrix} \} , & ( 87 ) \\ {S}_{2} = {P}_{1} \{ \begin{matrix}\begin{matrix}\begin{matrix}{ξ}_{2}^{2} ( {\vert {A}_{3} \vert}^{2} + {\vert {A}_{4} \vert}^{2} ) + {ζ}_{2}^{2} ( {\vert {B}_{3} \vert}^{2} + {\vert {B}_{4} \vert}^{2} ) + {η}_{2}^{2} ( {\vert {C}_{3} \vert}^{2} + {\vert {C}_{4} \vert}^{2} ) + \\ 2 {ζ}_{2} {η}_{2} [ \vert {B}_{3} \vert \vert {C}_{3} \vert cos {φ}_{{B}_{3} {C}_{3} {ɛ}_{2}} + \vert {B}_{4} \vert \vert {C}_{4} \vert cos {φ}_{{B}_{4} {C}_{4} {γ}_{2}} ] +\end{matrix} \\ 2 {ξ}_{2} {η}_{2} ( \frac{\vert {A}_{3} \vert}{\vert {A}_{1} \vert} ) ( \frac{\vert {C}_{3} \vert}{\vert {C}_{1} \vert} ) [ \begin{matrix}{ɛ}_{2} \vert {A}_{1} \vert \vert {C}_{1} \vert cos {φ}_{{A}_{1} {C}_{1} , 2} + \\ {γ}_{2} ( \frac{\vert {A}_{4} \vert}{\vert {A}_{3} \vert} ) ( \frac{\vert {C}_{4} \vert}{\vert {C}_{3} \vert} ) \vert {A}_{1} \vert \vert {C}_{1} \vert sin {φ}_{{A}_{1} {C}_{1} , 2}\end{matrix} ] +\end{matrix} \\ 2 {ξ}_{2} {ζ}_{2} [ \vert {A}_{3} \vert \vert {B}_{3} \vert cos {φ}_{{A}_{3} {B}_{3} {ɛ}_{2}} + \vert {A}_{4} \vert \vert {B}_{4} \vert cos {φ}_{{A}_{4} {B}_{4} {γ}_{2}} ]\end{matrix} \} , & ( 88 ) \\ {S}_{3} = {P}_{2} \{ \begin{matrix}\begin{matrix}\begin{matrix}{ξ}_{1}^{2} ( {\vert {A}_{1} \vert}^{2} + {\vert {A}_{2} \vert}^{2} ) + {ζ}_{1}^{2} ( {\vert {B}_{1} \vert}^{2} + {\vert {B}_{2} \vert}^{2} ) + {η}_{1}^{2} ( {\vert {C}_{1} \vert}^{2} + {\vert {C}_{2} \vert}^{2} ) + \\ 2 {ζ}_{1} {η}_{1} [ \vert {B}_{1} \vert \vert {C}_{1} \vert cos {φ}_{{B}_{1} {C}_{1} {ɛ}_{3}} + \vert {B}_{2} \vert \vert {C}_{2} \vert cos {φ}_{{B}_{2} {C}_{2} {γ}_{3}} ] +\end{matrix} \\ 2 {ξ}_{1} {η}_{1} [ \begin{matrix}{ɛ}_{3} \vert {A}_{1} \vert \vert {C}_{1} \vert cos {φ}_{{A}_{1} {C}_{1} , 3} + \\ {γ}_{3} ( \frac{\vert {A}_{2} \vert}{\vert {A}_{1} \vert} ) ( \frac{\vert {C}_{2} \vert}{\vert {C}_{1} \vert} ) \vert {A}_{1} \vert \vert {C}_{1} \vert sin {φ}_{{A}_{1} {C}_{1} , 3}\end{matrix} ] +\end{matrix} \\ 2 {ξ}_{1} {ζ}_{1} [ \vert {A}_{1} \vert \vert {B}_{1} \vert cos {φ}_{{A}_{1} {B}_{1} {ɛ}_{3}} + \vert {A}_{2} \vert \vert {B}_{2} \vert cos {φ}_{{A}_{2} {B}_{2} {γ}_{3}} ]\end{matrix} \} , & ( 89 ) \\ {S}_{4} = {P}_{2} \{ \begin{matrix}\begin{matrix}\begin{matrix}{ξ}_{2}^{2} ( {\vert {A}_{3} \vert}^{2} + {\vert {A}_{4} \vert}^{2} ) + {ζ}_{2}^{2} ( {\vert {B}_{3} \vert}^{2} + {\vert {B}_{4} \vert}^{2} ) + {η}_{2}^{2} ( {\vert {C}_{3} \vert}^{2} + {\vert {C}_{4} \vert}^{2} ) + \\ 2 {ζ}_{2} {η}_{2} [ \vert {B}_{3} \vert \vert {C}_{3} \vert cos {φ}_{{B}_{3} {C}_{3} {ɛ}_{4}} + \vert {B}_{4} \vert \vert {C}_{4} \vert cos {φ}_{{B}_{4} {C}_{4} {γ}_{4}} ] +\end{matrix} \\ 2 {ξ}_{2} {η}_{2} ( \frac{\vert {A}_{3} \vert}{\vert {A}_{1} \vert} ) ( \frac{\vert {C}_{3} \vert}{\vert {C}_{1} \vert} ) [ \begin{matrix}{ɛ}_{4} \vert {A}_{1} \vert \vert {C}_{1} \vert cos {φ}_{{A}_{1} {C}_{1} , 4} + \\ {γ}_{4} ( \frac{\vert {A}_{4} \vert}{\vert {A}_{3} \vert} ) ( \frac{\vert {C}_{4} \vert}{\vert {C}_{3} \vert} ) \vert {A}_{1} \vert \vert {C}_{1} \vert sin {φ}_{{A}_{1} {C}_{1} , 4}\end{matrix} ] +\end{matrix} \\ 2 {ξ}_{2} {ζ}_{2} [ \vert {A}_{3} \vert \vert {B}_{3} \vert cos {φ}_{{A}_{3} {B}_{3} {ɛ}_{4}} + \vert {A}_{4} \vert \vert {B}_{4} \vert cos {φ}_{{A}_{4} {B}_{4} {γ}_{4}} ]\end{matrix} \} , & ( 90 )\end{matrix}$$

where the relationships cos φ_{A}_{₃}_{C}_{₃}_{,j}=cos φ_{A}_{₁}_{C}_{₁}_{,j}, cos φ_{A}_{₄}_{C}_{₄}_{,j}=cos φ_{A}_{₂}_{C}_{₂}_{,j}, and cos φ_{A}_{₂}_{C}_{₂}_{,j}=sin φ_{A}_{₁}_{C}₁_{,j} have been used.

Information about the conjugated quadratures |C₁|cos φ_{A}_{₁}_{C}_{₁}_{,j} and |C₁|sin φ_{A}_{₁}_{C}_{₁}_{,j} are obtained using the symmetric and antisymmetric properties and orthogonality property of the conjugated quadratures as represented by the following digital filters applied to the signal values Sⱼ: j=1,2,3,4

$$\begin{matrix}{F}_{3} ( S ) = ( \frac{1}{{P}_{1}^{′}} ) ( \frac{{S}_{1}}{{ξ}_{1}^{′2}} - \frac{{S}_{2}}{{ξ}_{2}^{′2}} ) - ( \frac{1}{{P}_{2}^{′}} ) ( \frac{{S}_{3}}{{ξ}_{1}^{′2}} - \frac{{S}_{4}}{{ξ}_{2}^{′2}} ) , & ( 91 ) \\ {F}_{4} ( S ) = ( \frac{1}{{P}_{1}^{′}} ) ( \frac{{S}_{1}}{{ξ}_{1}^{′2}} - \frac{{S}_{2}}{{ξ}_{2}^{′2}} ) + ( \frac{1}{{P}_{2}^{′}} ) ( \frac{{S}_{3}}{{ξ}_{1}^{′2}} - \frac{{S}_{4}}{{ξ}_{2}^{′2}} ) . & ( 92 )\end{matrix}$$

The description of ξ′ⱼ and Pⱼ′ for the quad-homodyne detection method is the same as the corresponding description given for ξ′ⱼ and Pⱼ′ in the bi-homodyne detection method. Using Eqs. (87), (88), (89), (90), (91), and (92), the following expressions are obtained for the filtered quantities containing components of the conjugated quadratures |C₁|cos φ_{A}_{₁}_{C}_{₁}_{,j} and |C₁|sin φ_{A}_{₁}_{C}_{₁}_{,j}:

$$\begin{matrix}{F}_{3} ( S ) = 2 \vert {A}_{1} \vert \vert {C}_{1} \vert \times \{ \begin{matrix}\frac{{P}_{1}}{{P}_{1}^{′}} [ ( \frac{{ξ}_{1} {η}_{1}}{{ξ}_{1}^{′2}} ) cos {φ}_{{A}_{1} {C}_{1} , 1} + ( \frac{{ξ}_{2} {η}_{2}}{{ξ}_{2}^{′2}} ) ( \frac{\vert {A}_{3} \vert}{\vert {A}_{1} \vert} ) ( \frac{\vert {C}_{3} \vert}{\vert {C}_{1} \vert} ) cos {φ}_{{A}_{1} {C}_{1} , 2} ] + \\ \frac{{P}_{2}}{{P}_{2}^{′}} [ ( \frac{{ξ}_{1} {η}_{1}}{{ξ}_{1}^{′2}} ) cos {φ}_{{A}_{1} {C}_{1} , 3} + ( \frac{{ξ}_{2} {η}_{2}}{{ξ}_{2}^{′2}} ) ( \frac{\vert {A}_{3} \vert}{\vert {A}_{1} \vert} ) ( \frac{\vert {C}_{3} \vert}{\vert {C}_{1} \vert} ) cos {φ}_{{A}_{1} {C}_{1} , 4} ]\end{matrix} \} + 2 ( \frac{\vert {A}_{2} \vert}{\vert {A}_{1} \vert} ) ( \frac{\vert {C}_{2} \vert}{\vert {C}_{1} \vert} ) \vert {A}_{1} \vert \vert {C}_{1} \vert \times \{ \begin{matrix}\frac{{P}_{1}}{{P}_{1}^{′}} [ ( \frac{{ξ}_{1} {η}_{1}}{{ξ}_{1}^{′2}} ) sin {φ}_{{A}_{1} {C}_{1} , 1} + ( \frac{{ξ}_{2} {η}_{2}}{{ξ}_{2}^{′2}} ) ( \frac{\vert {A}_{4} \vert}{\vert {A}_{2} \vert} ) ( \frac{\vert {C}_{4} \vert}{\vert {C}_{2} \vert} ) sin {φ}_{{A}_{1} {C}_{1} , 2} ] - \\ \frac{{P}_{2}}{{P}_{2}^{′}} [ ( \frac{{ξ}_{1} {η}_{1}}{{ξ}_{1}^{′2}} ) sin {φ}_{{A}_{1} {C}_{1} , 3} + ( \frac{{ξ}_{2} {η}_{2}}{{ξ}_{2}^{′2}} ) ( \frac{\vert {A}_{4} \vert}{\vert {A}_{2} \vert} ) ( \frac{\vert {C}_{4} \vert}{\vert {C}_{2} \vert} ) sin {φ}_{{A}_{1} {C}_{1} , 4} ]\end{matrix} \} + {a}_{3} + … , & ( 93 ) \\ {F}_{4} ( S ) = 2 \vert {A}_{1} \vert \vert {C}_{1} \vert \times \{ \begin{matrix}\frac{{P}_{1}}{{P}_{1}^{′}} [ ( \frac{{ξ}_{1} {η}_{1}}{{ξ}_{1}^{′2}} ) cos {φ}_{{A}_{1} {C}_{1} , 1} + ( \frac{{ξ}_{2} {η}_{2}}{{ξ}_{2}^{′2}} ) ( \frac{\vert {A}_{3} \vert}{\vert {A}_{1} \vert} ) ( \frac{\vert {C}_{3} \vert}{\vert {C}_{1} \vert} ) cos {φ}_{{A}_{1} {C}_{1} , 2} ] - \\ \frac{{P}_{2}}{{P}_{2}^{′}} [ ( \frac{{ξ}_{1} {η}_{1}}{{ξ}_{1}^{′2}} ) cos {φ}_{{A}_{1} {C}_{1} , 3} + ( \frac{{ξ}_{2} {η}_{2}}{{ξ}_{2}^{′2}} ) ( \frac{\vert {A}_{3} \vert}{\vert {A}_{1} \vert} ) ( \frac{\vert {C}_{3} \vert}{\vert {C}_{1} \vert} ) cos {φ}_{{A}_{1} {C}_{1} , 4} ]\end{matrix} \} + 2 \vert {A}_{1} \vert \vert {C}_{1} \vert ( \frac{\vert {A}_{2} \vert}{\vert {A}_{1} \vert} ) ( \frac{\vert {C}_{2} \vert}{\vert {C}_{1} \vert} ) \times \{ \begin{matrix}\frac{{P}_{1}}{{P}_{1}^{′}} [ ( \frac{{ξ}_{1} {η}_{1}}{{ξ}_{1}^{′2}} ) sin {φ}_{{A}_{1} {C}_{1} , 1} + ( \frac{{ξ}_{2} {η}_{2}}{{ξ}_{2}^{′2}} ) ( \frac{\vert {A}_{4} \vert}{\vert {A}_{2} \vert} ) ( \frac{\vert {C}_{4} \vert}{\vert {C}_{2} \vert} ) sin {φ}_{{A}_{1} {C}_{1} , 2} ] + \\ \frac{{P}_{2}}{{P}_{2}^{′}} [ ( \frac{{ξ}_{1} {η}_{1}}{{ξ}_{1}^{′2}} ) sin {φ}_{{A}_{1} {C}_{1} , 3} + ( \frac{{ξ}_{2} {η}_{2}}{{ξ}_{2}^{′2}} ) ( \frac{\vert {A}_{4} \vert}{\vert {A}_{2} \vert} ) ( \frac{\vert {C}_{4} \vert}{\vert {C}_{2} \vert} ) sin {φ}_{{A}_{1} {C}_{1} , 4} ]\end{matrix} \} + {a}_{4} + … & ( 94 )\end{matrix}$$

where

$$\begin{matrix}{a}_{3} = ( \frac{{P}_{1}}{{P}_{1}^{′}} - \frac{{P}_{2}}{{P}_{2}^{′}} ) [ ( {\vert {A}_{1} \vert}^{2} + {\vert {A}_{2} \vert}^{2} ) ( \frac{{ξ}_{1}^{2}}{{ξ}_{1}^{′2}} ) - ( {\vert {A}_{3} \vert}^{2} + {\vert {A}_{4} \vert}^{2} ) ( \frac{{ξ}_{2}^{2}}{{ξ}_{2}^{′2}} ) ] + ( \frac{{P}_{1}}{{P}_{1}^{′}} - \frac{{P}_{2}}{{P}_{2}^{′}} ) [ ( {\vert {B}_{1} \vert}^{2} + {\vert {B}_{2} \vert}^{2} ) ( \frac{{ζ}_{1}^{2}}{{ξ}_{1}^{′2}} ) - ( {\vert {B}_{3} \vert}^{2} + {\vert {B}_{4} \vert}^{2} ) ( \frac{{ζ}_{2}^{2}}{{ξ}_{2}^{′2}} ) ] + ( \frac{{P}_{1}}{{P}_{1}^{′}} - \frac{{P}_{2}}{{P}_{2}^{′}} ) [ ( {\vert {C}_{1} \vert}^{2} + {\vert {C}_{2} \vert}^{2} ) ( \frac{{η}_{1}^{2}}{{ξ}_{1}^{′2}} ) - ( {\vert {C}_{3} \vert}^{2} + {\vert {C}_{4} \vert}^{2} ) ( \frac{{η}_{2}^{2}}{{ξ}_{2}^{′2}} ) ] , & ( 95 ) \\ {a}_{4} = ( \frac{{P}_{1}}{{P}_{1}^{′}} + \frac{{P}_{2}}{{P}_{2}^{′}} ) [ ( {\vert {A}_{1} \vert}^{2} + {\vert {A}_{2} \vert}^{2} ) ( \frac{{ξ}_{1}^{2}}{{ξ}_{1}^{′2}} ) - ( {\vert {A}_{3} \vert}^{2} + {\vert {A}_{4} \vert}^{2} ) ( \frac{{ξ}_{2}^{2}}{{ξ}_{2}^{′2}} ) ] + ( \frac{{P}_{1}}{{P}_{1}^{′}} + \frac{{P}_{2}}{{P}_{2}^{′}} ) [ ( {\vert {B}_{1} \vert}^{2} + {\vert {B}_{2} \vert}^{2} ) ( \frac{{ζ}_{1}^{2}}{{ξ}_{1}^{′2}} ) - ( {\vert {B}_{3} \vert}^{2} + {\vert {B}_{4} \vert}^{2} ) ( \frac{{ζ}_{2}^{2}}{{ξ}_{2}^{′2}} ) ] + ( \frac{{P}_{1}}{{P}_{1}^{′}} + \frac{{P}_{2}}{{P}_{2}^{′}} ) [ ( {\vert {C}_{1} \vert}^{2} + {\vert {C}_{2} \vert}^{2} ) ( \frac{{η}_{1}^{2}}{{ξ}_{1}^{′2}} ) - ( {\vert {C}_{3} \vert}^{2} + {\vert {C}_{4} \vert}^{2} ) ( \frac{{η}_{2}^{2}}{{ξ}_{2}^{′2}} ) ] . & ( 96 )\end{matrix}$$

The parameters

$$\begin{matrix}[ ( \frac{\vert {A}_{2} \vert}{\vert {A}_{1} \vert} ) ( \frac{\vert {C}_{2} \vert}{\vert {C}_{1} \vert} ) ] , & ( 97 ) \\ ( \frac{\vert {A}_{4} \vert}{\vert {A}_{2} \vert} ) ( \frac{\vert {C}_{4} \vert}{\vert {C}_{2} \vert} ) , & ( 98 ) \\ [ ( \frac{\vert {A}_{3} \vert}{\vert {A}_{1} \vert} ) ( \frac{\vert {C}_{3} \vert}{\vert {C}_{1} \vert} ) ] & ( 99 )\end{matrix}$$

need to be determined in order to complete the determination of a conjugated quadratures for certain end use applications. The parameters given by Eqs. (97), (98), and (99) can for example be measured by procedures analogous to the procedure described for the bi-homodyne detection method with respect to measuring the quantity specified by Eq. (47).

The remaining description of the quad-homodyne detection method with respect to considerations not related to effects of vibrations and environmental changes is the same as the corresponding portion of the description given for the bi-homodyne detection method.

The appearance of effects of vibrations and environmental changes is determined by expressing φ_{A}_{₁}_{C}_{₁}_{,j}=φ_{A}_{₁}_{C}_{₁}+Δφⱼ in Eqs. (93) and (94) where Δφ comprises the effects of vibration, environmental changes, and tilts between reference object 62 and measurement object 60 and following the same procedures used with respect to the single- and bi-homodyne detection methods herein to determine the corresponding effects of vibrations and environmental changes. The results obtained for the quad-homodyne detection method exhibit properties that are substantially the same as the properties exhibited for the bi-homodyne detection method.

Various embodiments of the present invention may use the quad-homodyne detection method instead of the bi-homodyne detection method. For the other embodiments such as those that are based on the apparatus shown in FIG. 1a, the corresponding the other embodiments use variants of the apparatus shown in FIG. 1a. In the variants of the apparatus such as used in the first embodiment of the present invention, interferometer 10 is modified to include for example a CCD configured with a architecture that pairs each photosensitive pixel with a blanked-off storage pixel to which the integrated charge is shifted at the moment of an interline transfer or a dispersive element such as a direct vision prism or a dichroic beam-splitter. When configured with a dispersive element, a second detector is further added to the system.

Descriptions of the variants of the apparatus based on the incorporation of a dispersive element are the same as corresponding portions of descriptions given for corresponding systems in commonly owned U.S. Provisional Application No. 60/442982 (Z1-45) and U.S. patent application Ser. No. 10/765,229 (Z1-45) wherein both are entitled “Interferometric Confocal Microscopy Incorporating Pinhole Array Beam-splitter” and both are by Henry A. Hill. The contents of both are here within incorporated in their entirety by reference. Corresponding variants of apparatus are also used for various embodiments of the present invention that comprise interferometers such as linear displacement interferometers.

It is also evident that since the conjugated quadratures of fields are obtained jointly when using the quad-homodyne detection, there is a significant reduction in the potential for an error in tracking phase as a result of a phase redundancy unlike the situation possible in single-homodyne detection of conjugated quadratures of fields.

There are a number of advantages of the quad-homodyne detection as a consequence of the conjugated quadratures of fields being jointly acquired quantities.

One advantage of the quad-homodyne detection method in relation to the bi-homodyne detection method is a factor of two increase in throughput.

Another advantage is a reduced sensitivity the effects of an overlay error of a spot in or on the substrate that is being imaged and a conjugate image of a pixel of a conjugate set of pixels of a multipixel detector during the acquisition of the four electrical interference signal values of each spot in and/or on a object imaged. Overlay errors are errors in the set of four conjugate images of a respective set of conjugate detector pixels relative to the spot being imaged.

Another advantage is that when operating in the scanning mode there is reduced sensitivity to effects of window to window variations of a respective conjugate set of windows of the input beam 24 to the interferometer system.

Another advantage is that when operating in the scanning mode there is an increase in throughput since only two windows of the source is required to generate the four electrical interference values.

A second embodiment of the present invention is shown schematically in FIG. 1f. The first embodiment comprises interferometer 10 configured as a Twyman-Green interferometer that uses homodyne detection methods based on a combination of polarization, temporal, and frequency encoding with or without use of phase shifting introduced by a relative translation of reference and measurement objects 62 and 1060 or by phase modulators 1022 and 1122. Phase modulators 1022 and 1122 are controlled by components of signal 1074 from electronic processor and controller 80. The second embodiment is in addition operated with a reference frame and a reference optical frequency f_{R} wherein the relative optical path length between a spot on surface 64 and a corresponding spot on measurement object 1060 is maintained constant mod 2π at the reference optical frequency f_{R}. The homodyne detection methods exhibit an intrinsic reduced sensitivity to vibrations and environmental changes.

In FIG. 1f, source 18 generates input beam 224 with two orthogonally polarized components wherein each polarized component comprises a single frequency component that is switched between selected frequency values with a switching frequency that is preferably high compared to the frequencies of the effects of vibration and environmental changes that may be present. The description of source 18 is the same as the description of source 18 of the first embodiment of the present invention with the addition of EOMs and analyzers to rotate the polarization state of beam 224 between different frequency components.

With reference to FIG. 1f, interferometer 10 comprises polarizing beam-splitter 144, reference object 62 with reference surface 64; measurement object 1060; transducers 150 and 152; detectors 70, 170, and 182; and electronic processor and controller 80. Input beam 224 is incident on non-polarizing beam splitter 148 and a first portion thereof transmitted as beam 24 and a second portion thereof reflected as monitor beam 1224. Beam 24 is incident on polarizing beam-splitter 144 and a first portion thereof transmitted as a measurement beam component of beam 232 and a second portion thereof reflected as reference beam component of beam 1232. The first and second portions are polarized parallel and orthogonal to the plane of FIG. 1f, respectively. Measurement beam component of beam 232 is subsequently incident on lens 1062 and transmitted as a measurement component of beam 230. The measurement beam component of beam 230 is incident on measurement object 1060 and a portion thereof reflected as a reflected measurement beam component of beam 230. The reflecting surface of measurement object 1060 is shown as a curved surface in FIG. 1f. The reflected measurement beam component of beam 230 is incident on lens 1062 and transmitted as the collimated reflected measurement beam component of beam 232. The reflected measurement beam component of beam 232 is next incident on polarizing beam-splitter 144 and reflected as a measurement beam component of output beam 34.

Reference beam component of beam 1232 is transmitted by phase modulator 1022 as a reference beam component of beam 1234 which is transmitted by phase modulator 1122 as a reference beam component of beam 1236. The reference beam component of beam 1236 is reflected by reference object 68 as a reflected reference beam component of beam 1236. The reflected reference beam component of beam 1236 is transmitted by phase modulators 1122 and 1022 as reflected reference beam components of beams 1234 and 1232, respectively. The reflected reference beam component of beam 1232 is incident on and transmitted by polarizing beam-splitter 144 as a reference beam component of output beam 34

Continuing with the description of the second embodiment, output beam 34 is incident on non-polarizing beam-splitter 146 and first and second portions thereof transmitted and reflected, respectively, as beams 138 and 140, respectively. Beam 138 is detected by detector 70 preferably by a quantum process to generate electrical interference signal 72 after transmission by shutter 168 if required to generate beam 142 as a gated beam. Shutter 168 is controlled by electronic processor and controller 80. The function of shutter may be alternatively served by a shutter integrated into detector 70. Electrical interference signal 72 contains information about the difference in surface profiles of surfaces of reference object 68 and the reflecting surface of measurement object 1060.

Beam 140 is incident on and detected by detector 170 preferably by a quantum process to generate electrical interference signal 172 to generate the respective transmitted beam as a mixed beam. If beam 140 is not a mixed beam, it is passed through an analyzer in detector 170 to form a mixed beam prior to detection by detector 170. Detector 170 comprises one or more high speed detectors where each of the high speed detectors may comprise one or more pixels. The photosensitive areas of each of the one or more high speed detectors overlaps a portion of the wavefront of beam 140.

Electrical interference signal 172 contains information about the relative changes in the optical path lengths between the reference and measurement objects 68 and 1060 at positions corresponding to the portions of the wavefront of beam 140 incident on each of the high speed detectors. The information contained in electrical interference signal 172 is processed and used by electronic processor and controller 80 to establish and maintain the reference frame and to detect changes in relative orientation and/or deformation of the reference and measurement objects 68 and 1060. The description of electrical interference signal 172 and the subsequent processing by electronic processor and controller 80 is the same as the corresponding portion of the description of the first embodiment of the present invention.

Beam 1224 is incident on detector 182 and detected preferably by a quantum process to generate electrical interference signal 184. Electrical interference signal 184 is processed and used by electronic processor and controller 80 to monitor and control the amplitude of components of beam 224 through a component of signal 74.

With reference to FIG. 1f, the phase shifting is achieved either with shifting the frequencies of components of input beam 24 or in conjunction with phase shifting introduced by translation and/or rotation of reference object 68 by transducers such as the transducers used to translate and/or rotate the reference object 62 of the first embodiment of the present invention or by phase modulators 1022 and 1122. Phase modulators 1022 and 1122 modulate the phases of orthogonally polarized components of transmitted beams as controlled by components of signal 1074 from electronic processor and controller 80. Transducers 150 and 152 which are controlled by signals 154 and 156, respectively, from electronic processor and controller 80 control the position and orientation of lens 1062. A third transducer located out of the plane of FIG. 1f (not shown in figure) is used to introduce changes in angular orientation of reference object 62 that are orthogonal to the changes in angular orientation introduced by transducers 150 and 152.

The remaining description of the second embodiment is the same as corresponding portions of the descriptions of the first embodiment of the present invention.

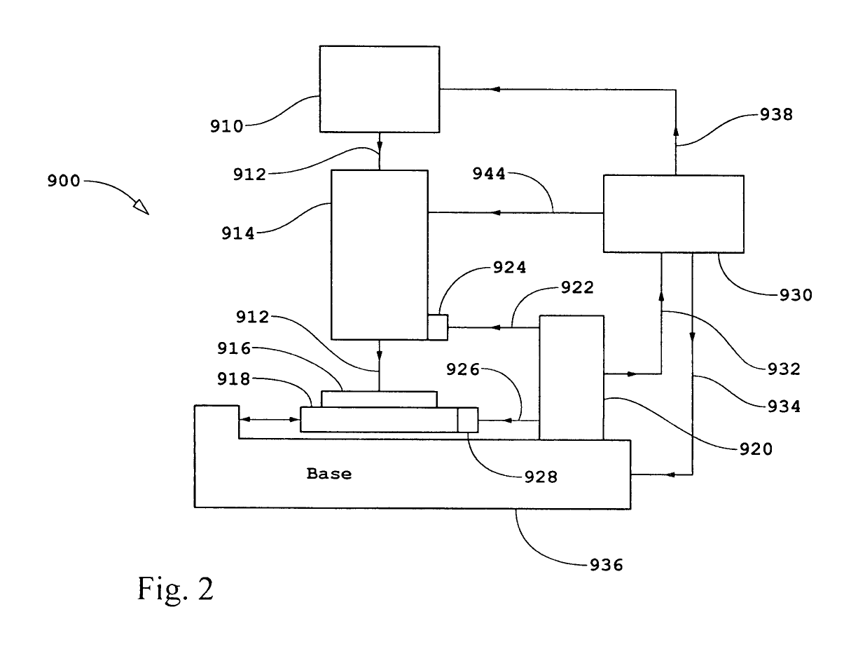

Two different modes are described for the acquisition of the electrical interference signals 72. The first mode to be described is a step and stare mode wherein objects 60 and 1060 of the first and second embodiments are stepped between fixed locations corresponding to locations where image information is desired. The second mode is a scanning mode. The descriptions of the two different modes are made with reference to FIG. 2 where a schematic of a metrology system 900 using a wavefront metrology system that embodies the present invention is shown. A source 910 generates a source beam and a wavefront metrology system 914 such as described in the first and second embodiments of the present invention directs a measurement beam 912 to a measurement object 916 supported by a movable stage 918. Source 910 is the same as source 18 shown in FIG. 1a. Measurement beam 912 located between wavefront metrology system 914 and measurement object 916 corresponds to measurement beam components 30A and 30B as shown in FIG. 1a.

To determine the relative position of stage 918, an interferometry system 920 directs a reference beam 922 to a mirror 924 mounted on wavefront metrology system 914 and a measurement beam 926 to a mirror 928 mounted on stage 918. Changes in the position measured by interferometry system 920 correspond to changes in the relative position of measurement beam 912 on measurement object 916. Interferometry system 920 sends a measurement signal 932 to controller 930 that is indicative of the relative position of measurement beam 912 on measurement 916. Controller 930 sends an output signal 934 to a base 936 that supports and positions stage 918. Interferometer system 920 may comprise for example linear displacement and angular displacement interferometers and cap gauges.

Controller 930 can cause the wavefront metrology system 914 to scan the measurement beam 912 over a region of the measurement object 916, e.g., using signal 934. As a result, controller 930 directs the other components of the system to generate information about different regions of the measurement object.

In the step and stare mode for generating a one-dimensional, a two-dimensional or a three-dimensional profile of measurement object 916, controller 930 translates stage 918 to a desired position and then acquires a set of at least three arrays of electrical interference signal values. After the acquisition of the sequence of at least three arrays of electrical interference signals, controller 930 then repeats the procedure for the next desired position of stage 918. The elevation and angular orientation of measurement object 916 is controlled by base 936.

The second mode for the acquisition of the electrical interference signal values is next described wherein the electrical interference signal values are obtained with the position of stage 918 scanned in one or more directions. In the scanning mode, source 910 is pulsed at times controlled by signal 938 from controller 930. Source 910 is pulsed at times corresponding to the registration of the conjugate image of pixels of the detector corresponding for example to detector 70 of FIG. 1b with positions on and/or in measurement object 916 for which image information is desired.

There will be a restriction on the duration or “pulse width” of a beam pulse sequence τₚₗ or corresponding integration time of the detector produced by source 910 as a result of the continuous scanning mode. Pulse width τₚₗ will be a parameter that in part controls the limiting value for spatial resolution in the direction of a scan to a lower bound of
τₚₗv, (100)
where v is the scan speed. For example, with a value of τₚₗ=50 nsec and a scan speed of v=0.20 m/sec, the limiting value of the spatial resolution τₚₗv in the direction of scan will be
τₚₗv=10 nm. (101)

Pulse width τₚₗ will also determine the minimum frequency difference that can be used in the bi-homodyne detection. In order that there be no contributions to the electrical interference signals from interference between fields of conjugated quadratures, the minimum frequency spacing Δfₘᵢₙ is expressed as

$$Δ {f}_{min} ⪢ \frac{1}{{τ}_{p 1}} . \qquad ( 102 )$$

For the example of τₚₗ=50 nsec, l/τₚₗ=20 MHz.

The frequencies of input beam 912 are controlled by signal 938 from controller 930 to correspond to the frequencies that will yield the desired phase shifts between the reference and return measurement beam components of output beams. In the first mode or step and stare mode for the acquisition of the electrical interference signal values, the set of at least three electrical interference signal values corresponding to a set of at least three electrical interference values are generated by common pixels of the detector. In the second or scanning mode for the acquisition of electrical interference signals, a set of at least three electrical interference signal values are not generated by a common pixel of the detector. Thus in the scanning mode of acquisition, the differences in pixel efficiency are compensated in the signal processing by controller 930 as described in the description of the bi- and quad-homodyne detection methods. The joint measurements of conjugated quadratures of fields are generated by controller 930 as previously described in the description of the bi- and quad-homodyne detection methods.

A third embodiment of the present invention comprises the interferometer system of FIG. 1a with interferometer 10 comprising an interferometric far-field confocal microscope such as described in cited U.S. Pat. No. 5,760,901. In the third embodiment, the interferometer system is configured to use a multiple-homodyne detection method. Embodiments in U.S. Pat. No. 5,760,901 are configured to operate in either the reflection or transmission mode. The third embodiment has reduced effects of background because of background reduction features of U.S. Pat. No. 5,760,901.

A fourth embodiment of the present invention comprises the interferometer system of FIG. 1a with interferometer 10 comprising an interferometric far-field confocal microscope such as described in U.S. Pat. No. 6,480,285 B1. In the fifth embodiment, the interferometer system is configured to use a multiple-homodyne detection method. Embodiments in U.S. Pat. No. 6,480,285 B1 are configured to operate in either the reflection or transmission mode. The fourth embodiment has reduced effects of background because of background reduction features of U.S. Pat. No. 6,480,285 B1.

A fifth embodiment of the present invention comprises the interferometer system of FIG. 1a with interferometer 10 comprising an interferometric near-field confocal microscope such as described in U.S. Pat. No. 6,445,453. In the fifth embodiment, the interferometer system is configured to use a multiple-homodyne detection method. Embodiments in U.S. Pat. No. 6,445,453 are configured to operate in either the reflection or transmission mode. The fifth embodiment of U.S. Pat. No. 6,445,453 in particular is configured to operate in the transmission mode with the measurement beam separated from the reference beam and incident on the measurement object being imaged by a non-confocal imaging system. Accordingly, the fifth embodiment of the present invention represents an application of a multiple-homodyne detection method in a non-confocal configuration for the measurement beam.

Interferometer 10 may further comprise any type of interferometer, e.g., a differential plane mirror interferometer, a double-pass interferometer, a Michelson-type interferometer and/or a similar device such as is described in an article entitled “Differential Interferometer Arrangements For Distance And Angle Measurements: Principles, Advantages And Applications” by C. Zanoni, VDI Berichle Nr. 749, p 93 (1989) configured for multiple-homodyne detection. Interferometer 10 may also comprise a passive zero shear plane mirror interferometer as described in U.S. patent application Ser. No. 10/207,314 entitled “Passive Zero Shear Interferometers” or an interferometer with a dynamic beam steering element such as described in U.S. patent application with Ser. No. 09/852,369 entitled “Apparatus And Method For Interferometric Measurements Of Angular Orientation And Distance To A Plane Mirror Object” and U.S. Pat. No. 6,271,923 entitled “Interferometry System Having A Dynamic Beam Steering Assembly For Measuring Angle And Distance,” all of which are by Henry A. Hill. For embodiments of the present invention which comprise interferometric apparatus such described in the U.S. patents and the article by Zanoni, the described interferometers are configured for a multiple-homodyne detection and the embodiments represent configurations that are of a non-confocal type.

Other embodiments are within the following claims.

What is claimed is:

1. An interferometric method comprising:
generating a source beam characterized by a variable frequency F;
from the source beam, generating a collimated beam propagating at an angle Ω relative to an optical axis;
introducing the collimated beam into an interferometer that includes a reference object and a measurement object, wherein at least a portion of the collimated beam interacts with the reference object to generate a reference beam, at least a portion of the collimated beam interacts with the measurement object to generate a return measurement beam, and the reference beam and the return measurement beam are combined to generate a combined beam;
causing the angle Ω to have a first value and at a later time a second value that is different from the first value; and
causing the variable frequency F to have a first value that corresponds to the first value of the angle Ω and at the later time to have a second value that corresponds to the first value of the angle Ω.

2. The interferometric method of claim 1, further comprising scanning the collimated beam over a plurality of different values of the angle Ω and for each of the different values of the angle Ω using a different value for the variable frequency F, wherein the first and second values of the angle Ω are among the plurality of different values of the angle Ω.

3. The interferometric method of claim 2, wherein the different values of the variable frequency F are selected to compensate for changes in an optical path length within the interferometer resulting from changes in the value of the angle Ω.

4. The interferometric method of claim 2, wherein the measurement object and the reference object define a cavity and wherein the different values of the variable frequency F are selected to maintain the order of interference of the cavity constant mod 1 for the plurality of values of the angle Ω.

5. The interferometric method of claim 2, further comprising, for each value of the angle Ω, causing the collimated beam to assume a plurality of different azimuthal angles relative to the optical axis.

6. The interferometric method of claim 1, wherein the combined beam is an interference beam.

7. The interferometric method of claim 2, further comprising detecting the combined beam to generate an interference signal.

8. The interferometric method of claim 7, further comprising integrating the interference signal that is generated for the plurality of different values of the angle Ω to generate an interferogram of the measurement object.

9. The interferometric method of claim 2, wherein scanning the collimated beam is performed to produce an extended source for the interferometer.

10. The interferometric method of claim 2, wherein the interferometer is a wavefront interferometer.

11. The interferometric method of claim 2, wherein the interferometer is a Fizeau-type interferometer.

12. An interferometric method comprising:
generating a source beam characterized by a variable frequency F;
from the source beam, generating a collimated beam propagating at an angle Ω relative to an optical axis;
interacting at least a portion of the collimated beam with a measurement object to generate a return measurement beam;
combining the return measurement beam with a reference beam to generate a combined beam; and
scanning the collimated beam over a plurality of different values of the angle Ω and for each of the different values of the angle Ω using a different value for the variable frequency F.

13. The interferometric method of claim 12, further comprising interacting a beam that is derived from the source beam with a reference object to generate the reference beam, wherein the measurement object and the reference object define a cavity, and wherein the different values of the variable frequency F are selected to compensate for changes in the optical path length of the cavity resulting from changes in the value of the angle Ω.

14. The interferometric method of claim 12, further comprising interacting a beam that is derived from the source beam with a reference object to generate the reference beam, wherein the measurement object and the reference object define a cavity, and wherein the different values of the variable frequency F are selected to maintain the order of interference of the cavity constant mod 1 for the plurality of values of the angle Ω.

15. The interferometric method of claim 12, further comprising, for each value of the angle Ω, causing the collimated beam to assume a plurality of different azimuthal angles relative to the optical axis.

16. The interferometric method of claim 12, wherein the combined beam is an interference beam.

17. The interferometric method of claim 12, further comprising detecting the combined beam to generate an interference signal.

18. The interferometric method of claim 17, further comprising integrating the interference signal that is generated for the plurality of different values of the angle Ω to generate an interferogram of the measurement object.

19. An apparatus comprising:
a variable frequency source for generating a beam characterized by a variable frequency F;
an interferometer characterized by an optical axis and having a reference object and a stage for holding a measurement object;
an optical module for generating from the source beam a collimated beam that propagates at an angle Ω relative to the optical axis of the interferometer and that is delivered to the interferometer, wherein during operation at least a portion of the collimated beam interacts with the reference object to generate a reference beam, at least a portion of the collimated beam interacts with the measurement object to generate a return measurement beam, and the interferometer combines the reference beam and the return measurement beam to generate a combined beam; and
a control module that during operation causes the optical module to scan the collimated beam over a plurality of different values of the angle Ω and for each of the different values of the angle Ω causes the variable source to use a different value for the variable frequency F.

20. The apparatus of claim 19, wherein the optical module comprises a combination of a first acousto-optic modulator and a second acousto-optic modulator for scanning the source beam over an area, wherein the scanned area represents an extended source for the interferometer.

21. The apparatus of claim 20, wherein the optical module further comprises a diffuser system onto which the source beam is scanned to produce a scattered beam from which the collimated beam is derived.

22. The apparatus of claim 21, wherein the optical module further comprises a collimating system which generates the collimated beam from the scattered beam.

23. The apparatus of claim 19, wherein the measurement object and the reference object define a cavity, and wherein the control module selects the different values of the variable frequency F so as to compensate for changes in the optical path length of the cavity resulting from changes in the value of the angle Ω.

24. The apparatus of claim 19, wherein the measurement object and the reference object define a cavity, and wherein the control module selects the different values of the variable frequency F so as to maintain the order of interference of the cavity constant mod 1 for the plurality of values of the angle Ω.

25. The apparatus of claim 19, wherein, for each value of the angle Ω, the control module during operation also causes the collimated beam to assume a plurality of different azimuthal angles relative to the optical axis.

26. The apparatus of claim 19, wherein the combined beam is an interference beam.

27. The apparatus of claim 19, further comprising a detector assembly that during operation receives the combined beam and generates an interference signal therefrom.

28. The apparatus of claim 19, further comprising a processor for integrating the interference signal that is generated for the plurality of different values of the angle Ω to generate an interferogram of the measurement object.
